(19) United States
(12) Patent Application Publication
(10) Pub. No.: US 2015/0264588 A1
(43) Pub. Date: Sep. 17, 2015

(54) METHODS AND APPARATUS FOR SYNCHRONIZATION IN DEVICE-TO-DEVICE COMMUNICATION NETWORKS

(71) Applicant: SAMSUNG ELECTRONICS CO., LTD., Suwon-si (KR)

(72) Inventors: Ying Li, Richardson, TX (US); Boon Loong Ng, Plano, TX (US); Thomas David Novlan, Dallas, TX (US); Gerardus Johannes Petrus van Lieshout, Apeldoorn (NL)

(21) Appl. No.: 14/640,879

(22) Filed: Mar. 6, 2015

Related U.S. Application Data
(60) Provisional application No. 61/953,436, filed on Mar. 14, 2014.
(60) Provisional application No. 62/033,950, filed on Aug. 6, 2014.
(60) Provisional application No. 62/081,987, filed on Nov. 19, 2014.
(60) Provisional application No. 62/085,048, filed on Nov. 26, 2014.
(60) Provisional application No. 62/029,217, filed on Jul. 25, 2014.

(51) Int. Cl. H04W 24/02; H04W 56/00; H04W 76/02

(52) U.S. Cl. CPC H04W 24/02; H04W 76/023; H04W 56/0015

(57) ABSTRACT

A Device to Device (D2D) user equipment (UE) is configured to support synchronization (sync) in a D2D network. The D2D UE includes an antenna configured to communicate via a D2D communication. The D2D UE also includes processing circuitry configured to communicate with a second portable terminal via the D2D communication. The processing circuitry is further configured to: derive a transmission (TX) timing from a synchronization (sync) source; and transmit a D2D Sync Signal (D2DSS) and Physical D2D Sync Channel (PD2DSCH) configured to indicate a hop number from the sync source. The hop number is indicated via the preamble sequence set and the indicator in PD2DSCH.

### CROSS-REFERENCE TO RELATED APPLICATION(S) AND CLAIM OF PRIORITY

The present application claims priority to U.S. Provisional Patent Application Ser. No. 61/953,436 filed Mar. 14, 2014, entitled “METHODS AND APPARATUS FOR SYNCHRONIZATION IN DEVICE-TO-DEVICE COMMUNICATION NETWORKS”, U.S. Provisional Patent Application Ser. No. 62/033,950, filed Aug. 6, 2014, entitled “METHODS AND APPARATUS FOR SYNCHRONIZATION IN DEVICE-TO-DEVICE COMMUNICATION NETWORKS”, U.S. Provisional Patent Application Ser. No. 62/081,987 filed Nov. 19, 2014, entitled “METHODS AND APPARATUS FOR SYNCHRONIZATION IN DEVICE-TO-DEVICE COMMUNICATION NETWORKS”, U.S. Provisional Patent Application Ser. No. 62/085,048 filed Nov. 26, 2014, entitled “METHOD AND APPARATUS FOR SYNCHRONIZATION IN DEVICE-TO-DEVICE COMMUNICATION NETWORKS” and U.S. Provisional Patent Application Ser. No. 62/029,217 filed Jul. 25, 2014, entitled “METHODS AND APPARATUS FOR OUT-OF-COVERAGE SUPPORT WIRELESS NETWORKS.” The content of the above-identified patent document is incorporated herein by reference.

### TECHNICAL FIELD

The present application relates generally to wireless communication systems and, more specifically, to the device-to-device (D2D) communications.

### BACKGROUND

Traditionally, cellular networks have been designed to establish wireless communications links between mobile devices, or User Equipments (UEs), and a fixed communication infrastructure (for example, base stations, access points, or enhanced NodeBs (eNBs)) that serves users in a wide or local geographic range. A wireless network, however, can also be implemented by utilizing D2D communication links with the assistance of infrastructure or without the need for deployed access points. A communication network can support devices which can connect both to access points (infrastructure mode) and other D2D-enabled devices. A D2D-enabled device is referred to as a D2D UE.

### SUMMARY

In a first embodiment, a User Equipment (UE) is provided. The UE includes an antenna configured to communicate via a device to device (D2D) communication. The first portable terminal also includes processing circuitry configured to communicate with a second UE via the D2D communication. The processing circuitry is further configured to: derive a transmission (TX) timing from a synchronization (sync) source; and transmit a sync signal configured to indicate a hop number from the sync source. When the UE derives the timing from a base station, the sync signal comprises a preamble sequence from a first set of sequences and Physical D2D Sync Channel (PD2DSCH) carrying an indicator indicating the UE is in-coverage. When the UE derives the timing from a D2D user UE at the first hop, the sync signal comprises a preamble sequence from a first set of sequences and Physical D2D Sync Channel (PD2DSCH) carrying an indicator indicating the portable terminal is out-of-coverage. When the UE derives the timing from a D2D UE at the second hop, the sync signal comprises a preamble sequence from a second set of sequences and Physical D2D Sync Channel (PD2DSCH) carrying an indicator indicating the portable terminal is out-of-coverage. The hop number is indicated via the preamble sequence set and the indicator in PD2DSCH.

In a second embodiment, a non-transitory computer readable medium comprising a plurality of instructions is provided. The plurality of instructions is configured to, when executed by a processor, cause the processor to: communicate with at least one portable terminal via a device to device (D2D) communication; derive a transmission (TX) timing from a synchronization (sync) source; and transmit a sync signal and Physical D2D Sync Channel (PD2DSCH), the sync signal configured to indicate a hop number from the sync source. When the processor derives the timing from a base station, the sync signal comprises a preamble sequence from a first set of sequences and Physical D2D Sync Channel (PD2DSCH) carrying an indicator indicating the UE is in-coverage. When the processor derives the timing from a D2D user UE at the first hop, the sync signal comprises a preamble sequence from a first set of sequences and Physical D2D Sync Channel (PD2DSCH) carrying an indicator indicating the portable terminal is out-of-coverage. When the processor derives the timing from a D2D UE at the second hop, the sync signal comprises a preamble sequence from a second set of sequences and Physical D2D Sync Channel (PD2DSCH) carrying an indicator indicating the portable terminal is out-of-coverage. The hop number is indicated via the preamble sequence set and the indicator in PD2DSCH.

In a third embodiment, a method is provided. The method includes deriving a transmission (TX) timing from a synchronization (sync) source. The method also includes transmitting a Device to Device (D2D) Sync Signal (D2DSS) and Physical D2D Sync Channel (PD2DSCH), the sync signal configured to indicate a hop number from the sync source by: transmitting, when the UE derives the timing from a base station, the sync signal including a preamble sequence from a first set of sequences and Physical D2D Sync Channel (PD2DSCH) carrying an indicator indicating the UE is in-coverage; transmitting, when the UE derives the timing from a D2D user UE at the first hop, the sync signal including a preamble sequence from a first set of sequences and Physical D2D Sync Channel (PD2DSCH) carrying an indicator indicating the portable terminal is out-of-coverage; and transmitting, when the UE derives the timing from a D2D UE at the second hop, the sync signal including a preamble sequence from a second set of sequences and Physical D2D Sync Channel (PD2DSCH) carrying an indicator indicating the portable terminal is out-of-coverage. The hop number is indicated via the preamble sequence set and the indicator in PD2DSCH.

Other technical features may be readily apparent to one skilled in the art from the following figures, descriptions, and claims.

Before undertaking the DETAILED DESCRIPTION below, it may be advantageous to set forth definitions of certain words and phrases used throughout this patent document. The term “couple” and its derivatives refer to any direct or indirect communication between two or more elements, whether or not those elements are in physical contact with one another. The terms “transmit,” “receive,” and “communicate,” as well as derivatives thereof, encompass both direct and indirect communication. The terms “include” and “comprise,” as well as derivatives thereof, mean inclusion without limitation. The term “or” is inclusive, meaning and/or. The phrase “associated with,” as well as derivatives thereof, means to include, be included within, interconnect with, contain, be contained within, connect to or with, couple to or with, be communicable with, cooperate with, interleave, juxtapose, be proximate to, be bound to or with, have, have a property of, have a relationship to or with, or the like. The term “controller” means any device, system or part thereof that controls at least one operation. Such a controller may be implemented in hardware or a combination of hardware and software and/or firmware. The functionality associated with any particular controller may be centralized or distributed, whether locally or remotely. The phrase “at least one of,” when used with a list of items, means that different combinations of one or more of the listed items may be used, and only one item in the list may be needed. For example, “at least one of: A, B, and C” includes any of the following combinations: A, B, C, A and B, A and C, B and C, and A and B and C.

Definitions for other certain words and phrases are provided throughout this patent document. Those of ordinary skill in the art should understand that in many if not most instances, such definitions apply to prior as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 illustrates an example wireless network according to this disclosure;

FIGS. 2A and 2B illustrate example wireless transmit and receive paths according to this disclosure;

FIG. 3 illustrates an example user equipment according to this disclosure;

FIG. 4 illustrates an example enhanced NodeB according to this disclosure;

FIG. 5 illustrates an exemplary topology of D2D communication networks according to this disclosure;

FIG. 6 illustrates a D2D sync establishment according to embodiments of the present disclosure;

FIG. 7 illustrates D2D sync establishment according to embodiments of the present disclosure;

FIG. 8 illustrates an exemplary configuration for different relative time domain positions of a PD2DSS and a SD2DSS to indicate different hop number values according to embodiments of the present disclosure;

FIG. 9 illustrates process for a D2D UE to determine a hop number value from a received D2DSS according to embodiments of the present disclosure;

FIG. 10 illustrates a process for a D2D UE to determine a hop number value from a received D2DSS and PD2DSCH according to embodiments of the present disclosure;

FIG. 11 illustrates a process for a D2D UE to determine a sync source type and a hop number value from a received D2DSS and PD2DSCH according to embodiments of the present disclosure;

FIG. 12 illustrates a D2D sync scenario according to embodiments of the present disclosure;

FIG. 13 illustrates a D2D sync procedure diagram according to embodiments of the present disclosure;

FIG. 14 illustrates another D2D sync procedure diagram according to embodiments of the present disclosure;

FIG. 15 illustrates a process in which a first D2D UE transmits information of the nodes from which it detects sync and a second D2D UE that receives such information uses the information as a factor to determine prioritization of the node to which the second D2D UE can synchronize according to embodiments of the present disclosure;

FIG. 16 illustrates a process in which a first D2D UE transmits information of multiple nodes from which the first D2D UE detects sync, and in which other nodes that receive the information request that the first UE become a relay according to embodiments of the present disclosure;

FIG. 17 illustrates exemplary operations in which a D2D UE transmits information of multiple nodes from which the D2D UE detects sync and in which the other node utilize the information according to embodiments of the present disclosure;

FIG. 18 illustrates exemplary operations that a D2D UE transmits information of multiple nodes from which the D2D UE detects sync and wherein the other node utilize the information according to embodiments of the present disclosure;

FIG. 19 illustrates a process for a first D2D UE to transmit a message including information about its changing a node to which it synchronizes according to embodiments of the present disclosure;

FIG. 20 illustrates exemplary operations in which a first D2D UE transmits a message including information about changing a node to which the D2D UE synchronizes according to embodiments of the present disclosure;

FIG. 21 illustrates a sync establishment according to embodiments of the present disclosure;

FIG. 22 illustrates another sync establishment according to embodiments of the present disclosure;

FIG. 23 illustrates a diagram of a preconfigured resource pool based on D2D-FN according to embodiments of the present disclosure;

FIG. 24 illustrates TX and RX resources including OOC resources determined by or based on D2D-FN and respective timing according to embodiments of the present disclosure;

FIG. 25 illustrates a process for a UE to determine TX resources according to embodiments of the present disclosure; and

FIG. 26 illustrate a process for RX monitoring by a UE according to embodiments of the present disclosure.

### DETAILED DESCRIPTION

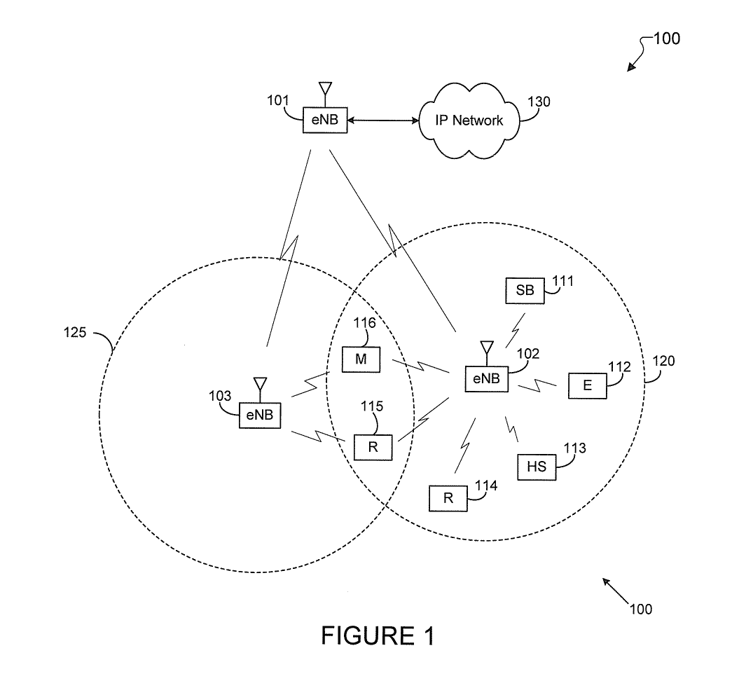

FIGS. 1 through 26, discussed below, and the various embodiments used to describe the principles of the present invention in this patent document are by way of illustration only and should not be construed in any way to limit the scope of the disclosure. Those skilled in the art will understand that the principles of this disclosure may be implemented in any suitably arranged device or system.

D2D communication may be used to implement many kinds of services that are complementary to the primary communication network or provide new services based on the flexibility of the network topology. LTE D2D multicast communication such as broadcasting or groupcasting has been identified as a potential means for D2D communication where UEs are able to transmit messages to all in-range D2D-enabled UEs or a subset of UEs which are members of particular group. Future public safety networks are expected to require devices to operate in near simultaneous fashion when switching between cellular and D2D communication modes. Accordingly, embodiments of the present disclosure illustrate protocols that can manage D2D communication in these deployment scenarios.

Throughout the disclosure, a first node synchronizes (syncs) to a second node means the first node derives its transmit (TX) timing from the second node, unless otherwise described. If a first node syncs to a second node where the second node is the maximum hop, synchronization (sync) means the first node can have a receive (RX) timing with respect to the timing from the second node; however, the first node may not use the TX timing derived from the TX timing of the second node, as the second node has indicated its TX is on the maximum hop already. The sync source type or sync source being an eNB means that TX timing is derived from the eNB, or TX reference timing is from the eNB. The sync source type or sync source being an independent UE source means that TX timing is derived from a non-eNB, or the TX timing is not derived from the eNB, or TX reference timing is not from the eNB.

FIG. 1 illustrates an example wireless network 100 according to this disclosure. The embodiment of the wireless network 100 shown in FIG. 1 is for illustration only. Other embodiments of the wireless network 100 could be used without departing from the scope of this disclosure.

The wireless network 100 includes an eNodeB (eNB) 101, an eNB 102, and an eNB 103. The eNB 101 communicates with the eNB 102 and the eNB 103. The eNB 101 also communicates with at least one Internet Protocol (IP) network 130, such as the Internet, a proprietary IP network, or other data network.

Depending on the network type, other well-known terms may be used instead of “eNodeB” or “eNB,” such as “base station” or “access point.” For the sake of convenience, the terms “eNodeB” and “eNB” are used in this patent document to refer to network infrastructure components that provide wireless access to remote terminals. Also, depending on the network type, other well-known terms may be used instead of “user equipment” or “UE,” such as “mobile station,” “subscriber station,” “remote terminal,” “wireless terminal,” or “user device.” For the sake of convenience, the terms “user equipment” and “UE” are used in this patent document to refer to remote wireless equipment that wirelessly accesses an eNB, whether the UE is a mobile device (such as a mobile telephone or smartphone) or is normally considered a stationary device (such as a desktop computer or vending machine).

The eNB 102 provides wireless broadband access to the network 130 for a first plurality of user equipments (UEs) within a coverage area 120 of the eNB 102. One or more of the UEs are configured as a device to device (D2D) UE. The first plurality of UEs includes a UE 111, which may be located in a small business (SB); a UE 112, which may be located in an enterprise (E); a UE 113, which may be located in a WiFi hotspot (HS); a UE 114, which may be located in a first residence (R); a UE 115, which may be located in a second residence (R); and a UE 116, which may be a mobile device (M) like a cell phone, a wireless laptop, a wireless PDA, or the like. The eNB 103 provides wireless broadband access to the network 130 for a second plurality of UEs within a coverage area 125 of the eNB 103. The second plurality of UEs includes the UE 115 and the UE 116. In some embodiments, one or more of the eNBs 101-103 may communicate with each other and with the UEs 111-116 using 5G, LTE, LTE-A, WiMAX, or other advanced wireless communication techniques.

Dotted lines show the approximate extents of the coverage areas 120 and 125, which are shown as approximately circular for the purposes of illustration and explanation only. It should be clearly understood that the coverage areas associated with eNBs, such as the coverage areas 120 and 125, may have other shapes, including irregular shapes, depending upon the configuration of the eNBs and variations in the radio environment associated with natural and man-made obstructions.

As described in more detail below, one or more of eNBs 101-103 and one or more of the UEs 111-116 include a mechanism for supporting synchronization (sync) of D2D UE. In addition, one or more of eNBs 101-103 are configured to inform a D2D UE, such as one or more UEs 111-116, of information that the D2D UE can utilize to determine the prioritization of the network nodes to which it can synchronize. Finally, one or more of eNBs 101-103 are configured to ensure a fast re-establishment of synchronization when there is change of the topology or locations of the D2D UEs.

Although FIG. 1 illustrates one example of a wireless network 100, various changes may be made to FIG. 1. For example, the wireless network 100 could include any number of eNBs and any number of UEs in any suitable arrangement. Also, the eNB 101 could communicate directly with any number of UEs and provide those UEs with wireless broadband access to the network 130. Similarly, each eNB 102-103 could communicate directly with the network 130 and provide UEs with direct wireless broadband access to the network 130. Further, the eNB 101, 102, and/or 103 could provide access to other or additional external networks, such as external telephone networks or other types of data networks.

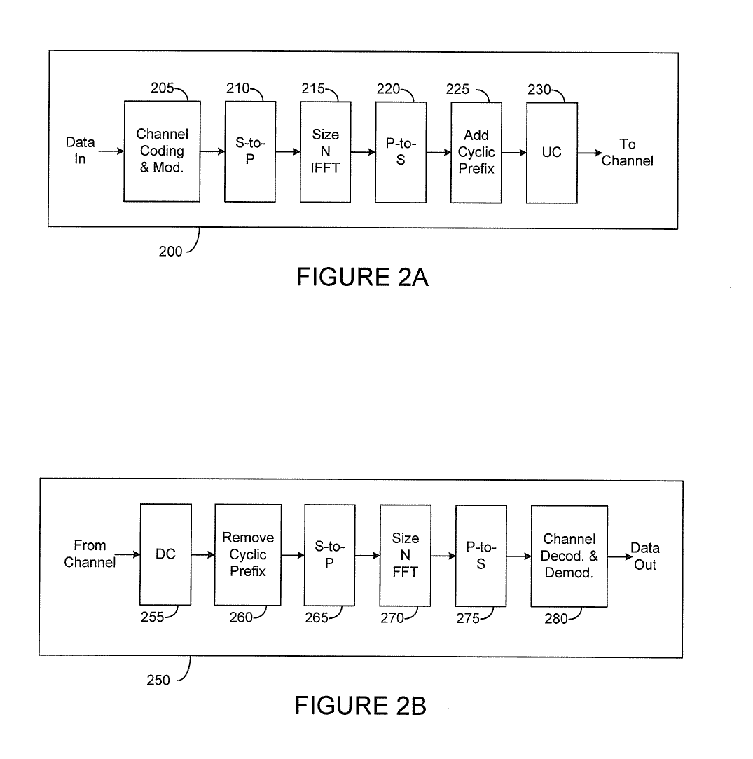

FIGS. 2A and 2B illustrate example wireless transmit and receive paths according to this disclosure. In the following description, a transmit path 200 may be described as being implemented in an eNB (such as eNB 102), while a receive path 250 may be described as being implemented in a UE (such as UE 116). However, it will be understood that the receive path 250 could be implemented in an eNB and that the transmit path 200 could be implemented in a UE. In some embodiments, the transmit path 200 and receive path 250 are configured to support synchronization of a D2D UE; configured to inform a D2D UE of information that the D2D UE can utilize to determine the prioritization of the network nodes to which it can synchronize; and configured to ensure a fast re-establishment of synchronization when there is change of the topology or locations of the D2D UEs.

The transmit path 200 includes a channel coding and modulation block 205, a serial-to-parallel (S-to-P) block 210, a size N Inverse Fast Fourier Transform (IFFT) block 215, a parallel-to-serial (P-to-S) block 220, an add cyclic prefix block 225, and an up-converter (UC) 230. The receive path 250 includes a down-converter (DC) 255, a remove cyclic prefix block 260, a serial-to-parallel (S-to-P) block 265, a size N Fast Fourier Transform (FFT) block 270, a parallel-to-serial (P-to-S) block 275, and a channel decoding and demodulation block 280.

In the transmit path 200, the channel coding and modulation block 205 receives a set of information bits, applies coding (such as a low-density parity check (LDPC) coding), and modulates the input bits (such as with Quadrature Phase Shift Keying (QPSK) or Quadrature Amplitude Modulation (QAM)) to generate a sequence of frequency-domain modulation symbols. The serial-to-parallel block 210 converts (such as de-multiplexes) the serial modulated symbols to parallel data in order to generate N parallel symbol streams, where N is the IFFT/FFT size used in the eNB 102 and the UE 116. The size N IFFT block 215 performs an IFFT operation on the N parallel symbol streams to generate time-domain output signals. The parallel-to-serial block 220 converts (such as multiplexes) the parallel time-domain output symbols from the size N IFFT block 215 in order to generate a serial time-domain signal. The add cyclic prefix block 225 inserts a cyclic prefix to the time-domain signal. The up-converter 230 modulates (such as up-converts) the output of the add cyclic prefix block 225 to an RF frequency for transmission via a wireless channel. The signal may also be filtered at baseband before conversion to the RF frequency.

A transmitted RF signal from the eNB 102 arrives at the UE 116 after passing through the wireless channel, and reverse operations to those at the eNB 102 are performed at the UE 116. The down-converter 255 down-converts the received signal to a baseband frequency, and the remove cyclic prefix block 260 removes the cyclic prefix to generate a serial time-domain baseband signal. The serial-to-parallel block 265 converts the time-domain baseband signal to parallel time domain signals. The size N FFT block 270 performs an FFT algorithm to generate N parallel frequency-domain signals. The parallel-to-serial block 275 converts the parallel frequency-domain signals to a sequence of modulated data symbols. The channel decoding and demodulation block 280 demodulates and decodes the modulated symbols to recover the original input data stream.

Each of the eNBs 101-103 may implement a transmit path 200 that is analogous to transmitting in the downlink to UEs 111-116 and may implement a receive path 250 that is analogous to receiving in the uplink from UEs 111-116. Similarly, each of UEs 111-116 may implement a transmit path 200 for transmitting in the uplink to eNBs 101-103 and may implement a receive path 250 for receiving in the downlink from eNBs 101-103.

Each of the components in FIGS. 2A and 2B can be implemented using only hardware or using a combination of hardware and software/firmware. As a particular example, at least some of the components in FIGS. 2A and 2B may be implemented in software, while other components may be implemented by configurable hardware or a mixture of software and configurable hardware. For instance, the FFT block 270 and the IFFT block 215 may be implemented as configurable software algorithms, where the value of size N may be modified according to the implementation.

Furthermore, although described as using FFT and IFFT, this is by way of illustration only and should not be construed to limit the scope of this disclosure. Other types of transforms, such as Discrete Fourier Transform (DFT) and Inverse Discrete Fourier Transform (IDFT) functions, could be used. It will be appreciated that the value of the variable N may be any integer number (such as 1, 2, 3, 4, or the like) for DFT and IDFT functions, while the value of the variable N may be any integer number that is a power of two (such as 1, 2, 4, 8, 16, or the like) for FFT and IFFT functions.

Although FIGS. 2A and 2B illustrate examples of wireless transmit and receive paths, various changes may be made to FIGS. 2A and 2B. For example, various components in FIGS. 2A and 2B could be combined, further subdivided, or omitted and additional components could be added according to particular needs. Also, FIGS. 2A and 2B are meant to illustrate examples of the types of transmit and receive paths that could be used in a wireless network. Any other suitable architectures could be used to support wireless communications in a wireless network.

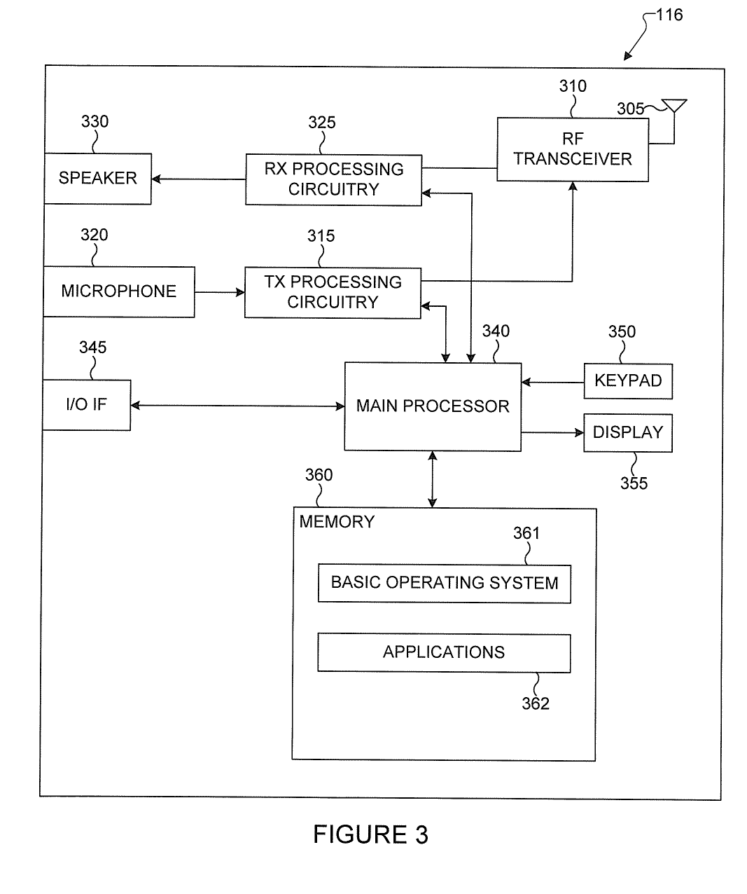

FIG. 3 illustrates an example UE 116 according to this disclosure. The embodiment of the UE 116 illustrated in FIG. 3 is for illustration only, and the UEs 111-115 of FIG. 1 could have the same or similar configuration. However, UEs come in a wide variety of configurations, and FIG. 3 does not limit the scope of this disclosure to any particular implementation of a UE.

The UE 116 includes an antenna 305, a radio frequency (RF) transceiver 310, transmit (TX) processing circuitry 315, a microphone 320, and receive (RX) processing circuitry 325. Although the example shown in FIG. 3 illustrates a single antenna 305 coupled to a single RF transceiver 310, embodiments including multiple antennas coupled to respective multiple RF transceivers could be used without departing from the scope of the present disclosure. The UE 116 also includes a speaker 330, a main processor 340, an input/output (I/O) interface (IF) 345, a keypad 350, a display 355, and a memory 360. The memory 360 includes a basic operating system (OS) program 361 and one or more applications 362.

The RF transceiver 310 receives, from the antenna 305, an incoming RF signal transmitted by an eNB of the network 100. The RF transceiver 310 down-converts the incoming RF signal to generate an intermediate frequency (IF) or baseband signal. The IF or baseband signal is sent to the RX processing circuitry 325, which generates a processed baseband signal by filtering, decoding, and/or digitizing the baseband or IF signal. The RX processing circuitry 325 transmits the processed baseband signal to the speaker 330 (such as for voice data) or to the main processor 340 for further processing (such as for web browsing data).

The TX processing circuitry 315 receives analog or digital voice data from the microphone 320 or other outgoing baseband data (such as web data, e-mail, or interactive video game data) from the main processor 340. The TX processing circuitry 315 encodes, multiplexes, and/or digitizes the outgoing baseband data to generate a processed baseband or IF signal. The RF transceiver 310 receives the outgoing processed baseband or IF signal from the TX processing circuitry 315 and up-converts the baseband or IF signal to an RF signal that is transmitted via the antenna 305.

The main processor 340 can include one or more processors or other processing devices and execute the basic OS program 361 stored in the memory 360 in order to control the overall operation of the UE 116. For example, the main processor 340 could control the reception of forward channel signals and the transmission of reverse channel signals by the RF transceiver 310, the RX processing circuitry 325, and the TX processing circuitry 315 in accordance with well-known principles. In some embodiments, the main processor 340 includes at least one microprocessor or microcontroller.

The main processor 340 is also capable of executing other processes and programs resident in the memory 360, such as operations for supporting synchronization of D2D UE; receiving and utilizing information to determine the prioritization of the network nodes to which synchronization can be performed; and operations for a fast re-establishment of synchronization when there is change of the topology or locations of the UEs. The main processor 340 can move data into or out of the memory 360 as required by an executing process. In some embodiments, the main processor 340 is configured to execute the applications 362 based on the OS program 361 or in response to signals received from eNBs or an operator. The main processor 340 is also coupled to the I/O interface 345, which provides the UE 116 with the ability to connect to other devices such as laptop computers and handheld computers. The I/O interface 345 is the communication path between these accessories and the main controller 340.

The main processor 340 is also coupled to the keypad 350 and the display unit 355. The operator of the UE 116 can use the keypad 350 to enter data into the UE 116. The display 355 may be a liquid crystal display or other display capable of rendering text and/or at least limited graphics, such as from web sites.

The memory 360 is coupled to the main processor 340. Part of the memory 360 could include a random access memory (RAM), and another part of the memory 360 could include a Flash memory or other read-only memory (ROM).

Although FIG. 3 illustrates one example of UE 116, various changes may be made to FIG. 3. For example, various components in FIG. 3 could be combined, further subdivided, or omitted and additional components could be added according to particular needs. As a particular example, the main processor 340 could be divided into multiple processors, such as one or more central processing units (CPUs) and one or more graphics processing units (GPUs). Also, while FIG. 3 illustrates the UE 116 configured as a mobile telephone or smartphone, UEs could be configured to operate as other types of mobile or stationary devices.

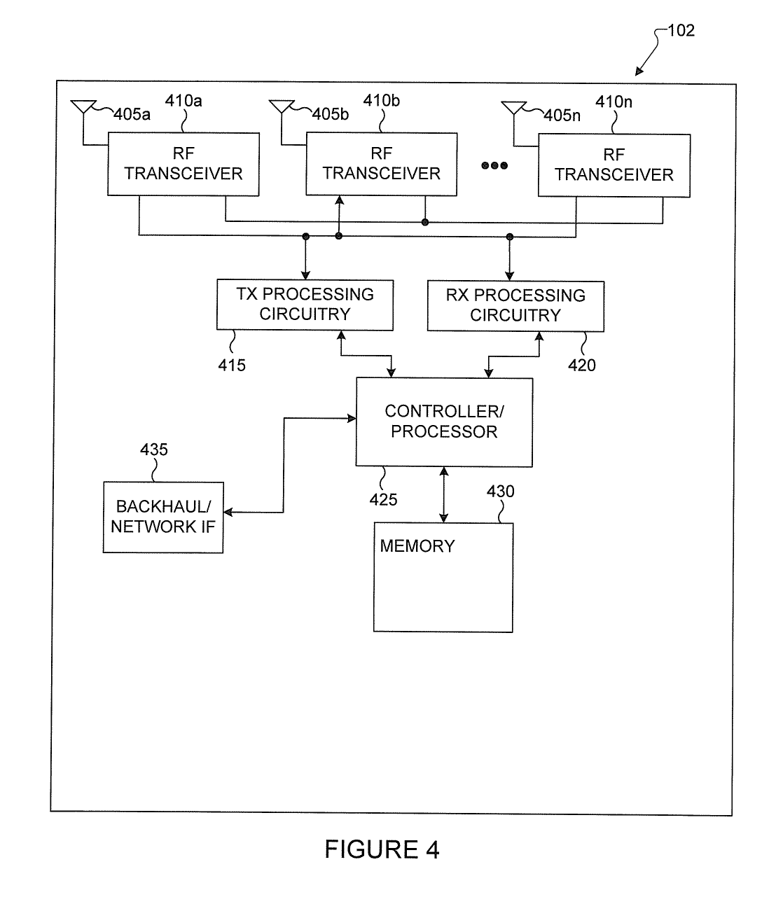

FIG. 4 illustrates an example eNB 102 according to this disclosure. The embodiment of the eNB 102 shown in FIG. 4 is for illustration only, and other eNBs of FIG. 1 could have the same or similar configuration. However, eNBs come in a wide variety of configurations, and FIG. 4 does not limit the scope of this disclosure to any particular implementation of an eNB.

The eNB 102 includes multiple antennas 405a-405n, multiple RF transceivers 410a-410n, transmit (TX) processing circuitry 415, and receive (RX) processing circuitry 420. The eNB 102 also includes a controller/processor 425, a memory 430, and a backhaul or network interface 435.

The RF transceivers 410a-410n receive, from the antennas 405a-405n, incoming RF signals, such as signals transmitted by UEs or other eNBs. The RF transceivers 410a-410n down-convert the incoming RF signals to generate IF or baseband signals. The IF or baseband signals are sent to the RX processing circuitry 420, which generates processed baseband signals by filtering, decoding, and/or digitizing the baseband or IF signals. The RX processing circuitry 420 transmits the processed baseband signals to the controller/processor 425 for further processing.

The TX processing circuitry 415 receives analog or digital data (such as voice data, web data, e-mail, or interactive video game data) from the controller/processor 425. The TX processing circuitry 415 encodes, multiplexes, and/or digitizes the outgoing baseband data to generate processed baseband or IF signals. The RF transceivers 410a-410n receive the outgoing processed baseband or IF signals from the TX processing circuitry 415 and up-converts the baseband or IF signals to RF signals that are transmitted via the antennas 405a-405n.

The controller/processor 425 can include one or more processors or other processing devices that control the overall operation of the eNB 102. For example, the controller/processor 425 could control the reception of forward channel signals and the transmission of reverse channel signals by the RF transceivers 410a-410n, the RX processing circuitry 420, and the TX processing circuitry 415 in accordance with well-known principles. The controller/processor 425 could support additional functions as well, such as more advanced wireless communication functions. For instance, the controller/processor 425 could support beam forming or directional routing operations in which outgoing signals from multiple antennas 405a-405n are weighted differently to effectively steer the outgoing signals in a desired direction. Any of a wide variety of other functions could be supported in the eNB 102 by the controller/processor 425. In some embodiments, the controller/processor 425 includes at least one microprocessor or microcontroller.

The controller/processor 425 is also capable of executing programs and other processes resident in the memory 430, such as a basic OS. The controller/processor 425 can move data into or out of the memory 430 as required by an executing process.

The controller/processor 425 is also coupled to the backhaul or network interface 435. The backhaul or network interface 435 allows the eNB 102 to communicate with other devices or systems over a backhaul connection or over a network. The interface 435 could support communications over any suitable wired or wireless connection(s). For example, when the eNB 102 is implemented as part of a cellular communication system (such as one supporting 5G, LTE, or LTE-A), the interface 435 could allow the eNB 102 to communicate with other eNBs over a wired or wireless backhaul connection. When the eNB 102 is implemented as an access point, the interface 435 could allow the eNB 102 to communicate over a wired or wireless local area network or over a wired or wireless connection to a larger network (such as the Internet). The interface 435 includes any suitable structure supporting communications over a wired or wireless connection, such as an Ethernet or RF transceiver.

The memory 430 is coupled to the controller/processor 425. Part of the memory 430 could include a RAM, and another part of the memory 430 could include a Flash memory or other ROM.

As described in more detail below, the transmit and receive paths of the eNB 102 (implemented using the RF transceivers 410a-410n, TX processing circuitry 415, and/or RX processing circuitry 420) support synchronization of D2D UE are configured to inform a D2D UE of information that the D2D UE can utilize to determine the prioritization of the network nodes to which it can synchronize; and are configured to ensure a fast re-establishment of synchronization when there is change of the topology or locations of the D2D UEs.

Although FIG. 4 illustrates one example of an eNB 102, various changes may be made to FIG. 4. For example, the eNB 102 could include any number of each component shown in FIG. 4. As a particular example, an access point could include a number of interfaces 435, and the controller/processor 425 could support routing functions to route data between different network addresses. As another particular example, while shown as including a single instance of TX processing circuitry 415 and a single instance of RX processing circuitry 420, the eNB 102 could include multiple instances of each (such as one per RF transceiver).

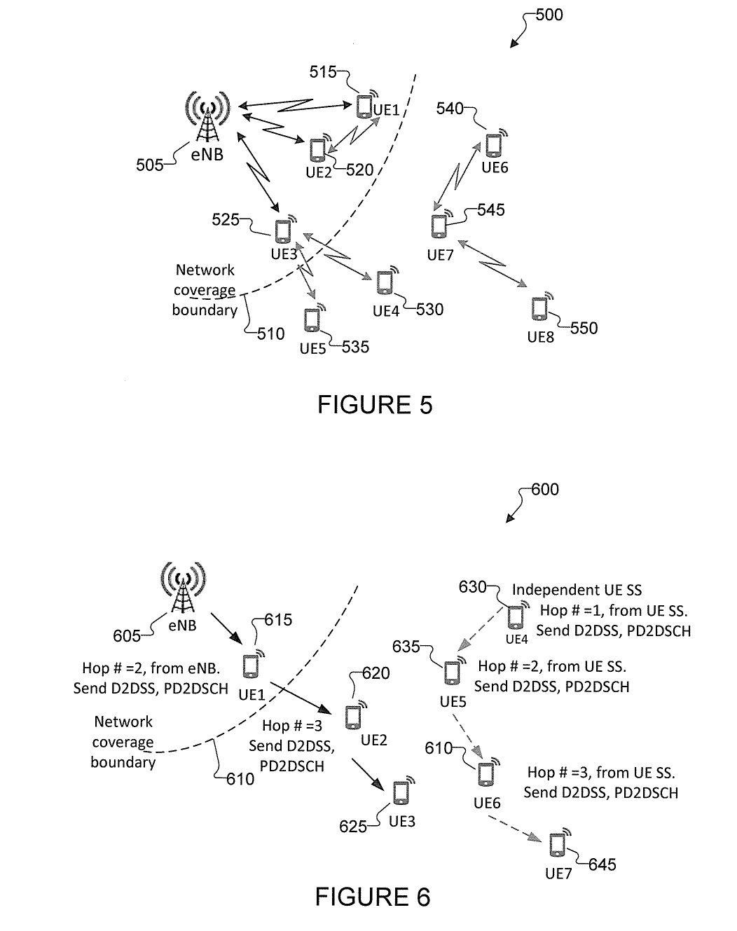

FIG. 5 illustrates an exemplary topology of D2D communication networks according to this disclosure. The embodiment of the D2D communication network 500 shown in FIG. 5 is for illustration only. Other embodiments could be used without departing from the scope of the present disclosure.

The D2D communication network 500 includes an eNB 505 that is able to communicate with a number of UEs within network coverage boundary 510. The eNB 505 communicates with UE1 515, UE2 520, UE3 525 within the network coverage boundary 510. The remaining UEs in the example shown in FIG. 5 are outside of the network coverage boundary 510. In the example shown in FIG. 5, UE1 515 and UE2 520 engage in D2D communication with each other; UE3 525 has a D2D communication with UE4 520 and UE5 535; UE6 540 has a D2D communication with UE7 545; and UE7 545 has a D2D communication with UE8 550.

Establishment of synchronization in D2D communication network 500 is an essential component to enable D2D communications. If a D2D UE, such as UE1 515, can detect other nodes, including an eNB 505 and other D2D UEs, such as UE2 520, the D2D UE, namely UE1 515, can use the detected nodes as synchronization sources to establish synchronization. If a D2D UE, such as UE1 515, cannot detect another node for synchronization, the D2D UE, namely UE1 515, is able to become an independent synchronization source. Certain nodes can have a higher priority than other nodes to be a synchronization source that a D2D UE can use. However, the mechanism for supporting synchronization of D2D UE, including which information is useful for prioritization of the synchronization source, how the prioritization is performed, how to re-establish synchronization if it is lost, is not clear in the literature.

For D2D transmission, a UE, such as UE1 515, uses uplink (UL) resources. The UL resources vary depending upon whether the system is frequency-division duplexing (FDD) or time-division duplexing (TDD), and based on the TDD UL-downlink (DL) configuration. In a TDD communication system, the communication direction in some sub-frames is in the DL and the communication direction in some other sub-frames is in the UL. Table 1 lists indicative UL-DL configurations over a period of ten (10) sub-frames, which is also referred to as frame period. The “D” denotes a DL sub-frame, “U” denotes an UL sub-frame, and “S” denotes a special sub-frame, which includes a DL transmission field referred to as Downlink Pilot Time Slot (DwPTS), a Guard Period (GP), and an UL transmission field referred to as Uplink Pilot Time Slot (UpPTS). Several combinations exist for the duration of each field in a special sub-frame, subject to the condition that the total duration is one sub-frame.

TABLE 1
TDD UL-DL configurations.

| TDD UL- | DL-to-UL | | | | | | | | | | | |
|---|---|---|---|---|---|---|---|---|---|---|---|---|
| DL Con- | Switch-point | | Sub-frame number | | | | | | | | | |
| figuration | periodicity | | 0 | 1 | 2 | 3 | 4 | 5 | 6 | 7 | 8 | 9 |
| 0 | 5 | ms | D | S | U | U | U | D | S | U | U | U |
| 1 | 5 | ms | D | S | U | U | D | D | S | U | U | D |
| 2 | 5 | ms | D | S | U | D | D | D | S | U | D | D |
| 3 | 10 | ms | D | S | U | U | U | D | D | D | D | D |
| 4 | 10 | ms | D | S | U | U | D | D | D | D | D | D |
| 5 | 10 | ms | D | S | U | D | D | D | D | D | D | D |
| 6 | 5 | ms | D | S | U | U | U | D | S | U | U | D |

The TDD UL-DL configurations in Table 1 provide 40% and 90% of DL sub-frames per frame to be DL sub-frames and the remaining to be UL sub-frames. Despite this flexibility, a semi-static TDD UL-DL configuration that can be updated every six hundred forty (640) milliseconds (ms) or less frequently by System Information (SI) signaling may not match well with short term data traffic conditions. For this reason, faster adaptation of a TDD UL-DL configuration is considered to improve system throughput especially for a low or moderate number of connected UEs. For example, when there is more DL traffic than UL traffic, the TDD UL-DL configuration is adapted to include more DL sub-frames. Signaling for faster adaptation of a TDD UL-DL configuration can be provided by several means including a PDCCH, Medium Access Control (MAC) signaling, and Radio Resource Control (RRC) signaling.

An operating constraint in an adaptation of a TDD UL-DL configuration by means other than SI signaling is an existence of UEs that cannot be aware of such adaptation. Such UEs are referred to as conventional UEs. Since conventional UEs perform measurements in DL sub-frames using a respective Cell Specific Reference Signal (CRS), such DL sub-frames cannot be changed to UL sub-frames or to special sub-frames by a faster adaptation of a TDD UL-DL configuration. However, an UL sub-frame can be changed to a DL sub-frame without impacting conventional UEs as a NodeB can ensure that such UEs do not transmit any signals in such UL sub-frames. In addition, an UL sub-frame common to all TDD UL-DL configurations should exist to enable a NodeB to possibly select this UL sub-frame as the only UL one. This UL sub-frame is subframe#2. Considering the above, Table 2 indicates the flexible sub-frames (denoted by ‘F’) for each TDD UL-DL configuration in Table 1.

TABLE 2
Flexible TTIs (F) for TDD UL-DL configurations.

| TDD UL- | DL-to-UL | | | | | | | | | | | |
|---|---|---|---|---|---|---|---|---|---|---|---|---|
| DL Con- | Switch-point | | Subframe number | | | | | | | | | |
| figuration | periodicity | | 0 | 1 | 2 | 3 | 4 | 5 | 6 | 7 | 8 | 9 |
| 0 | 5 | ms | D | S | U | F | F | D | F | F | F | F |
| 1 | 5 | ms | D | S | U | F | D | D | F | F | F | D |
| 2 | 5 | ms | D | S | U | D | D | D | F | F | D | D |
| 3 | 10 | ms | D | S | U | F | F | D | D | D | D | D |
| 4 | 10 | ms | D | S | U | F | D | D | D | D | D | D |
| 5 | 10 | ms | D | S | U | D | D | D | D | D | D | D |
| 6 | 5 | ms | D | S | U | F | F | D | F | F | F | D |

D2D communication networks support D2D discovery and D2D communication, or support D2D discovery only. In a D2D discovery, a D2D transmitter UE transmits a D2D discovery signal and one or more D2D receiver UEs receive the signal. For D2D communication, the D2D communication network supports: a Mode 1 communication where the resource used by a UE to transmit D2D control information and data is exactly scheduled by the eNB; and Mode 2 communication where a UE on its own selects resources from resource pools to transmit D2D control information and data.

It is important to ensure that out-of-coverage (OOC) UEs can communicate with each other, if they are within each other's proximity. It is also important to ensure OOC UE can communicate with in-coverage (IC) UEs, if they are within each other's proximity. An IC UE can obtain a resource pool from its own serving cell, however, in asynchronous system, cells may not be synchronized. Also, an OOC UE may not know the resource allocation configured by an eNB, as the OOC UE may not receive signal from the eNB or from UE that relays the signal from the eNB. All these make it challenging for OOC UEs or IC UEs to communicate with each other. A UE is considered in-coverage (IC) if it has a serving cell (CONNECTED) or is camping on a cell (IDLE).

To overcome the aforementioned deficiencies shown in FIG. 5, embodiments of the present disclosure provide a mechanism for supporting synchronization of D2D UE. Certain embodiments of the present disclosure also provide a system and method to inform a D2D UE of information that the D2D UE can utilize to determine the prioritization of the network nodes to which it can synchronize. Certain embodiments of the present disclosure also provide a system and method to ensure a fast re-establishment of synchronization when there is change of the topology or locations of the D2D UEs. Certain embodiments of the present disclosure also provide a system and method for an OOC UE to determine resources for transmission. Certain embodiments of the present disclosure also provide a system and method for an OOC UE to determine the resources to monitor the reception. Certain embodiments of the present disclosure also provide a system and method for enabling an OOC UE and an IC UE to communicate with each other.

An eNB can transmit a legacy sync signal, which can have Primary Sync Signal (PSS) and Secondary Sync Signal (SSS). A first D2D UE synchronizes to the eNB when the first D2D UE is able to receive a sync signal from the eNB. The first D2D UE, which is synchronized to the eNB, can transmit D2D Sync Signal (D2DSS) and Physical D2D Sync CHannel (PD2DSCH) on a hop with hop number value 2. A second D2D UE that receives the D2DSS is able to synchronize to the first D2D UE. The D2DSS carries information of the sync preamble or sequence. The D2DSS can have primary sync signal and secondary sync signal. The D2DSS also indicates whether the sync source that transmits sync signal on hop with hop number value “1” is an eNB or not. The D2DSS also indicates information related to the hop number on the hop that transmits D2DSS. The PD2DSCH carries important system information, where some information can be related to sync. For example, PD2DSCH can carry some information related to hop number in addition to the information in D2DSS. The second D2D UE can transmit D2DSS and PD2DSCH on a hop with hop number value “3”. A third D2D UE that receives the D2DSS and PD2DSCH from the second D2D UE is able to synchronize to the second D2D UE. This eNB source synchronization process can be extended to arbitrary number of hops. That is, a maximum number of hops can be defined by an amount that the system can support, where the maximum number is fixed or predefined.

A fourth D2D UE that is unable synchronize to another node, such as the eNB or a D2D UE that transmits D2DSS and PD2DSCH indicating its sync source is the eNB, is able to become a D2D UE with an independent UE sync source. The fourth D2D UE can transmit D2DSS and PD2DSCH on a hop with hop number value “1”. The D2DSS indicates that the sync source is an independent UE sync source. A fifth D2D UE that receives the D2DSS and PD2DSCH from the fourth D2D UE is able to synchronize to the fourth D2D UE. The fifth D2D UE can transmit D2DSS and PD2DSCH on a hop with hop number value “2”. A sixth D2D UE that receives the D2DSS and PD2DSCH from the fifth D2D UE is able to synchronize to the fifth D2D UE. This independent UE synchronization process can be extended to arbitrary number of hops.

A hop number is an indication of hop counting. An eNB has a hop number “1”. A first UE that syncs to eNB and that transmits D2DSS and PD2DSCH has a hop number “2”. A second UE that receives D2DSS and PD2DSCH with hop number 2 indicated from the first UE interprets that the received signal is transmitted as the second hop counting from the eNB. Alternatively, the eNB can have a first hop. The first UE syncs to eNB and transmits D2DSS and PD2DSCH with a hop number “1”. The second UE that receives D2DSS and PD2DSCH with the hop number 1 indicated from the first UE interprets that the received signal, from the first UE, is transmitted using the TX timing derived via the first hop counting from the eNB.

FIG. 6 illustrates a D2D sync establishment according to embodiments of the present disclosure. The embodiment of the D2D communication network 600 shown in FIG. 6 is for illustration only. Other embodiments could be used without departing from the scope of the present disclosure.

The D2D communication network 600 includes an eNB 605 that is able to communicate with a number of UEs within network coverage boundary 610. The eNB 605 communicates with UE1 615 within the network coverage boundary 610. The eNB 605 can be configured the same as, or similar to, eNB 102. One or more of the UE1 615, UE2 620, UE3 625, UE4 630, UE5 635, UE6 640 and UE7 645 shown in FIG. 6 can be configured the same as, or similar to, UE 116.

UE1 615 receives sync and synchronizes with eNB 605 within network coverage boundary 610. UE1 615 synchronizes with eNB 605 by deriving its TX timing from eNB 605. UE1 615 transmits D2DSS and PD2DSCH on a hop with a hop number “2”, and indicates the sync source is eNB 605. UE2 620 receives D2DSS and PD2DSCH from UE1 615 and synchronizes by deriving its TX timing also from eNB 605. UE2 620 transmits D2DSS and PD2DSCH on a hop with hop number “3”, and indicates the sync source is eNB 605. UE3 625 receives D2DSS and PD2DSCH from UE2 620. UE3 625 may not derive the TX timing from UE2 620 or from eNB 605, if hop number “3” is already the maximum hop number. UE3 625 uses another means to derive its TX timing. UE4 630 identifies itself as an independent sync source (SS) as UE4 630 cannot receive any of the sync signals from eNB 605, UE1 615, UE2 620 or UE3 625. Therefore, UE4 630 transmits D2DSS and PD2DSCH on a hop with hop number “1”, and indicates the sync source is not eNB 605. UE5 635 receives D2DSS and PD2DSCH from UE4 630 and synchronizes by deriving its TX timing from UE4 630. UE5 635 transmits D2DSS and PD2DSCH on a hop with hop number “2”, and indicates the sync source is not eNB 605. UE6 640 receives D2DSS and PD2DSCH from UE5 635 becomes synchronized. UE6 640 transmits D2DSS and PD2DSCH on a hop with hop number “3”, and indicates the sync source is not eNB 605. UE7 645 receives D2DSS and PD2DSCH from UE6 635. UE6 640 may not derive the TX timing from UE5 635 or from the independent sync source UE4 630, if hop number “3” is already the maximum hop number. UE6 640 uses another means to derive its TX timing.

The D2DSS sequences can be divided or partitioned to groups. A D2DSS sequence in a first group is used by a UE, such as UE 615, when the UE's transmission timing reference is an eNB 605. A D2DSS sequence in a second group is used by a UE, such as UE 615, when the UE's transmission timing reference is not an eNB 605. For example, UE1 615, UE2 620, UE3 625 can each use the D2DSS sequence in the first group, and UE4 630, UE5 635, UE6 640, UE7 645 can each use a D2DSS sequence in the second group.

For D2D communication, in a first mode (Mode 1), an eNB or a relay node schedules resources used by a D2D UE to transmit D2D data and D2D control information. The resources may or may not be restricted. For example, the resources may or may not be restricted to be within resource pool(s). The eNB or the relay node indicates to the D2D UE certain resources for scheduling assignment (SA) transmission. In response, the D2D UE transmits SA to other D2D UEs in the indicated resources. The SA indicates resources for D2D data. The eNB or the relay node indicates to the D2D UE certain resources to transmit D2D data together with control information, where a separate SA used to indicate resources for D2D data may not be necessary.

In a second mode (Mode 2), a UE, on its own, selects resources from resource pool(s) to transmit D2D data and D2D control information. The resource pool(s) are predefined, preconfigured, or fixed. For example, the resource pool(s) can be indicated by a physical D2D synchronization channel (PD2DSCH) that is transmitted by a D2D UE and received by one or more other D2D UEs. The resource pool(s) can also be indicated in system information block from an eNB or a relay node. The resource pool(s) for D2D data and D2D control can be the same or different. The D2D UE selects resources to transmit SA to one or more other D2D UEs, and the SA indicates resources for D2D data. The D2D UE selects resources to transmit D2D data together with control information, where a separate SA used to indicate resources for D2D data may not be necessary.

When the D2D UE, such as UE1 615, is in network coverage (in-coverage, IC), the D2D UE can at least support Mode 1. In certain embodiments, an IC UE, such as UE1 615, also is instructed by the eNB, such as eNB 605, to use Mode 2, or IC UE uses Mode 2 in certain exceptional cases, such as when an RRC connection reconfiguration starts. In certain embodiments, the D2D UE supports Mode 2 at least when the D2D UE is out-of-coverage (OOC).

In certain embodiments, an out-of-coverage (OOC) UE, such as UE2 620, needs to let another UE know whether the OOC UE has an accurate method of sync available, such as Global Positioning Signal (GPS) or Coordinated Universal Time (UTC). Such information can be carried in D2DSS and PD2DSCH. The information can be used by the other UEs, such as other OOC UEs, to prioritize to which node to sync, or from which node the OOC UE derives sync timing.

A node that derives timing from a node that transmits D2DSS and PD2DSCH on a maximum allowable hop number with respect to the origin sync type, which can be an eNB or a non-eNB, such as an independent UE SS, cannot provide sync to another node. For example, for a sync origin of eNB 605, when a maximum allowable hop number (Max_hop_eNB) is 3, then when a first node receives D2DSS and PD2DSCH from a second node, which indicates the second node derives its timing from eNB 605 on the third hop: the first node should not be a sync source; or the first node cannot provide sync to other nodes; or other nodes cannot derive timing or sync timing from the first node. The first node indicates such in its transmitted D2DSS and PD2DSCH. For example, the first node can indicate in D2DSS that the first node derives its timing from eNB 605 by using a D2DSS sequence from a set of sequences that are used by UEs that derive timing from eNB 605. Additionally, the first node also can indicate in D2DSS and PD2DSCH that the first node derives its timing from a node with hop number equal to a Max_hop_eNB originated from the eNB 605. Additionally, the first node can indicate that the first node has hop number equal to Max_hop_eNB+1 originated from the eNB 605. The max number of hop Max_hop_eNB can be fixed or preconfigured for all UEs. Therefore, other UEs that receive a hop number Max_hop_eNB+1 originated from eNB 605 know that timing cannot be derived from the node. Alternatively, if the D2DSS or PD2DSCH includes a separate indication indicating whether the node can be a sync source or not, then the UE that derives its timing from a node with hop number being Max_hop_eNB originated from eNB 605 is able to set the separate indication indicating that the node cannot be a sync source. For example, the PD2DSCH can include a 1-bit indicator filed configured to indicate whether the node can be sync source. In another example, a D2DSS sequence further partitioning, or PD2DSS and SD2DSS relative timing can be used to indicate whether the node can be a sync source or not.

In certain embodiments, an OOC UE becomes an independent sync source UE when the OOC UE is unable to locate another node that can provide sync. When the OOC UE has an accurate sync method available, such as GPS or UTC, the OOC UE transmits D2DSS and PD2DSCH and indicates that the OOC UE is an independent UE SS, with hop number 1.

For a sync origin of independent UE, when the origin is not eNB 605, when a maximum allowable hop number (Max_hop_NeNB) is 1, then when a first node receives D2DSS and PD2DSCH from a second node that indicates the second node derives timing from a non-eNB on the first hop: the first node should not be a sync source; or the first node cannot provide sync to other nodes; or other nodes cannot derive timing or sync timing from the first node. The first node can indicate such in its transmitted D2DSS and PD2DSCH. For example, the first node can indicate in D2DSS that the first node does not derive its timing from eNB 605 by using a D2DSS sequence from a set of sequences which are used by UEs that do not derive timing from eNB 605. In another example, the first node can also indicate in D2DSS and PD2DSCH that the first node derives its timing from a node with hop number equal to Max_hop_NeNB not originated from eNB 605. In another example, the first node can indicate that the first node has hop number Max_hop_NeNB+1 and is not originated from eNB 605. The max number of hop Max_hop_NeNB can be fixed or preconfigured for all UEs. Therefore, other UEs that receive a hop number equal to Maxhop_NeNB+1 not originated from eNB, know that timing cannot be derived from the node. Alternatively, when the D2DSS or PD2DSCH includes a separate indication that indicates whether the node can be a sync source or not, the UE that derives its timing from a node with hop number Max_hop_NeNB not originated from eNB 605 sets the separate indication to indicate that the node cannot be sync source. For example, the PD2DSCH can include 1-bit indicator filed configured to indicate whether the node can be sync source. In another example, D2DSS sequence further partitioning, or PD2DSS and SD2DSS relative timing can be used to indicate whether the node can be a sync source or not.

When the OOC UE is unable to locate another node that can provide sync, and when the OOC UE does not have accurate sync method available, such as GPS or UTC, the OOC UE becomes an independent sync source UE. The OOC UE indicates in its transmitted D2DSS and PD2DSCH that the OOC UE does not have accurate sync method. Alternatively, the OOC UE indicates that the OOC UE cannot be a sync source that can provide sync to any other UE. The OOC UE transmits D2DSS and PD2DSCH and indicates: that the OOC UE is an independent UE SS, such as by using a D2DSS sequence from a set of sequences that are used by UEs that do not derive timing from eNB 605, with hop number equal to Max_hop_NeNB not originated from eNB 605; that the OOC UE does not have accurate sync method; or that the OOC UE cannot be a sync source that can provide sync to any other UE. For example, the OOC UE can transmit D2DSS and PD2DSCH and indicate that the OOC UE does not derive timing from eNB 605, such as by using a D2DSS sequence from a set of sequences that are used by UEs that do not derive timing from eNB 605, and purposely indicates that the hop number equals Max_hop_NeNB+1 not originated from eNB (although actually D2DSS and PD2DSCH are transmitted with hop number 1), which implicitly tells other UEs that it cannot be a sync source which can provide sync to others. Alternatively, when D2DSS and PD2DSCH include a separate indication that indicates whether the node can be a sync source or not, the UE that is unable to locate another node that can provide sync, and that does not have accurate sync method available, such as a GPS or a UTC, sets the separate indication to indicate that the UE cannot be sync source. For example, the PD2DSCH can include 1-bit indicator filed configured to indicate whether the node can be sync source. In another example, a D2DSS sequence further partitioning, or PD2DSS and SD2DSS relative timing can be used to indicate whether the node can be a sync source or not.

When a UE, such as UE 615 cannot be a sync source, or when the UE 605 cannot provide sync to another UE, the UE 605 is still able to transmit D2DSS and PD2DSCH and other signals for D2D communications. A second UE receives, from the first UE, a signal that includes information on a first UE that can be or cannot be a sync source, or whether the first UE has and accurate sync method available or not, is used for the purpose of sync pnontization when selecting or reselecting a node to sync to by a second UE, where the. The second UE uses the sync signal received from the first UE to determine the second UE's RX timing to monitor the D2D signal from the first UE, or D2D signal from any other UE that uses the same TX timing as the first UE. The second UE may not use the timing derived from the sync signal received from the first UE as the second UE's own TX timing for D2D signal, such as the second UE's own D2DSS and PD2DSCH, and another D2D signal. The second UE may need to use TX timing determined by another method, such as by using a GPS or UTC, or by using D2DSS and PD2DSCH received from other nodes that are eligible to provide sync to another UE.

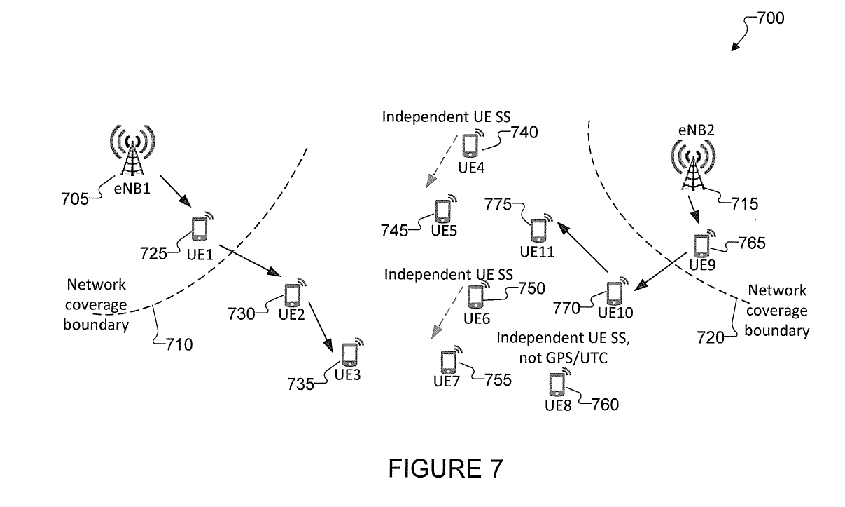

FIG. 7 illustrates D2D sync establishment according to embodiments of the present disclosure. The embodiment of the D2D communication network 700 shown in FIG. 7 is for illustration only. Other embodiments could be used without departing from the scope of the present disclosure.

The D2D communication network 700 includes a first eNB, eNB1 705, that is able to communicate with a number of UEs within network coverage boundary 710. The eNB1 705 communicates with UE1 715 within the network coverage boundary 710. The D2D communication network 700 also includes a second eNB, eNB2 715, that is able to communicate with a number of UEs within network coverage boundary 720. The eNB1 705 and eNB2 715, can be configured the same as, or similar to, eNB 102. One or more of the UE1 725, UE2 730, UE3 735, UE4 740, UE5 745, UE6 750, UE7 755, UE8 760, UE9 765, UE10 770 and UE11 775 shown in FIG. 7 can be configured the same as, or similar to, UE 116.

UE1 725 receives sync and synchronizes with eNB1 705 within network coverage boundary 710. UE1 725 transmits D2DSS and PD2DSCH on a hop with hop number “1”, which is the second hop counting from the sync origin of eNB1 705, assuming eNB1 705 has a hop number “0”. UE2 730 receives D2DSS and PD2DSCH from UE1 725 and is synchronized. UE2 730 transmits D2DSS and PD2DSCH on a hop with hop number “2”, which is the third hop counting from the sync origin of eNB1 705. UE3 735 receives D2DSS and PD2DSCH from UE2 730 and is synchronized in which its TX timing is derived from UE2 730 or eNB1 705. In the example shown in FIG. 7, a maximum hop number is allowed when the sync origin is eNB1 705. For example, when the sync origin is eNB1 705, the max hop number allowed is three (3). UE3 735 transmits D2DSS and PD2DSCH and indicates that UE3 735 obtains sync from a node. UE3 735 further indicates its TX timing is at a max hop number “3” originated from eNB1 705 to inform one or more other UEs not use UE3 735 as a sync source, namely the one or more other UEs will not derive TX timing from the timing of UE3 735.

UE4 740 identifies itself as an independent sync source (SS) since UE4 740 does not receive a sync signal from eNB 705 or another UE. UE4 740 transmits D2DSS and PD2DSCH on a hop with hop number “1” indicating the first hop counting from the sync origin of an independent UE SS. In the example shown in FIG. 7, UE5 745 can detect only UE4 740 as a node that can provide sync and does not detect another UE as a node that can provide sync. UE5 745 receives D2DSS and PD2DSCH from UE4 740 and is synchronized, that is, derives timing from UE4 740. UE5 745 transmits D2DSS and PD2DSCH on a hop with hop number “2”, which is the second hop counting from the sync origin of an independent UE SS, namely UE4 740. In the example shown in FIG. 7, a maximum hop number is allowed when the sync origin is an independent UE SS, namely UE4 740. For example, when the sync origin is an independent UE SS, namely UE4 740, the max hop number allowed if is “1”. UE5 745 transmits D2DSS and PD2DSCH, and indicates that UE5 745 obtains a sync from a node with a max hop number originated from independent UE SS, namely UE4 74, to inform other UEs to not use UE5 745 as a sync source.

UE6 750 and UE7 755 are similar to UE4 740 and UE5 745, respectively. UE8 760 identifies itself as an independent sync source (SS) as UE8 760 does not receive a sync signal from eNB1 705, eNB2 715 or another UE. Therefore, UE8 760 transmits D2DSS and PD2DSCH on a hop with hop number “1”, which is the first hop counting from the sync origin of independent UE SS, namely UE8 760. If UE8 760 does not have an accurate sync method available, such as GPS or UTC, UE8 760 transmits D2DSS and PD2DSCH and indicates that UE8 760 does not have accurate sync method. Based on the transmission from UE8 760, other UEs are informed not use UE8 760 as a sync source. If UE4 740 and UE6 750 have accurate sync methods available, such as GPS or UTC, when UE4 740 and UE6 750 each transmit D2DSS and PD2DSCH, UE4 740 and UE6 750 respectively indicate that they have accurate sync method. For example, UE4 740 can inform other UEs that they have accurate sync method by indicating the hop number value being “1” and that UE 740 is an independent UE SS. In addition, For example, UE6 750 can inform other UEs that they have accurate sync method by indicating the hop number value being “1” and that UE6 750 is an independent UE SS.

UE9 765 receives sync and synchronizes with eNB2 715 within network coverage boundary 720. UE9 765 transmits D2DSS and PD2DSCH on a hop with hop number “1”, which is the second hop counting from the sync origin of eNB2 715 assuming eNB2 715 has a hop number “0”. UE10 770 receives D2DSS and PD2DSCH from UE9 765 and gets synchronized. UE10 770 transmits D2DSS and PD2DSCH on a hop with hop number “2”, which is the third hop counting from the sync origin of eNB2 715. UE11 775 receives D2DSS and PD2DSCH from UE10 770 and gets synchronized in which its TX timing is derived from UE10 770 or eNB2 715. In the example shown in FIG. 7, a maximum hop number is allowed when the sync origin is eNB2 715. For example, when the sync origin is eNB2 715, the max hop number allowed is three (3). UE11 775 transmits D2DSS and PD2DSCH and indicates that UE11 775 obtains sync from a node. UE11 775 further indicates its TX timing is at a max hop number “3” originated from eNB2 715 to inform one or more other UEs not use UE11 775 as a sync source, namely the one or more other UEs will not derive TX timing from the timing of UE11775.

Based on how a UE derives TX reference timing, the UE can be in one of a number of categories. D2D UEs can be an in coverage (IC) UE, referred to as an IC UE. A UE can be considered in-coverage if it has a serving cell (CONNECTED) or is camping on a cell (IDLE). The IC UE derives its TX reference timing from eNB. An out-of-coverage (OOC) UE with TX reference timing from an eNB is referred to as OOC category 1 UE (OOC cat. 1 UE). An out-of-coverage UE with TX reference timing not from an eNB is referred to as OOC cat. 2 UE. For example, in the example shown in FIG. 7, the D2D communication network 700 includes:

1) IC UEs: UE1 725, UE9 765;

2) OOC cat. 1 UEs, in which TX timing is derived from an eNB: UE2 730, UE3 735, UE10 770 and UE11 775; and

3) OOC cat. 2 UEs, in which TX timing is not derived from an eNB: UE4 740, UE6 750, UE5 745, UE7 755 and UE8 760.

Throughout the disclosure, the measurement on a sync signal can be a measurement on, one or more of: a PD2DSS, an SD2DSS, a D2DSS, namely a PD2DSS and SD2DSS, a PD2DSCH, or the demodulation reference signal (DMRS) for PD2DSCH.

In certain embodiments, D2DSS and PD2DSCH indicate information related to respective hop number relative to a sync source. The indication of information related to respective hop number on D2DSS can be via the relative time domain positions of a Primary D2DSS (PD2DSS) and a Secondary D2DSS (SD2DSS), or via different sets of sync preamble sequence, or any combination thereof. The indication of information related to respective hop number on PD2DSCH can be, for example, in a payload.

In one approach, information related to respective hop number relative to a sync source is communicated via the relative time domain positions of a PD2DSS and a SD2DSS. For example, a first relative time domain positions of a PD2DSS and a SD2DSS indicates a first hop number value, a second relative time domain positions of a PD2DSS and a SD2DSS indicates a second hop number value.

A node that derives timing from a node that transmits D2DSS and PD2DSCH on a maximum allowable hop number with respect to the origin sync type, which can be an eNB or a non-eNB, such as an independent UE SS, cannot provide sync to another node. The node indicates such in its transmitted D2DSS and PD2DSCH. When an OOC UE is unable to locate any other node that can provide sync, and when the OOC UE does not have accurate sync method available, such as a GPS or a UTC, the OOC UE indicates in its transmitted D2DSS and PD2DSCH that the OOC UE cannot provide sync to other node. Table 3 illustrates an example of such indication.

TABLE 3
Information fields in PD2DSCH

| | Size | |
|---|---|---|
| | (bits) | Information |
| . . . | . . . | . . . |
| Indication of whether the UE that | 1 | Value ‘0’ indicates: no |
| transmits the PD2DSCH can provide | | Value ‘1’ indicates: yes |
| sync to other nodes or not | | |
| . . . | . . . | . . . |

A UE indicates whether the UE has an accurate sync method available or not. The accurate sync method can include a GPS, UTC, and the like. Table 4 illustrates an example of the indication, or indicator.

TABLE 4
Information fields in PD2DSCH

| | Size | |
|---|---|---|
| | (bits) | Information |
| . . . | . . . | . . . |
| Indication of whether the UE that | 1 | Value ‘0’ indicates: no |
| transmits the PD2DSCH has accurate | | Value ‘1’ indicates: yes |
| sync method available or not | | |
| . . . | . . . | . . . |

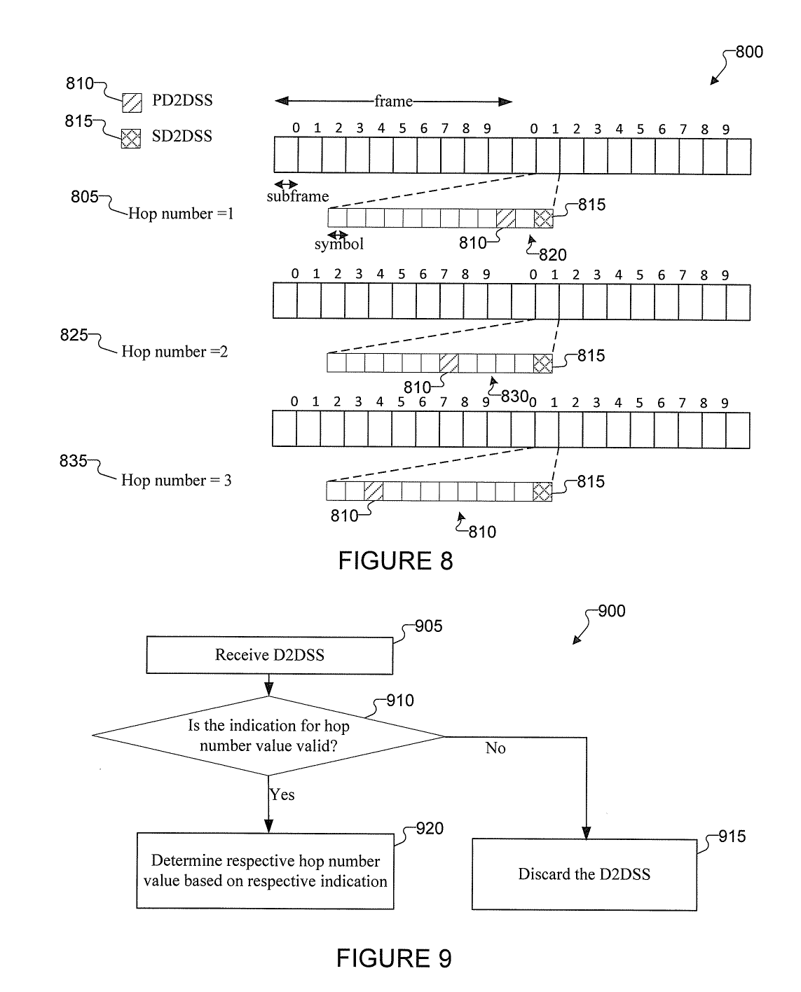

FIG. 8 illustrates an exemplary configuration for different relative time domain positions of a PD2DSS and a SD2DSS to indicate different hop number values according to embodiments of the present disclosure. The embodiment of the time domain positions 800 shown in FIG. 8 is for illustration only. Other embodiments could be used without departing from the scope of the present disclosure.

In the example shown in FIG. 8, in a first TX timing 805 having a hop number value of “1”, PD2DSS 810 and SD2DSS 815 are separated from each other by two symbols 820. In a second TX timing 825 having a hop number value of “2”, PD2DSS 810 and SD2DSS 815 are separated from each other by five symbols 830. In a second TX timing 835 having hop number value of “3”, PD2DSS 810 and SD2DSS 815 are apart from each other by ten symbols 840. In the example shown in FIG. 8, one symbol is used for PD2DSS and another symbol is used for SD2DSS, but the present disclosure is not limited to such; rather, embodiments of the present disclosure can be extended to the case where one or multiple symbols are used for PD2DSS, and one or multiple symbols are used for SD2DSS. For example, two symbols could be used for PD2DSS or for SD2DSS, where these two symbols can be adjacent to each other or also be positioned with one or more symbols between them. In certain embodiments, the time domain positions can be extended from the relative timing of PD2DSS and SD2DSS to periodicity, the timing of the transmission of D2DSS (for example, the sub-frame or frame position), and any combinations thereof.

In another approach, information related to respective hop number relative to a sync source can be indicated via different sets of preambles or sequences on carried on D2DSS. Preambles on D2DSS can be partitioned to disjoint sets, where a set can be used to indicate a hop number value. For example, a first set of preambles indicate a first hop number value, a second set of preambles indicate a second hop number value. Each D2D UE chooses a preamble randomly from the respective set of preambles to transmit D2DSS and PD2DSCH on a hop with a respective hop number value. Alternatively, each D2D UE can be preconfigured or receive a configuration indicating which preamble to select for a respective hop number value. In one example, the selection of a preamble within a set is determined by a UE's group association or group ID. Table 5 illustrates an example of hop number value being indicated by preamble set.

In Table 5 and other tables in the disclosure, it is assumed the hop from the eNB is counted as hop number “1”, and the UE directly that syncs to the eNB is counted as hop number “2”, an independent sync source from the UE is counted as hop number “1”, and a UE directly that syncs to the independent UE sync source is counted as hop number “2”. In certain embodiments, the hop from the eNB is counted as hop number “0”, and the UE directly sync'd to the eNB is counted as hop number “1”, and a UE that syncs the UE with hop number “1” will have hop number “2”.

TABLE 5
Hop number value indicated by preamble set

| State | Indication method |
|---|---|
| hop = 1 | Preamble set 1 |
| hop = 2 | Preamble set 2 |
| hop = 3 | Preamble set 3 |

There can be equal or unequal number of preambles in each set, where each set is used to indicate a hop number value. For example, there may be fewer UEs to transmit on hop with hop number value being “1”, a smaller number of preambles can be assigned to the set of preambles. The partition of the preamble sets can be fixed, predefined, broadcast, or informed to UEs.

FIG. 9 illustrates process 900 for a D2D UE to determine a hop number value from a received D2DSS according to embodiments of the present disclosure. While the flow chart depicts a series of sequential steps, unless explicitly stated, no inference should be drawn from that sequence regarding specific order of performance, performance of steps or portions thereof serially rather than concurrently or in an overlapping manner, or performance of the steps depicted exclusively without the occurrence of intervening or intermediate steps. The process depicted in the example depicted is implemented by a transmitter chain in, for example, a mobile station.

In block 905, a D2D UE receives D2DSS. The UE decodes D2DSS and determines whether the indication for the hop number value is valid in block 910. If the indication for the hop number value is not valid, the UE discards the received D2DSS in block 915. If the indication for the hop number value is valid, the UE determines respective hop number value based on respective indication in block 920. For example, assuming there are preconfigured three configurations of relative time domain positions of PD2DSS and SD2DSS to indicate three respective hop number values, when a D2DUE detects the relative time domain positions of PD2DSS and SD2DSS are not any of the preconfigured configurations, the D2DUE regards the signal invalid and discard the received D2DSS in block 915. If a D2D UE detects the relative time domain positions of PD2DSS and SD2DSS are one of the preconfigured configurations, the D2D UE determines respective hop number value according to the detected relative time domain positions of PD2DSS and SD2DSS in block 920. Similar operations can be for when the preamble sets are used to indicate the hop number values. It is noted that block 910 and block 915 may be skipped, and the D2D UE determines one of the hop number values. Alternatively, block 910 and block 915 can occur in parallel to block 920. For example, after receiving D2DSS, the UE can determine respective hop number based on respective indication, and if the indication for hop number is invalid, the UE discards the received D2DSS.

In one extension, information related to respective hop number relative to a sync source and information related to the sync source are jointly indicated via an indication configuration on D2DSS, which can be based on preamble set or time domain positions, or a combination thereof. The time domain positions can be periodicity, the timing of the transmission of D2DSS, such the sub-frame or frame position, the relative timing of PD2DSS and SD2DSS, and a combination thereof. After the D2D UE receives D2DSS, the D2D UE determines information related to respective hop number value and sync source, according to the detected indication in D2DSS.

When the sync source is the eNB, hop number value “1” can be omitted as the eNB can transmit a legacy sync signal that a D2D UE is able to recognize. Hence, in certain embodiments a maximum hop number (Max_hop_eNB) if eNB is sync source, the hop number value falls to the range of [2 . . . Max_hop_eNB]. When sync source is a UE, in certain embodiments, a maximum hop number (Max_hop_UE) if a UE is sync source, the hop number value falls to the range of [1 . . . Max_hop_UE]. The Max_hop_eNB and Max_hop_eNB can be the same or different. When Max_hop_eNB and Max_hop_eNB are the same, a common parameter Max_hop is used.

Table 6 illustrates an example of jointly indicating Sync Source Type (SST) and hop number value by indication configuration, where the indication configuration can be based on preamble set or time domain positions, or combination thereof. In one example, Max_hop=3. In total, five indication configurations exist. For example, five different sets of preambles can be used, with each preamble set as an indication configuration. For another example, five different relative time domain positions can be used for PD2DSS and SD2DSS, with each relative position as an indication configuration. Alternatively, different time domain positions can be used for D2DSS, such as the position of a sub-frame in which D2DSS is transmitted, within a cycle of the D2DSS transmission, such as certain positions of sub-frames (for instance, the 5^{th}, 10^{th}, and so forth) within a 40 ms cycle (that is forty sub-frames) of D2DSS transmission. In another example, indication configurations “1” and “2” use a first set of preambles, while the hop number can be differentiated by time domain positions; indication configurations “3”, “4”, or “5” use a second set of preambles, while the hop number can be differentiated by time domain positions. The indication configuration can be fixed or predefined or notified to a UE in advance. After a D2D UE receives D2DSS, the D2D UE determines SST and a respective hop number value, according to the detected indication configuration in D2DSS. Assume Max_hop_eNB=3 and Max_hop_UE=2, then indication configuration “5” is not necessary.

Throughout the disclosure, the time domain positions refer to the relative timing domain distance of PD2DSS and SD2DSS. Alternatively, the time domain positions refer to the time domain positions of the sub-frame where D2DSS is transmitted within a D2DSS transmission cycle.

TABLE 6
Sync source type and hop number value indicated
by indication configuration

| State | Indication method |
|---|---|
| | Indication configuration can be based on |
| | preamble set or time domain positions, or any |
| | combination thereof |
| SST = eNB, hop = 2 | Indication configuration 1 |
| SST = eNB, hop = 3 | Indication configuration 2 |
| SST = UE, hop = 1 | Indication configuration 3 |
| SST = UE, hop = 2 | Indication configuration 4 |
| SST = UE, hop = 3 | Indication configuration 5 |

In another approach, information related to respective hop number relative to a sync source is indicated jointly by D2DSS and PD2DSCH. For example, hop number values can be partitioned into multiple sets, where D2DSS is used to indicate which set the hop number value is in and PD2DSCH is used to indicate exact hop number value within a respective set. Within a set of hop number values, there can be one or multiple hop number values. The configuration of the partitioning of the hop number values to multiple sets, and the indication configuration can be fixed or predefined or notified to a UE in advance. A D2D UE detects D2DSS and PD2DSCH to determine the hop number value accordingly.

For example, with a maximum hop number equal to “3”, hop number values can be partitioned to two sets: the first set of hop number values has one element, hop number value “1”; and the second set of hop number values has two elements, hop number value “2” or hop number value “3”. In certain embodiments, the partition includes a first set of hop number values that are not a maximum, while a second set includes hop number value equal to the maximum.

Table 7 and Table 8 illustrate examples of an indication of hop number value jointly by D2DSS and PD2DSCH. In the examples, Max_hop=3. In Table 7, a first indication configuration on D2DSS indicates a first set of hop number values, and a second indication configuration on D2DSS indicates a second set of hop number values. In the examples, the first set of hop number values has one element, hop number value “1”, and the second set of hop number values has two elements, hop number value “2” or hop number value “3”. If a D2D UE detects the second indication configuration on D2DSS, the D2D UE further detects PD2DSCH. In PD2DSCH, the D2D UE indicates hop number value “2” if a 1-bit indicator of hop number has value “0”, and the D2D UE indicates hop number value “3” if a 1-bit indicator of hop number has value “1”, as shown in Table 8.

TABLE 7
Set of hop number values indicated by indication configuration on D2DSS

| State | Indication method |
|---|---|
| | Indication configuration can be based on |
| | preamble set or time domain positions, or |
| | any combination |
| First set of hop number | Indication configuration 1 on D2DSS |
| values, hop = {1} | (for example, preamble sequence set, |
| | or time domain positions) |
| Second set of hop number | Indication configuration 2 on D2DSS |
| values, hop = {2, 3} | (for example, preamble sequence set, |
| | or time domain positions) |

TABLE 8
Hop number value indicated by PD2DSCH

| | Size | |
|---|---|---|
| | (bits) | Information |
| . . . | . . . | . . . |
| If D2DSS indicates ‘second | 1 | For value ‘0’, it indicates hop = 2. |
| set of hop number values’, | | For value ‘1’, it indicates hop = 3. |
| indicates hop number | | |
| . . . | . . . | . . . |

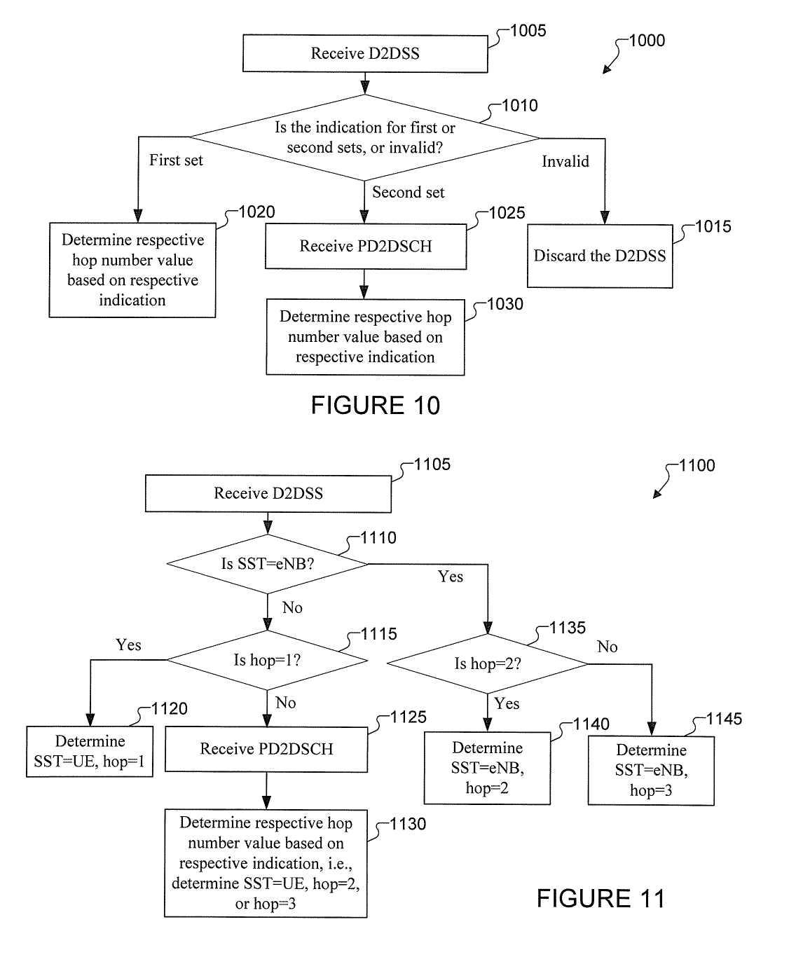

FIG. 10 illustrates a process for a D2D UE to determine a hop number value from a received D2DSS and PD2DSCH 1000 according to embodiments of the present disclosure. While the flow chart depicts a series of sequential steps, unless explicitly stated, no inference should be drawn from that sequence regarding specific order of performance, performance of steps or portions thereof serially rather than concurrently or in an overlapping manner, or performance of the steps depicted exclusively without the occurrence of intervening or intermediate steps. The process depicted in the example depicted is implemented by a transmitter chain in, for example, a mobile station.

In block 1005, a D2D UE receives D2DSS. The D2D UE decodes D2DSS and determines whether the indication for set of hop number values is for a first set, a second set, or invalid in block 1010. If the indication for set of hop number values is invalid, the D2D UE discards the received D2DSS in block 1015. If the indication for set of hop number values indicates the first set of hop number values, and if the set has one element, the D2D UE determines the hop number value in block 1020. If the indication for set of hop number values indicates the second set of hop number values, and if the set has more than one element, according to the fixed or predefined partition of the sets of hop number values, the D2D UE further receives PD2DSCH in block 1025, and the D2D UE determines respective hop number value based on respective indication in PD2DSCH 550. It is noted that block 1010 and block 1015 may be skipped.

In certain embodiments, information related to respective hop number relative to a sync source and information related to the sync source are jointly indicated jointly by D2DSS and PD2DSCH. For example, information of sync source and information of hop number value can be partitioned into multiple sets, where D2DSS is used to indicate which set the information of sync source and information of hop number values is in, and PD2DSCH is used to indicate exact information of sync source and information of hop number value within a respective set. Within a set of information of sync source and information of hop number value, one or multiple elements can be used. The configuration of the partitioning of the information of sync source and information of hop number value into multiple sets, and the indication configuration can be fixed or predefined or notified to a UE in advance. A D2D UE detects D2DSS and PD2DSCH to determine the information of sync source and information of hop number value accordingly. The UE's operations are similar to the ones shown in FIG. 10.

Table 9 and Table 10 illustrate an example of indication of SST and hop number value jointly by D2DSS and PD2DSCH, where a maximum number of hop “3” is assumed. In Table 9, an i-th indication configuration on D2DSS indicates an i-th set of hop number values, where i=1, 2, 3, 4. In the example, the first, the second, and the third set of SST and hop number values each has one element, and the fourth set of SST and hop number values has two elements, with SST being UE and hop number value “2” or “3”. If a D2D UE detects the fourth indication configuration on D2DSS, the D2D UE further detects PD2DSCH. In PD2DSCH, the D2D UE indicates hop number value “2” if a 1-bit indicator of hop number has value “0”, and the D2D UE indicates hop number value “3” if a 1-bit indicator of hop number has value “1”, as shown in Table 10. In certain embodiments, Max_hop_eNB=3 and Max_hop_UE=2, then Table 10 is not necessary, and the fourth set will have hop=“2”. In another example, the third set and the four set can be combined as one set, for SST=UE, regardless of the hop number.

It is noted that throughout the disclosure, SST=eNB is used to indicate the origin of the sync is the eNB, and there could be UEs along the following chain of sync hops, and SST=UE is used to indicate the origin of the sync is UE, and there also can be a following chain of sync hops from the origin of the chain that is the UE.

TABLE 9
Set of sync source type and hop number value indicated
by indication configuration on D2DSS

| State | Indication method |
|---|---|
| | Indication configuration can be |
| | based on preamble set or time |
| | domain positions, or any combination |
| First set: SST = eNB, hop = 2 | Indication configuration 1 |
| Second set: SST = eNB, hop = 3 | Indication configuration 2 |
| Third set: SST = UE, hop = 1 | Indication configuration 3 |
| Fourth set: SST = UE, | Indication configuration 4 |
| hop = {2, 3} | |

TABLE 10
Sync source type and hop number value indicated by PD2DSCH

| | Size | |
|---|---|---|
| | (bits) | Information |
| . . . | . . . | . . . |
| If D2DSS indicates ‘fourth set | 1 | For value ‘0’, it indicates hop = 2. |
| of sync source type and hop | | For value ‘1’, it indicates hop = 3. |
| number value’, indicates hop | | |
| number | | |
| . . . | . . . | . . . |

One of the advantages of the above is that the process enables other UEs to determine prioritization of the node from which the UE can sync, based on detected SST and the hop number, while keeping the D2DSS more reliable with reduced information comparing to the case that D2DSS conveys all the hop values.

In certain embodiments, the indication configuration is fixed or predefined, and can be achieved in different ways. For example, there can be four different sets of preambles, with each preamble set as an indication configuration. For instance, 2-bits in a preamble sequence, such as the first 2-bits or last 2-bits of a preamble sequence, can be used, with ‘00’, ‘01’, ‘10’, ‘11’ indicating the first, second, third, fourth set of SST and hop number value, respectively. In a variation, 1-bit in a preamble sequence can be used, with ‘0’, ‘1’ indicating the first, second SST (for example, eNB or UE), and another 1-bit out of a preamble sequence can be used, with ‘0’, ‘1’ further differentiate hop number, respectively. For another example, there can be four different relative time domain positions for PD2DSS and SD2DSS, with each relative position as an indication configuration. In another example, there can be multiple or different time domain positions for the location of sub-frames in which the D2DSS is transmitted within a D2DSS cycle. In another example, indication configuration “1”, “2” can use a first set of preambles, while the hop number can be differentiated by time domain positions; indication configuration “3”, “4” can use a second set of preambles, while the hop number can be differentiated by time domain positions. This example is illustrated by Table 11 below where a maximum number of hop “3” is assumed. In certain embodiments, Max_hop_eNB=3 and Max_hop_UE=2, then time domain positions configuration “2” will only have hop=2 for SS=UE.

TABLE 11
Sync source type and hop number value indicated by
indication configuration on D2DSS

| State | Indication method |
|---|---|
| SST = eNB | Preamble set 1 |
| SST = UE | Preamble set 2 |
| hop = 2 for SST = eNB, | Time domain positions configuration 1 |
| hop = 1 for SST = UE | |
| hop = 3 for SST = eNB, | Time domain positions configuration 2 |
| hop = {2, 3} for SST = UE. | |

FIG. 11 illustrates a process for a D2D UE to determine a sync source type and a hop number value from a received D2DSS and PD2DSCH according to embodiments of the present disclosure. While the flow chart depicts a series of sequential steps, unless explicitly stated, no inference should be drawn from that sequence regarding specific order of performance, performance of steps or portions thereof serially rather than concurrently or in an overlapping manner, or performance of the steps depicted exclusively without the occurrence of intervening or intermediate steps. The process depicted in the example depicted is implemented by a transmitter chain in, for example, a mobile station.

In the example shown in FIG. 11, a maximum number of hop is “3”. In block 1105, a D2D UE receives D2DSS. In block 1110, the D2D UE decodes D2DSS and determines whether the indication indicates SST is eNB or not. If the indication indicates SST is not an eNB in block 1110, the D2D UE determines whether the indication indicates a hop number value “1” in block 1115. If the indication is hop number value “1”, the D2D UE determines that the SST is the UE and a hop number value is “1” in block 1120. If the hop number value is not “1”, the D2D UE receives and detects PD2DSCH in block 1125 and determines a respective hop number value based on respective indication in PD2DSCH in block 1130. That is, the D2D UE determines that the SST is a UE from the detected D2DSS and that the hop number value is “2” or that the hop number value is “3” from detected PD2DSCH. If in block 1110 the D2D UE determines SST is an eNB, the D2D UE determines whether the indication in the D2DSS indicates a hop number value “2” in block 1135. If the indication is hop number value “2”, the D2D UE determines that the SST is the eNB and that the hop number value is “2” in block 1140. Alternatively, f the indication is hop number value is not “2”, the D2D UE determines that the SST is the eNB and that the hop number value is “3” in block 1145.

In another approach, information related to a respective hop number relative to the sync source is fully included in the PD2DSCH, not included in the D2DSS. For example, a field in the PD2DSCH can provide a hop number value. In certain embodiments, the field in the PD2DSCH is a 2-bit field, where ‘00’ designates a hop number value “1”; ‘01’ designates a hop number value “2”; ‘10’ designates a hop number value “3”; and ‘11’ designates a hop number value “4”. In certain embodiments, a maximum hop number is 3 and, when the D2DSS indicates that the sync source type is an eNB, the PD2DSCH includes a 1-bit field to indicate hop number value, where a ‘0’ designates a hop number value “2” and ‘1’ designates a hop number value “3”. In certain embodiments, a maximum hop number is 3 and, when the D2DSS indicates the sync source type is a UE, the PD2DSCH includes a 2-bit field, where ‘00’ designates a hop number value “1”, ‘01’ designates a hop number value “2”, and ‘10’ designates a hop number value “3”.

In certain embodiments, the PD2DSCH also includes a field to indicate the maximum hop number. In certain embodiments, the maximum hop number is not indicated, but the PD2DSCH includes a field to indicate whether the transmission of D2DSS and PD2DSCH is on a hop with maximum hop number. Table 12 illustrates an example of such indication.

TABLE 12
Information fields in PD2DSCH

| | Size | |
|---|---|---|
| | (bits) | Information |
| . . . | . . . | . . . |
| Indication of whether the | 1 | Value ‘0’ indicates: not a |
| transmission of D2DSS | | maximum hop number value |
| and PD2DSCH is on a hop | | Value ‘1’ indicates: maximum |
| with maximum hop | | hop number value |
| number | | |
| . . . | . . . | . . . |

One of the advantages of the 1-bit field in Table 12 is to save payload in the PD2DSCH as compared to transmitting the maximum hop number value. For example, when a maximum hop number value is configurable and the value is chosen from a set {2, 3, 4}, then a 2-bit indicator is needed. However, utilizing the method with Table 12, only a 1-bit indicator is necessary.

In one example, the D2DSS sequences used by the UE are partitioned to two groups. The first group or set, referred to as D2DSS_set1, is the set of sequences that can be used by a UE that derives TX timing from an eNB. The second group or set, referred to as D2DSS_set2, is the set of sequences that can be used by a UE that derives TX timing from a non-eNB source, such as an independent UE.

In certain embodiments, an IC UE and an OOC cat. 1 UE use the D2DSS sequence from the set D2DSS_set1, while OOC cat. 2 UE uses the D2DSS sequence from the set D2DSS_set2. For example, to further differentiate the IC UE and the OOC cat. 1 UE, the hop number is used. In one example, the IC UE uses hop number “1”, that is when the eNB hop is counted as hop number “0”, or hop number 2, that is when the hop from eNB is counted as hop number 1, while the OOC cat. 1 UE uses a hop number more than “1”, also when the eNB hop is counted as hop number “0”, or more than 2, also when the eNB hop is counted as hop number “1”. In another example, to further differentiate the IC UE and the OOC cat. 1 UE, further partitioning of the D2DSS_set1 sequences is used, or different relative distances of PD2DSS and SD2DSS are used, or different relative distances of PD2DSS and SD2DSS are used, or an indication in PD2DSCH is used, such as a ‘1’-bit indication to differentiate IC and OOC, or an implicit indication by a field in the Physical Cell Identifier (PCID) of the cell from which the UE derives its TX timing. When the field of the PCID is present, it means the UE is IC UE, and when the field of the PCID is not present, it means the UE is OOC cat. 1 UE.

In certain embodiments, the IC UE uses the D2DSS sequence from the set D2DSS_set1, while the OOC cat. 1 and the OOC cat. 2 UE use the D2DSS sequence from the set D2DSS_set2. To further differentiate the OOC cat. 1 UE and the OOC cat. 2 UE, further partitioning of the D2DSS_set2 sequences can be used, or different relative distances of PD2DSS and SD2DSS can be used, or an indication in the PD2DSCH can be used, such as a ‘1’-bit indication to differentiate OOC cat. 1 or OOC cat. 2, or an implicit indication by a field in the PCID of the cell from which the UE derives its TX timing. When the field is present in the PCID, it means the UE is the OOC cat. 1 UE, and when the field is not present in the PCID, it means the UE is the OOC cat. 2 UE.

The differentiation methods illustrated in the disclosure for two sets can be used for either option above similarly. Combination of the methods or options mentioned in the disclosure can also apply.

In another example, the information related to a respective hop number relative to a sync source and information related to the sync source are jointly indicated jointly by D2DSS and PD2DSCH. The information indication can be explicit or implicit.

In certain embodiments, an indication of 1-bit is included in the PD2DSCH to indicate whether a UE is in coverage or out of coverage. For example, the bit is set to “1” when the UE is in coverage, and set to “0” when the UE is out of coverage.

In certain embodiments, the D2DSS sequences used by UE are partitioned to two groups. The first group or set, referred to as D2DSS_set1, D2DSSue_net, or other names, is the set of sequences that is used by a UE that derives TX timing from an eNB. The second group or set, referred to as D2DSS_set2, D2DSSue_oon, or other names, is the set of sequences that is used by a UE that derives TX timing from a non-eNB.

That is, in certain embodiments, a synchronization signal from a UE indicates a number of hops from the sync source. For example, a first D2D UE at the first hop that derives its TX timing from an eNB transmits D2D synchronization signal with a preamble sequence from a first set of sequences and transmits D2D synchronization channel carrying an indicator indicating the UE is in-coverage. Additionally, a second D2D UE at the second hop that derives its TX timing from a D2D UE at the first hop transmits D2D synchronization signal with a preamble sequence from a first set of sequences and transmits D2D synchronization channel carrying an indicator indicating the UE is out-of-coverage. Further, a third D2D UE at the third hop which derives its TX timing from a D2D UE at the second hop transmits D2D synchronization signal with a preamble sequence from a second set of sequences and transmits D2D synchronization channel carrying an indicator indicating the UE is out-of-coverage. In certain embodiments, the D2D UE, such as the main processor 340 or processing circuitry, is configured to partition the D2DSS sequences and set the appropriate bit value in the PD2DSCH.

In certain embodiments, there is one sync resource, such as, the central 6 PRBs, 2 symbols for PD2DSSS, and 2 symbols for SD2DSS, and so forth, for the in-coverage UE to use within a sync periodicity, such as, 40 ms. In certain embodiments, there are two sync resources, such as at different sub-frames, for the OOC UE to use. The in-coverage synchronization resource can be the same as one of the out-of-coverage synchronization resources, or the in-coverage synchronization resource can be different from the out-of-coverage sync resources.

When an out-of-coverage UE selects D2D synchronization source using a D2DSS in D2DSSue_net and the PD2DSCH indicating “in coverage” as its transmit timing reference, the OOC UE transmits the same D2DSS in D2DSSue_net. The OOC UE transmits the same D2DSS in the resource that is different from the sync resource for the IC UE, the D2D Frame Number (DFN) of the sub-frame in which the PD2DSCH is transmitted.

In a first approach, the in-coverage synchronization resource can be the same or different from the out-of-coverage synchronization resources. For example, there can be two OOC sync resources and D2DSS and PD2DSCH can be transmitted on T-th (T=1^{st} or T=2^{nd}) of the two OOC sync resources. When the OOC UE selects D2D synchronization source using a D2DSS in D2DSSue_net and the PD2DSCH indicating “out-of-coverage” as its transmit timing reference:

if the detected D2DSS and PD2DSCH is using the first OOC resource, then, the OOC UE transmits the same D2DSS in D2DSSue_net, in the other, namely the second, out-of-coverage synchronization resource, the DFN of the sub-frame in which the PD2DSCH is transmitted;

if the detected D2DSS and PD2DSCH is using the second OOC resource, then, the OOC UE transmits the same D2DSS in D2DSSue_net, in the other, namely the first, out-of-coverage synchronization resource, the DFN of the sub-frame in which the PD2DSCH is transmitted.

Alternatively, in a second approach, the in-coverage synchronization resource can be the same or different from the out-of-coverage synchronization resources. For example, there can be two OOC sync resources and D2DSS and PD2DSCH can be transmitted on T-th (T=1^{st} or T=2^{nd}) of the two OOC sync resources. When the OOC UE selects D2D synchronization source using a D2DSS in D2DSSue_net and the PD2DSCH indicating “out-of-coverage” as its transmit timing reference:

if the detected D2DSS and PD2DSCH is using the second OOC resource, then, the OOC UE transmits the same D2DSS in D2DSSue_net, in the other, namely the first, out-of-coverage synchronization resource, the DFN of the sub-frame in which the PD2DSCH is transmitted;

if the detected D2DSS and PD2DSCH is using the first OOC resource, then, the OOC UE transmits the same D2DSS in D2DSSue_net, in the other, namely the second, out-of-coverage synchronization resource, the DFN of the sub-frame in which the PD2DSCH is transmitted.

Table 13 provides an example of the indication for SST and hop number. In Table 9, state 2 uses example T=1, and state 3 uses example T=2, but it can be extended to T=2 for state 2 and T=1 for state 3.

TABLE 13
Sync source type and hop number value indicated by indication
configuration on D2DSS and PD2DSCH
(assume the sync signal transmitted from eNB
is hop 1 counting from eNB)

| State | | |
|---|---|---|
| index | State | Indication method |
| 1 | SST = eNB, hop = 2 | Transmitting: D2DSS sequence in |
| | | D2DSSue_net; 1-bit indicator in |
| | | PD2DSCH indicating ‘in-coverage’; |
| | | sync resource using the resource for |
| | | IC |
| 2 | SST = eNB, hop = 3 | Transmitting: 1-bit indicator in |
| | | PD2DSCH indicating ‘out-of- |
| | | coverage’; D2DSS sequence in |
| | | D2DSSue_net; sync resource using |
| | | the first resource (T = 1) for OOC |
| 3 | SST = eNB, hop = 4 | Transmitting: 1-bit indicator in |
| | | PD2DSCH indicating ‘out-of- |
| | | coverage’; D2DSS sequence in |
| | | D2DSSue_oon; sync resource using |
| | | the first resource (T = 2) for OOC |
| 4 | SST = UE, regardless | Transmitting: 1-bit indicator in |
| | hop number | PD2DSCH indicating ‘out-of- |
| | | coverage’; D2DSS sequence in |
| | | D2DSSue_oon; sync resource using |
| | | the resource (T = 1 or T = 2) for OOC, |
| | | which is different from the resource |
| | | for the received D2DSS/PD2DSCH |
| | | (where for the independent sync |
| | | source UE, it can be fixed or |
| | | preconfigured either to use T = 1 or |
| | | T = 2). |

Table 13 illustrates that state 3 and state 4 have some overlap on the indication. Therefore, state 3 and state 4 can be treated as a combined state, as shown in Table 14.

TABLE 14
Sync source type and hop number value indicated by indication
configuration on D2DSS and PD2DSCH
(assume the sync signal transmitted from eNB
is hop 1 counting from eNB)

| State index | State | Indication method |
|---|---|---|
| 1 | SST = eNB, hop = 2 | Receiving: eNB sync signal. |
| | | Transmitting: D2DSS sequence in |
| | | D2DSSue_net; 1-bit indicator in |
| | | PD2DSCH indicating ‘in- |
| | | coverage’; sync resource using |
| | | the resource for IC. |
| 2 | SST = eNB, hop = 3 | Receiving: signal from state 1. |
| | | Transmitting: 1-bit indicator in |
| | | PD2DSCH indicating ‘out-of- |
| | | coverage’; D2DSS sequence in |
| | | D2DSSue_net; |
| 3 | SST = eNB, hop = 4; | Transmitting: 1-bit indicator in |
| | SST = UE, regardless | PD2DSCH indicating ‘out-of- |
| | hop number | coverage’; D2DSS sequence in |
| | | D2DSSue_oon; |

Using Table 14, and also considering a state 0: SST=eNB, hop=1, which is the sync signal from the eNB itself, in total there can be four states. For example, for state 3, a case exists in which the UE may need to use its internal timing, such as when the UE may not select another node to which to sync. Therefore, the states can be similar to the states shown in Table 15.

TABLE 15
Sync source type and hop number value indicated by indication configuration on
D2DSS and PD2DSCH
(assume the sync signal transmitted from eNB is hop 1 counting from eNB)

| State index | State | Indication method |
|---|---|---|
| 0 | SST = eNB, hop = 1 | Transmitting: eNB sync signal |
| 1 | SST = eNB, hop = 2 | Transmitting: D2DSS sequence in |
| | (select node in state 0 to sync | D2DSSue_net; 1-bit indicator in |
| | to) | PD2DSCH indicating ‘in-coverage’; sync |
| | | resource using the resource for IC. |
| 2 | SST = eNB, hop = 3 | Transmitting: 1-bit indicator in |
| | (select node in state 1 to sync | PD2DSCH indicating ‘out-of-coverage’; |
| | to) | D2DSS sequence in D2DSSue_net. |
| 3 | SST = eNB, hop = 4; | Transmitting: 1-bit indicator in |
| | SST = UE, regardless hop | PD2DSCH indicating ‘out-of-coverage’; |
| | number; not an independent | D2DSS sequence in D2DSSue_oon; |
| | UE sync source | |
| 4 | An independent UE sync | Transmitting: 1-bit indicator in |
| | source | PD2DSCH indicating ‘out-of-coverage’; |
| | (select no other node to sync | D2DSS sequence in D2DSSue_oon; |
| | to) | where the sync resource it uses can be |
| | | fixed or preconfigured either to use T = 1 |
| | | or T = 2 |

As such, the sync node selection priority can be based on a UE state: the UE in state 0 can have a highest priority for the other UEs to select, the UE in state 1 can have a second priority level for the other UEs to select, the UE in state 2 can have the third priority level for the other UEs to select, the UE in state 3 can have the fourth priority level for the other UEs to select, and the UE in state 4 is required to use its own sync, that is, not from any other UEs. At each priority level, the sync signal strength, for example, measurement based on D2DSS, PD2DSCH, or DMRS of PD2DSCH, can be used for further prioritization, and the higher the measurement result is the higher priority within the same priority level.

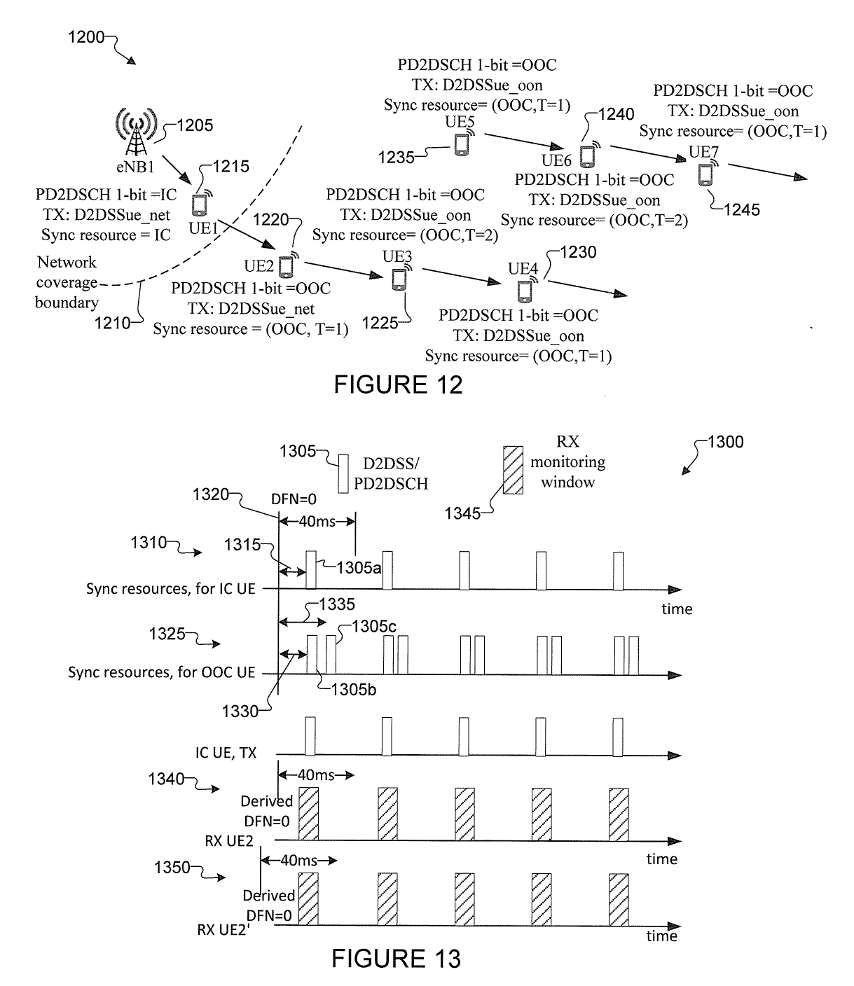

FIG. 12 illustrates a D2D sync scenario according to embodiments of the present disclosure. The embodiment of the D2D communication network 1200 shown in FIG. 12 is for illustration only. Other embodiments could be used without departing from the scope of the present disclosure.

The D2D communication network 1200 includes a first eNB, eNB1 1205, that is able to communicate with a number of UEs within network coverage boundary 1210. The eNB11205 communicates with UE1 1215 within the network coverage boundary 1210. The eNB1 1205 can be configured the same as, or similar to, eNB 102. One or more of the UE1 1215, UE2 1220, UE3 1225, UE4 1230, UE5 1235, UE6 1240 and UE7 1245 shown in FIG. 12 can be configured the same as, or similar to, UE 116. UE1 1215 is a state 1 UE in Tables 13-15. UE2 1220 is an example for a state 2 UE in Tables 13-15. UE3 1225 is an example for a state 3 UE in Table 13. UE4 1230, UE5 1235, UE6 1240, and UE7 1245 are examples for state 4 UEs in Table 13. UE51235 also is an example for state 4 UE in Table 15.

In the example shown in FIG. 12, UE1 1215 is IC UE with eNB1 1205. UE1 1215 transmits PD2DSCH including 1-bit indication indicating that UE1 1215 is an IC UE. UE1 1215 transmits D2DSS using sequence form D2DSSue_net. UE1 1215 also transmits sync on the IC sync resource. An OOC UE, UE2 1220, selects UE1 1215. UE2 1220 transmits PD2DSCH including 1-bit indication indicating that UE2 1220 is an OOC UE. UE2 1220 transmits D2DSS using sequence form D2DSSue_net. UE2 1220 also transmits sync on one of the OOC resources. If the sync resource for an IC UE is one of the two resources for an OOC, UE2 1220 uses a different resource than the IC UE resource. If the sync resource for an IC UE is different from the two resources for an OOC, UE2 1220 uses one of the two resources. The resource selected by UE2 1220 to use can be preconfigured or fixed.

In certain embodiments, when UE2 1220 transmits a sync on the first OOC sync resource (T=1). Although the example shown in FIG. 12 illustrates UE2 1220 transmitting a sync on T=1, the embodiments disclosed can be extended to the case where UE2 1220 transmits a sync source on the second OOC sync resource (T=2). Another OOC UE, UE3 1225 selects UE2 1220. UE3 1225 transmits PD2DSCH including a 1-bit indication indicating that UE3 1225 is an OOC UE. UE3 1225 transmits D2DSS using sequence form D2DSSue_oon. UE3 1225 transmits sync on a different resource than that used by UE2 1220. For example, in the example shown in FIG. 12, UE3 1225 transmits sync on the second OOC sync resource (T=2). Another OOC UE, UE4 1230 selects UE3 1225. UE4 1230 transmits PD2DSCH including a 1-bit indication that indicates that UE4 1230 is an OOC UE. UE4 1230 transmits D2DSS using sequence form D2DSSue_oon. UE4 1230 transmits sync on a resource other than a resource used by UE3 1225. For example, in the example shown in FIG. 12, UE2 1220 transmits sync on the first OOC sync resource (T=1); UE3 1225 transmits sync on the second OOC sync resource (t=2); therefor, UE4 1230 transmits sync also on the first OOC sync resource (T=1).

In the example shown in FIG. 12, UE5 1235 could not select another node to sync to; therefore UE5 1235 becomes an independent UE source. UE5 1235 indicates that UE5 1235 is OOC using the 1-bit in PD2DSCH, and transmits D2DSS sequence from D2DSSue_oon. In the example shown in FIG. 12, UE5 1235 uses the first OOC sync resource (T=1). However, in certain embodiments of the present disclosure, UE5 1235 uses the second OOC sync resource (T=2). Whether UE5 1235 will use T=1 or T=2 can be preconfigured, or fixed, or it can be determined by to UE implementation. UE6 1240 selects UE5 1235. UE6 1240 uses T=2, sequence from D2DSSue_oon, and indicates UE6 1240 is an OOC UE. UE7 1245 selects UE6 1240. UE7 1245 uses T=1, sequence from D2DSSue_oon, and indicates UE7 1245 is an OOC UE.

Throughout the disclosure, IC UE can refer to, for example, a UE is in RRC_CONNECTED state or UE is camping on a cell. OOC UE can refer to the UE which is not IC. UE2 1220 in can be in partial coverage, or edge-of-coverage, or UE2 1220 can be also categorized as OOC UE.

Alternatively, UE3 1225 uses D2DSS sequence from D2DSSue_net. However, when UE3 1225 uses D2DSS sequence from D2DSSue_net, then, to differentiate UE2 1220 and UE3 1225 by another UE that may receive sync signal from UE2 1220 and UE3 1225, further differentiation may be necessary to indicate whether UE2 1220 is the second hop originating from eNB1 1205 and UE3 1225 is the third hop originating from eNB1 1205. Such further differentiation can include using other differentiation methods described in various embodiments of the present. If UE3 1225 uses D2DSSue_net, UE4 1230 can use D2DSSue_oon, at OOC T=1, that is, a different resource from the one used by its selected node, here UE4 1230. In certain embodiments, there can be another UE (for example, UE4′) selecting UE4 1230, and UE4′ can use D2DSSue_oon, at OOC T=2, namely different resource from the one used by its selected node, here UE4 1230. UE4 1230 and UE4′ can be further differentiated by the T=1 or T=2, and differentiation of which resource (T=1 or T=2) the UE uses for sync transmission for an OOC UE can be performed using any of the differentiation methods described in various embodiments of the present.

FIG. 13 illustrates a D2D sync procedure diagram according to embodiments of the present disclosure. The embodiment of the D2D sync procedure 1300 shown in FIG. 13 is for illustration only. Other embodiments could be used without departing from the scope of the present disclosure.

In certain embodiments, a sync signal D2DSS and PD2DSCH 1305 can be in a same sub-frame. A sync resource 1310 for an IC UE has a D2DSS and PD2DSCH 1305a every 40 ms. The sync resource starts from Offset_IC 1315 with respect to a DFN=0 1320, where the offset, namely Offset_IC 1315, can be in the unit of sub-frames. Sync resources 1325 for OOC UE can include two D2DSS and PD2DSCH 1305 every 40 ms. A first D2DSS and PD2DSCH 1305b resource starts from Offset_OOC1 1330 with respect to DFN=0 1320. The second D2DSS and PD2DSCH 1305c resource starts from Offset_OOC2 1335 with respect to DFN=0 1320. The offsets, namely Offset_OOC1 1330 and Offset_OOC2 1335, can be in units of sub-frames. The first D2DSS and PD2DSCH 1305b of the OOC UE resources is the same as the IC sync D2DSS and PD2DSCH 1305a resource.

In the example shown in FIG. 13, Offset_IC=Offset_OOC1. However, embodiments in which Offset_IC=Offset_OOC2 could be used without departing from the scope of the present disclosure.

If the OOC RX UE knows beforehand that the first OOC sync resource is the same as the IC sync resource, the OOC RX UE derives its DFN as shown for RX UE2 1340 in order to establish the RX monitoring window 1345. If the OOC RX UE does not know beforehand that the first OOC sync resource is the same as the IC sync resource, the OOC RX UE derives its DFN as shown for RX UE2′ 1350, or the OOC RX UE derives its DFN as shown for RX UE2 1340, hence, there is ambiguity. Therefore, it is better for the UE to know beforehand which OOC sync resource is the same as the IC sync resource. This can be also extended to asynchronous system.

The DFN can be carried in PD2DSCH, and a D2D UE can decode the PD2DSCH to obtain the DFN. Based on the DFN, the UE can determine which resource is the first and which resource is the second, if the UE beforehand knows the respective DFN for the first resource, and the respective DFN for the second resource.

The embodiment illustrated in FIG. 13 can be extended to a case in which the TX UE is an OOC UE using a D2DSS sequence in D2DSSue_net. This means that, for the UE using D2DSS sequence in D2DSSue_net in its transmission, the transmission resource is the fixed or preconfigured and known to all the UEs, namely both the TX and RX UEs. For example, the UE transmitting the D2DSS sequence in D2DSSue_net and an IC UE, such as UE1 1215 in FIG. 12, should use sync resource for IC UE, and the UE transmitting the D2DSS sequence in D2DSSue_net and that is an OOC UE, such as UE2 1220 in FIG. 12 should use sync resource for OOC UE. The resources used by UE2 1220 should be different from UE1 1215, namely, the IC UE. For example, if the sync resource for IC UE (UE1 1215) is the same as one of the two sync resources for OOC UE (UE2 1220), the OOC UE (UE2 1220) should use the other resource for OOC UE (UE2 1220) that is different from the IC UE (UE1 1215). If the sync resource for IC UE (UE1 1215) is different from the two sync resources for OOC UE (UE2 1220), (UE2 1220) should use one fixed or preconfigured sync resource out of the two sync resources for OOC UE, such as by using the first OOC resource if the first OOC resource is the fixed or preconfigured for such UE to use, or use the second resource if the second OOC resource is the fixed or preconfigured for such UE to use. No ambiguity should exist for the RX UE to determine which resource the received D2DSS and PD2DSCH was using for transmission.

In the D2D sync procedure 1300 shown in FIG. 13, if the TX UE is OOC UE, not IC UE, then, the RX UE may end up with the similar problem of not being able to determine the timing for DFN, that is, where the derived DFN 0 should be, if the RX UE does not know the received D2DSS and PD2DSCH is transmitted on the first OOC resource, or the second OOC resource, within the cycle of D2DSS and PD2DSCH. To resolve this problem, in certain embodiments, a second identification or second indication is used to indicate whether the transmitted D2DSS and PD2DSCH is on the first resource or the second resource when the UE is transmitting D2DSS sequence using D2DSSue_oon. The indication is indicated by using D2DSS, PD2DSCH, or combination thereof. The indication methods described in embodiments of this disclosure regarding how to differentiate two states, or combinations of the methods, can be used.

For example, a further partition of the sequence of D2DSSue_oon can be used, such as by using two subsets of D2DSSue_oon. A first subset is configured for D2DSSue_oon to use to indicate that the transmitted signal used the first sync resource for OOC. A second subset is configured for D2D for D2DSSue_oon to use to indicate that the transmitted signal used the second sync resource for OOC.

Another method can be, for example, different ordering of D2DSS and PD2DSCH in the time domain (for example, one order can be PD2DSS, PD2DSCH, SD2DSS, and another order can be PD2DSS, SD2DSS, PD2DSCH), or different relative distances in time domain for PD2DSS, SD2DSS, PD2DSCH. There can be other orderings by shuffling and combinations.

In another example, the PD2DSCH uses two different sets of scrambling sequences. Each different set of scrambling sequences is used to indicate one of the states—the first or the second sync resources for OOC. In another example, the PD2DSCH uses two different generators for CRC, or two different masks for CRC. Each of the different generators for CRC, or each different mask for CRC, is used to indicate one of the states—the first or the second sync resources for OOC. If PD2DSCH content can be allowed to be different for OOC UEs; then, a bit in PD2DSCH is used to indicate whether the UE uses the first sync resource or the second sync resource for OOC.

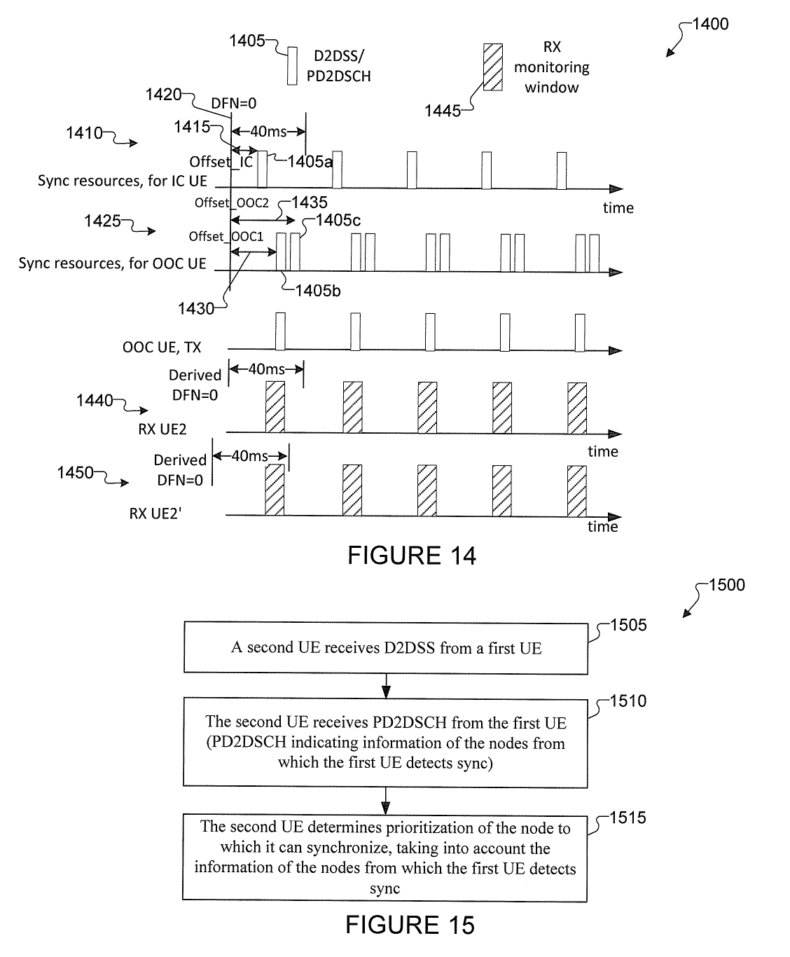

FIG. 14 illustrates another D2D sync procedure diagram according to embodiments of the present disclosure. The embodiment of the D2D sync procedure 1400 shown in FIG. 14 is for illustration only. Other embodiments could be used without departing from the scope of the present disclosure.

In the example shown in FIG. 14, a sync signal D2DSS and PD2DSCH 1405 can be in a same sub-frame. A sync resource 1410 for an IC UE has a D2DSS and PD2DSCH 1405a every 40 ms. The sync resource starts from Offset_IC 1415 with respect to a DFN=0 1420, where the offset, namely Offset_IC 1415, can be in the unit of sub-frames. Sync resources 1425 for OOC UE can include two D2DSS and PD2DSCH 1405 every 40 ms. A first D2DSS and PD2DSCH 1405b resource starts from Offset_OOC1 1430 with respect to DFN=0 1420. The second D2DSS and PD2DSCH 1405c resource starts from Offset OOC2 1435 with respect to DEN=0 1420. The offsets, namely Offset_OOC1 1430 and Offset_OOC2 1435, can be in units of sub-frames. The first D2DSS and PD2DSCH 1405b of the OOC UE resources is the same as the IC sync D2DSS and PD2DSCH 1405a resource.

In certain embodiments, the D2D sync procedure 1400 is used when the sync resource 1410 for the IC UE is the same as one of the sync resources 1425 for OOC UE. For example, an Offset IC 1415 can be equal to one of the offsets for OOC, Offset_OOC1 1430 or Offset OOC2 1435. In certain embodiments, the D2D sync procedure 1400 is used when the sync resource for IC is different from the two sync resources for OOC.

Similar to the D2D sync procedure 1300 shown in FIG. 13, in the D2D sync procedure 1400, RX UE2 and RX UE2′ may derive different DFN 0 timing when the UEs do not know how to determine whether the TX UE is using the first or the second sync resource for OOC UE. When the RX UE knows whether the TX UE is using the first or the second sync resource for OOC UE, for example, by detecting some information or indication, explicitly or implicitly, via D2DSS, PD2DSCH, or both D2DSS and PD2DSCH, then, the RX UE will not have an ambiguity, and the RX UE can determine the timing accordingly.

If the OOC RX UE knows beforehand that the first OOC sync resource is the same as the IC sync resource, the OOC RX UE derives its DFN as shown for RX UE2 1440 in order to establish the RX monitoring window 1445. If the OOC RX UE does not know beforehand that the first OOC sync resource is the same as the IC sync resource, the OOC RX UE derives its DFN as shown for RX UE2′ 1450, or the OOC RX UE derives its DFN as shown for RX UE2 1440, hence, there is ambiguity. Therefore, it is better for the UE to know beforehand which OOC sync resource is the same as the IC sync resource. This can be also extended to asynchronous system.

All the above embodiments for two resources for OOC UEs to use for sync can be extended to more than 2 resources in the time domain within a sync cycle. The related methods also can be also extended to more than two sync resources in the time domain for OOC UEs within a sync cycle.

When a D2D UE detects PD2DSCH, the D2D UE should identify when the PD2DSCH is transmitted from the same node that transmitted D2DSS that the UE has already detected. To identify when the PD2DSCH is transmitted from the same node that transmitted D2DSS that the UE has already detected, the PD2DSCH can be scrambled by a sequence that is a function of the preamble sequence or the identifier carried by D2DSS. For example, the scrambling sequence can be initialized with the preamble carried by D2DSS. In another example, the preamble carried by D2DSS is used to XOR the CRC of PD2DSCH. In another alternative the PD2DSCH is identified by the receiving UE as linked with a D2DSS by the relative time and frequency position of the PD2DSCH to the corresponding D2DSS. For example the D2DSS can be transmitted by the D2D UE in frequency resource X, such as a sub-band, and sub-frame Y. Additionally, the same UE transmits the corresponding PD2DSCH in frequency resource X+N_{F} and sub-frame Y+N_{T}, where N_{F} and N_{T} are offsets that can be preconfigured to be the same for all UEs or can be configured on a per UE or per UE group basis. A receiving UE is able to implicitly determine the link between any PD2DSCH and D2DSS based on a comparison of the reception time and frequency locations. When multiple UEs transmit D2DSS and PD2DSCH in the same time and frequency locations as other UEs, the implicit determination by the UE can be combined with the first alternative in which a preamble or D2D group ID is used in the scrambling to differentiate between the sync transmissions of multiple UEs.

In certain embodiments, the PD2DSCH transmitted from a D2D UE indicates one or multiple nodes, including eNB and D2D UEs, that the UE detects sync. The sync can include sync from an eNB, or the D2DSS and PD2DSCH from D2D UE. The information on the one or multiple nodes that the UE detects sync also can be in conveyed on data channel, such as, a layer-2 message, or MAC message, or higher layer message. Other D2D UEs that receive such information can use the information as one of the factors to determine prioritization of network node from which the UE can get synchronized. For example, a UE can prioritize a node that can receive sync from multiple other nodes over a node that can only receive sync from a single other node. In certain embodiments, this information is fed back from the D2D UE to another network node including an eNB and other D2D UEs, such as a UE acting as a cluster head, where the eNB or D2D UE can use the information to determine topology and configurations, such as determine which UE can be a relay node and relay information from which other nodes.

Table 16 provides exemplary information fields in PD2DSCH transmitted by a D2D UE to indicate the information of a node that the UE detects. One or more of the fields may be omitted.

TABLE 16
Information fields in PD2DSCH

| | Size (bits) | Information |
|---|---|---|
| . . . | . . . | . . . |
| Information of a node the UE | | |
| detects sync from { | | |
| Carrier index | | Carrier index of the node |
| Preamble | | Preamble in D2DSS transmitted by the node. |
| MAC identifier | | MAC identifier indicated in PD2DSCH |
| | | transmitted by the node. |
| node's SST | 1 | eNB or UE. The node's sync source type. |
| Hop number relative to the | 2 | Hop number relative to the node's sync |
| node's SS | | source. |
| Node's SS identifier | | Identifier (preamble, or MAC ID) of the |
| | | node's sync source. Optional. Preamble can |
| | | be derived from the preamble of the node and |
| | | the hop number if the hop number is |
| | | indicated via preamble sequence partition. |
| } | | |
| . . . | . . . | . . . |

FIG. 15 illustrates a process 1500 in which a first D2D UE transmits information of the nodes from which it detects sync and a second D2D UE that receives such information uses the information as a factor to determine prioritization of the node to which the second D2D UE can synchronize according to embodiments of the present disclosure. While the flow chart depicts a series of sequential steps, unless explicitly stated, no inference should be drawn from that sequence regarding specific order of performance, performance of steps or portions thereof serially rather than concurrently or in an overlapping manner, or performance of the steps depicted exclusively without the occurrence of intervening or intermediate steps. The process depicted in the example depicted is implemented by a transmitter chain in, for example, a mobile station.

In block 1505, a second D2D UE receives D2DSS from a first D2D UE, where the first D2D UE may have detected one or multiple of the nodes to which the first UE can sync. The first UE transmits PD2DSCH including information of the nodes from which the first UE detects sync, and the second UE receives the PD2DSCH from the first UE in block 1510. In block 1515, the second UE determines prioritization of the node to which the second UE can synchronize, taking into account the information of the nodes from which the first UE detects sync.

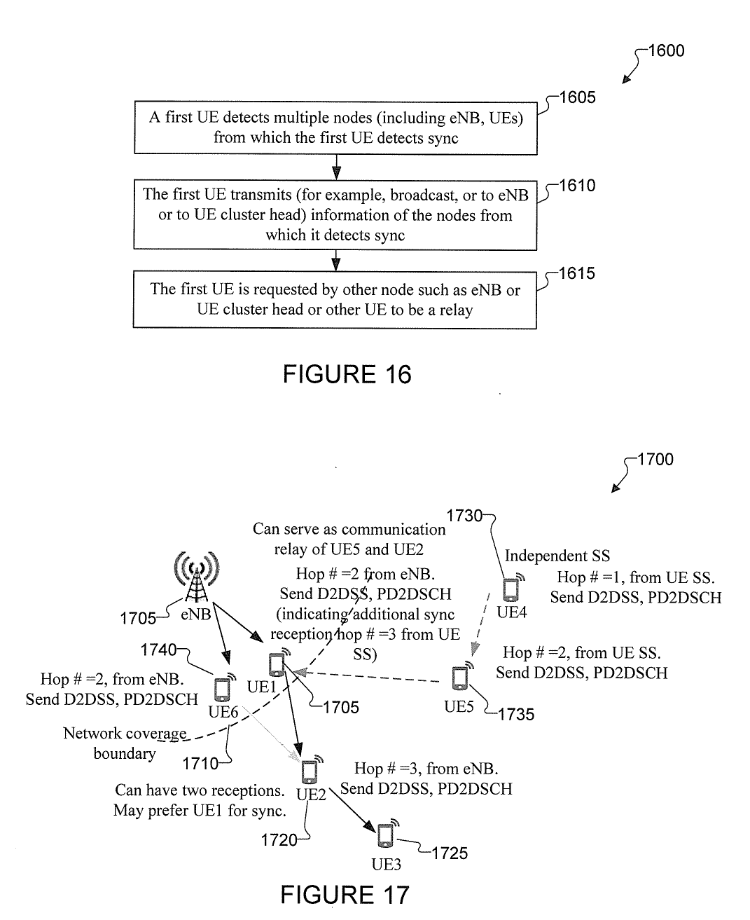

FIG. 16 illustrates a process 1600 in which a first D2D UE transmits information of multiple nodes from which the first D2D UE detects sync, and in which other nodes that receive the information request that the first UE become a relay according to embodiments of the present disclosure. While the flow chart depicts a series of sequential steps, unless explicitly stated, no inference should be drawn from that sequence regarding specific order of performance, performance of steps or portions thereof serially rather than concurrently or in an overlapping manner, or performance of the steps depicted exclusively without the occurrence of intervening or intermediate steps. The process depicted in the example depicted is implemented by a transmitter chain in, for example, a mobile station.

In block 1605, a first UE detects multiple nodes (including eNB, UEs) from which the first UE detects sync. The first UE transmits the information of the nodes from which it detects sync in block 1610. The transmission from the first UE can be a broadcast, or to eNB or to UE cluster head. In block 1615, one or more other nodes request that the first UE be a relay. The one or more other nodes can be eNB or UE cluster head or another UE. As an alternative, the first UE may decide to be a relay autonomously.

FIG. 17 illustrates exemplary operations in which a D2D UE transmits information of multiple nodes from which the D2D UE detects sync and in which the other node utilize the information according to embodiments of the present disclosure. The embodiment of the D2D communication network 1700 shown in FIG. 17 is for illustration only. Other embodiments could be used without departing from the scope of the present disclosure.

The D2D communication network 1700 includes an eNB 1705 that is able to communicate with a number of UEs within network coverage boundary 1710. The eNB 1705 can be configured the same as, or similar to, eNB 102. One or more of the UE1 1715, UE2 1720, UE3 1725, UE4 1730, UE5 1735 and UE6 1740 shown in FIG. 17 can be configured the same as, or similar to, UE 116.

The eNB 1705 communicates with UE1 1715 and UE6 1740 within the network coverage boundary 1710. UE4 1730 is out of network coverage and is an independent sync source as UE4 1730 does not detect any other sync. UE4 1730 transmits D2DSS and PD2DSCH. UE5 1735 is also out of coverage and UE5 1735 gets sync from UE4 1730. UE5 1735 transmits D2DSS and PD2DSCH. UE1 1715 detects sync from UE5 1735 in addition to eNB 1705. UE1 1715 transmits D2DSS and PD2DSCH, which indicates UE1 1715 is synchronized to eNB 1705, and in the PD2DSCH UE1 1715 includes information regarding the additional sync detection from UE5 1735. UE6 1740 transmits D2DSS and PD2DSCH, indicating that UE6 1740 is synchronized to eNB 1705. UE2 1720 detects sync from UE1 1715 and UE6 1740. UE2 1720 selects, prefers or prioritizes UE1 1715 as the node from which UE2 1720 can get sync, as UE1 1715 has detected additional sync compared to what UE6 1740 has detected. UE2 1720 synchronizes to UE1 1715, and UE2 1720 transmits D2DSS and PD2DSCH. UE3 1725 detects sync from UE2 1720. UE1 1715 transmits information of multiple nodes from which UE1 1715 detects sync. Additionally, other nodes that receive the information, such as eNB 1705 or UE2 1720, can request UE1 1715 to be a relay. In certain embodiments, UE1 1715 decides to be a relay autonomously.

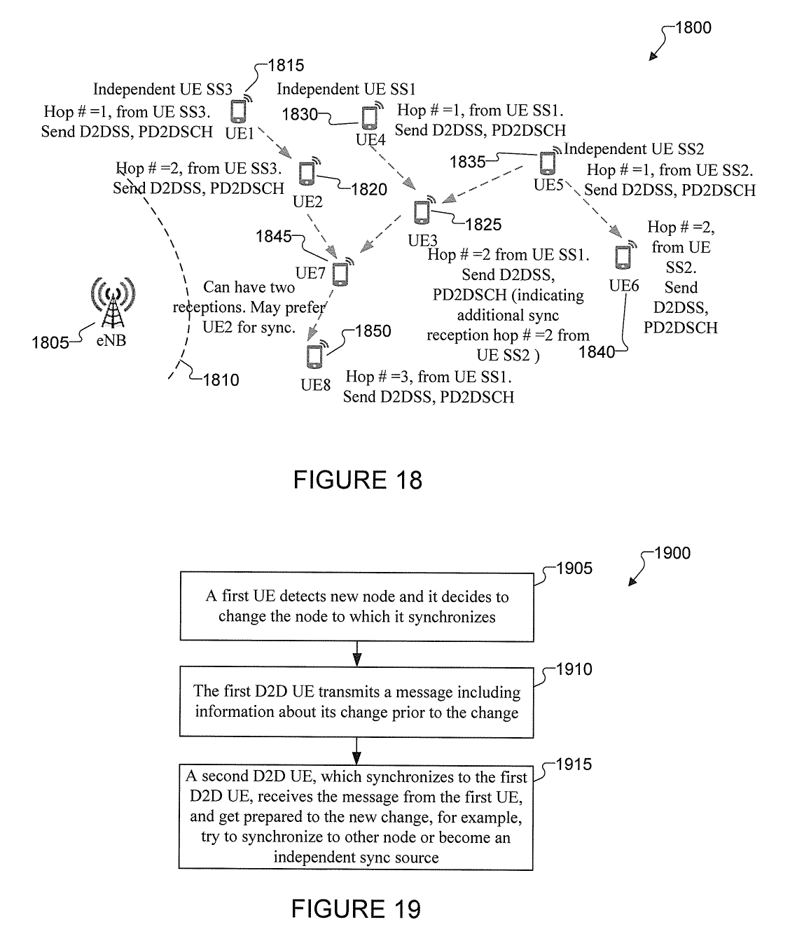

FIG. 18 illustrates exemplary operations that a D2D UE transmits information of multiple nodes from which the D2D UE detects sync and wherein the other node utilize the information according to embodiments of the present disclosure. The embodiment of the D2D communication network 1800 shown in FIG. 18 is for illustration only. Other embodiments could be used without departing from the scope of the present disclosure.

The D2D communication network 1800 includes an eNB 1805 that is able to communicate with a number of UEs within network coverage boundary 1810. The eNB 1805 can be configured the same as, or similar to, eNB 102. One or more of the UE1 1815, UE2 1820, UE3 1825, UE4 1830, UE5 1835, UE6 1840, UE7 1845 and UE8 1850 shown in FIG. 18 can be configured the same as, or similar to, UE 116.

In the example shown in FIG. 18, UE1 1815-UE8 1850 are not connected to eNB 1805 as they are out of the network coverage boundary 1810. UE1 1815 is an independent sync source and UE1 1815 transmits D2DSS and PD2DSCH. UE2 1820 gets sync from UE3 1825 and UE2 1820 transmits D2DSS and PD2DSCH. UE4 1830 is an independent sync source and UE4 1830 transmits D2DSS and PD2DSCH. UE5 1835 is an independent sync source and UE5 1835 transmits D2DSS and PD2DSCH. UE6 1840 detects sync from UE5 1835. UE3 1825 detects sync from UE4 1830 and UE5 1835 and UE3 1825 determines to be synchronized to UE4 1830. UE3 1825 transmits D2DSS and PD2DSCH and in PD2DSCH UE3 1825 includes information on the additional sync detection from UE5 1835. UE7 1845 detects sync from UE2 1820 and UE3 1825 and UE7 1845 determines to be synchronized to UE3 1825, as UE3 1825 includes in PD2DSCH information on the additional sync detection from UE5 1835 while UE2 1820 does not. UE7 1845 transmits D2DSS and PD2DSCH and UE8 1850 detects sync from UE7 1845. UE7 1845 or UE3 1825 can transmit information of multiple nodes from which UE3 1825 detects sync. Additionally, other nodes that receive the information can request for UE3 1825 or UE7 1845 to be a relay. In certain embodiments, UE7 1845 or UE3 1825 decides to be a relay autonomously.

The two additional conditions can apply for all cases for a first UE to reselect a second node to which it can sync, or reconfigure its D2DSS and PD2DSCH:

the signal detected from the second node (e.g., UE) is stronger than certain threshold (Th_sync_reconfig1) during a certain time interval T_sync_reconfig; and

more than a certain period of time T_keep (for example, 1 second) has elapsed since the UE has sync'd to a current node, such as a UE.

The two additional conditions also can apply for all cases for a UE to reconfigure its D2DSS/PD2DSCH to an independent UE sync source:

the signal detected from other nodes (e.g., UE) is below certain threshold (Th_sync_reconfig2) during a certain time interval T_sync_reconfig; and more than a certain period of time T_keep (for example, 1 second) has elapsed since the UE has sync'd to a current node, such as a UE.

The signal strength can be measured by reference signal received power (RSRP), reference signal received quality (RSRQ), or sync signal received power (SSRP), sync signal received quality (SSRQ). The sync signal can be measured by energy detection.

The parameters mentioned above, for example, Th_sync_reconfig1, T_sync_reconfig, T_keep, Th_sync_reconfig2 can be fixed, preconfigured, predefined, or signaled in message. For example, the parameters can be signaled in SIB, in PD2DSCH, or in dedicated signaling, and the like.

In certain embodiments, a first D2D UE transmits a message including information about its changing a node to which it synchronizes. The message is transmitted in advance prior to the actual change so that other D2D UEs, such as a second D2D UE, that may have synchronized to the first UE can get prepared for the change and finds another node to which to synchronize. The first D2D UE can also include in the message an effective timing for the actual change. The first D2D UE can also recommend one or multiple nodes to the second D2D UE so the second D2D UE can try to synchronize to one of the recommended nodes. If the second D2D UE cannot find another node to synchronize to, the second D2D UE becomes an independent sync source. The attempt to find new node to synchronize to or the determination of becoming an independent sync source can be done, or partly done, before the effective timing of the change of the first D2D UE. One of the advantages is that it can provide fast sync re-establishment and make the network more robust.

Table 17 provides exemplary information fields in a message transmitted by a first D2D UE to indicate the information related to a change of the node to which the first D2D UE will synchronize. In certain embodiments, the message is transmitted prior to the change. Some of the fields may be omitted. Information regarding a new node to which the UE synchronizes can be regarded as one of the recommended change for sync nodes for a second D2D UE. If there is no more recommended node than the new node that the first UE will synchronize, the information field of recommended node can be omitted; or it can be vice versa. The information field of a new node to which the UE synchronizes can be omitted while the information field of recommended node can be included.

TABLE 17
Information UE transmits prior to its change of a node to which it synchronizes

| | Size | |
|---|---|---|
| | (bits) | Information |
| . . . | . . . | . . . |
| Information of a new node | | |
| to which the UE | | |
| synchronizes { | | |
| Carrier index | | Carrier index of the node |
| Preamble | | Preamble in D2DSS transmitted by the node. |
| MAC identifier | | MAC identifier indicated in PD2DSCH transmitted by |
| | | the node. |
| Node's SST | 1 | eNB or UE. The node's sync source type. |
| Hop number relative to the | 2 | Hop number relative to the node's sync source. |
| node's SS | | |
| Node's SS identifier | | Identifier (preamble, or MAC ID) of the node's sync |
| | | source. Optional. Preamble can be derived from the |
| | | preamble of the node and the hop number if the hop |
| | | number is indicated via preamble sequence partition. |
| } | | |
| Time of the change | | After the indicated time, the change will be effective. |
| Recommended change for | | |
| sync node { | | |
| Carrier index | | Carrier index of the node |
| Preamble | | Preamble in D2DSS transmitted by the node |
| Node's SST | 1 | eNB or UE. The node's sync source type. |
| Hop number relative to the | 2 | Hop number relative to the node's sync source. |
| node's SS | | |
| . . . | . . . | . . . |
| } | | |
| . . . | . . . | . . . |

The time of the change can be omitted and the parameter may be fixed or predefined. The time of the change also can be scaled by a factor of the UE's mobility.

FIG. 19 illustrates a process 1900 for a first D2D UE to transmit a message including information about its changing a node to which it synchronizes according to embodiments of the present disclosure. While the flow chart depicts a series of sequential steps, unless explicitly stated, no inference should be drawn from that sequence regarding specific order of performance, performance of steps or portions thereof serially rather than concurrently or in an overlapping manner, or performance of the steps depicted exclusively without the occurrence of intervening or intermediate steps. The process depicted in the example depicted is implemented by a transmitter chain in, for example, a mobile station. The message can be transmitted in advance prior to the actual change, so that a second D2D UE that synchronized to the first UE can get prepared for the change.

In block 1905, a first D2D UE detects new node and decides to change the node to which it synchronizes. The first D2D UE transmits a message including information about its change prior to the change in block 1910. In block 1915, a second D2D UE that synchronizes to the first D2D UE receives the message from the first UE. The second D2D UE gets prepared for the new change, such as to try to synchronize to another node or become an independent sync source.

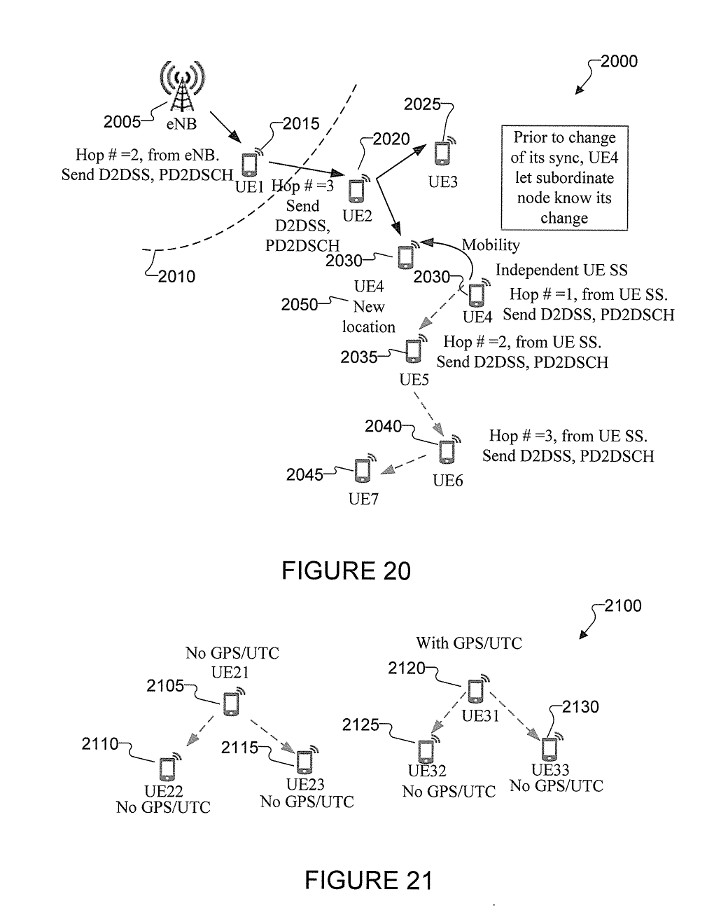

FIG. 20 illustrates exemplary operations in which a first D2D UE transmits a message including information about changing a node to which the D2D UE synchronizes according to embodiments of the present disclosure. The embodiment of the D2D communication network 2000 shown in FIG. 20 is for illustration only. Other embodiments could be used without departing from the scope of the present disclosure. The message can be transmitted in advance prior to the actual change, so that a second D2D UE that synchronized to the first UE can get prepared for the change.

The D2D communication network 2000 includes an eNB 2005 that is able to communicate with a number of UEs within network coverage boundary 2010. The eNB 2005 can be configured the same as, or similar to, eNB 102. One or more of the UE1 2015, UE2 2020, UE3 2025, UE4 2030, UE5 2035, UE6 2040, and UE7 2045 shown in FIG. 18 can be configured the same as, or similar to, UE 116.

The eNB 2005 communicate with UE1 2015 within network coverage boundary 2010. UE1 2015 gets sync from eNB 2005 and transmits D2DSS and PD2DSCH. UE2 2020 gets sync from UE1 2015 and transmits D2DSS and PD2DSCH. UE3 2025 gets sync from UE2 2020. UE4 2030 is out of network coverage and UE4 2030 is an independent sync source as UE4 2030 does not detect any other sync. UE4 2030 transmits D2DSS and PD2DSCH. UE5 2035 gets sync from UE4 2030 and it transmits D2DSS and PD2DSCH. UE6 2040 gets sync from UE5 2035 and transmits D2DSS and PD2DSCH. UE7 2045 gets sync from UE6 2040. UE4 2030 is mobile. UE4 2030 moves towards UE2 2020. When UE4 2030 reaches its new location 2050, UE4 2030 determines that it needs to change sync to UE2 2020. Before UE4 2030 changes its sync, UE4 2030 transmits information about the new change, such as referenced in Table 17. The information includes UE2 2020 as the node that UE4 2030 in the new location 2050 will synchronize to, and the information also includes that UE2 2020 has already been a node that transmits D2DSS on a hop with maximum number relative to an eNB. UE5 2035 receives such information and determines that UE5 2035 cannot synchronize to UE4 2030 any longer before the effective time of the sync change of UE4 2030, so UE5 2035 decides to be an independent sync source. UE5 2035 can also try to detect UE2 2020 indicated by UE4 2030 before UE5 2035 decides to be an independent sync source. If UE5 2035 fails to detect UE2 2020, UE5 2035 becomes an independent sync source. UE5 2035 can inform UE6 about its change prior to its change of sync. UE6 2040 can inform UE7 2045 about its change prior to its change of sync.

The embodiment shown in FIG. 20 can be extended to that a first D2D UE that transmits a message including information about its changing of important system information or configuration. The changing of important system information or configuration can include information in D2DSS, or information in PD2DSCH, such as maximum hop number, resource allocation configuration for D2D broadcast data channel, and so forth. In certain embodiments, the message is transmitted in advance prior to the actual change so that other D2D UEs, such as a second D2D UE, that have synchronized to the first UE can get prepared for the change and find another node to which to synchronize. The message from first D2D UE can also include an effective timing for the actual change. The first D2D UE can also recommend one or multiple nodes for synchronization. That is, the message from first D2D UE can also include recommended node information so the second D2D UE can try to synchronize to one of the recommended nodes. This can enable fast topology change and fast re-establishment of new topology for D2D communication.

In certain embodiments, a battery life or battery state for the D2D UE can be transmitted to other nodes and the information can be used by other nodes as one of the factors to determine the prioritization of the node from which a D2D UE can synchronize. The information regarding the battery life or battery state can be included in PD2DSCH or other messages. In certain embodiments, the battery state includes power source information that indicates whether the D2D UE is connected, namely “plugged.” to powerline supply or not, as well as the remaining energy in the battery. The D2D UE can select, prefer or prioritize a first D2D UE that has higher remaining energy over a second D2D UE that has lower remaining energy, to be a node to which the D2D UE can synchronize.

In certain embodiments, one or more nodes can request a D2D UE to be a relay. In certain embodiments, the decision to request which node should be a relay is also related to battery state. A D2D UE with higher remaining energy can have higher priority to be a relay. In certain embodiments, the D2D UE autonomously determines that it should be a relay. When the D2D UE autonomously determines to be a relay, the D2D UE can also take into account of its battery state. For example, when the battery is low, the D2D UE does not need to be a relay or selects to not be a relay.

In certain embodiments, when a first D2D UE changes a node to which the first D2D UE synchronizes, the change in timing or frequency, or both, is performed in multiple steps where a restriction on the magnitude of each change and the rate of change can be imposed to the first D2D UE. This restriction causes the first D2D UE to adjust its timing or frequency, or both, in a gradual and controlled manner, thereby allowing a second UE that is synchronized to the first UE to also adjust its timing and frequency in a gradual and controlled manner. A set of rules for the timing or frequency change can be defined. In one example, all adjustments made to the UE timing are performed according to the following:

1) The maximum amount of the magnitude of the timing change in one adjustment shall be Tq seconds.

2) The minimum aggregate adjustment rate shall be 7*T_{S} per second.

3) The maximum aggregate adjustment rate shall be Tq per 200 ms.

The maximum autonomous time adjustment step Tq is specified in Table 18.

TABLE 18
Tq Maximum Autonomous Time Adjustment Step

| Downlink Bandwidth (MHz) | T_{q}_{_{—}} |
|---|---|
| 1.4 | 17.5 * T_{S} |
| 3 | 9.5 * T_{S} |
| 5 | 5.5 * T_{S} |
| ≧10 | 3.5 * T_{S} |

Note:
T_{S} is the basic timing unit defined in TS 36.211

FIG. 21 illustrates a sync establishment according to embodiments of the present disclosure. The embodiment of the sync establishment 2100 shown in FIG. 21 is for illustration only. Other embodiments could be used without departing from the present disclosure.

In the example shown in FIG. 21, UE21 2105 does not detect another node to provide sync. Additionally, UE21 2105 does not have accurate sync method, such as GPS or UTC. Therefore, UE21 2105 has no choice but send sync signal with a rough timing on its own. UE21 2105 needs to indicate in D2DSS and PD2DSCH that UE21 2105 cannot provide sync to other nodes, for example, the bit in Table 3 set as ‘0’. Alternatively UE21 2105 indicates that UE21 2105 does not have accurate sync method, for example, the bit in Table 4 set as ‘0’. UE21 2105 indicates it is hop number “1”. UE22 2110 and UE23 2115 do not have GPS or UTC. UE22 2110 and UE23 2115 try to detect sync signal from other nodes. Then UE22 2110 and UE23 2115 detect the sync from UE21 2105, but not another node that can provide sync. UE22 2110 and UE23 2115 sync to UE21 2105 for communication purposes, but UE22 2110 and UE23 2115 understand that the sync provided by UE21 2105 is not accurate. Therefore, whenever UE23 2115, or UE22 2110, detects a more accurate sync, such as from UE31 2120, UE23 2115, or UE22 2110 respectively, reselects to sync to UE31 2120. UE31 2120 does not detect another node to provide sync, but UE31 2120 has an accurate sync method, such as GPS or UTC. UE31 2120 sends a sync signal with a timing based on its own timing. UE31 2120 also indicates in D2DSS and PD2DSCH that UE31 2120 can provide sync to another node, for example, the bit in Table 3 set as ‘1’. Alternatively, UE31 2120 indicates that UE31 2120 has an accurate sync method, for example, the bit in Table 4 set as ‘1’. UE31 2120 indicates it is hop number “1”. Then UE32 2125 and UE33 2130 detect the sync from UE31 2120 and sync to UE31 2120 for communication purpose. UE22 2110 and UE23 2115 understand that the sync provided by UE31 2120 is accurate, so when either UE22 2110 or UE23 2115 detect another UE without accurate sync, such as UE21 2105, even with stronger signal, UE22 2110, or UE23 2115 respectively, does not reselect to the other node. If Max_hop_NeNB is “1”, an alternative way for signaling for the information listed in Table 3 and Table 4 can be as follows. For UE21 2105, UE21 2105 signals that it has hop number “2”, even though it actually is hop number “1”, where the hop number “2” will let the other UEs know that UE21 2105 cannot provide sync to other UEs, such as, in terms of priority of sync selection/reselection, not the communication purpose; and for UE31 2120, UE31 2120 signals that it has hop number “1”. Then the signaling in Table 3 and Table 4 may be omitted.

In certain embodiments, the UE indicates in a sync signal (D2DSS and PD2DSCH) whether the UE has its timing derived from an accurate timing source, such GPS or UTC, or a node that has accurate sync method available. The accurate sync method can include GPS, UTC, or the like. Table 19 illustrates an example of the indication.

TABLE 19
Information fields in PD2DSCH

| | Size (bits) | Information |
|---|---|---|
| . . . | . . . | . . . |
| Indication of whether the | 1 | Value ‘0’ indicates: no |
| UE that transmits the | | Value ‘1’ indicates: yes |
| PD2DSCH has its timing | | (applicable for the UE who |
| derived from an accurate | | transmits D2DSS sequence |
| timing source (GPS/UTC) | | from a set of sequences |
| or a node that has accurate | | which are used by UEs who do |
| sync method available | | not derive timing from eNB, if |
| | | eNB has accurate sync method) |
| . . . | . . . | . . . |

An alternative, the 1-bit indicator can indicate whether the UE that transmits the PD2DSCH has its timing derived from an accurate timing source, such as GPS or UTC, or by Table 4, and another 1-bit can indicate whether the UE that transmits the PD2DSCH has its timing derived from a node that has accurate sync method available, where this 1-bit may be only applicable when the hop number is greater than “1”.

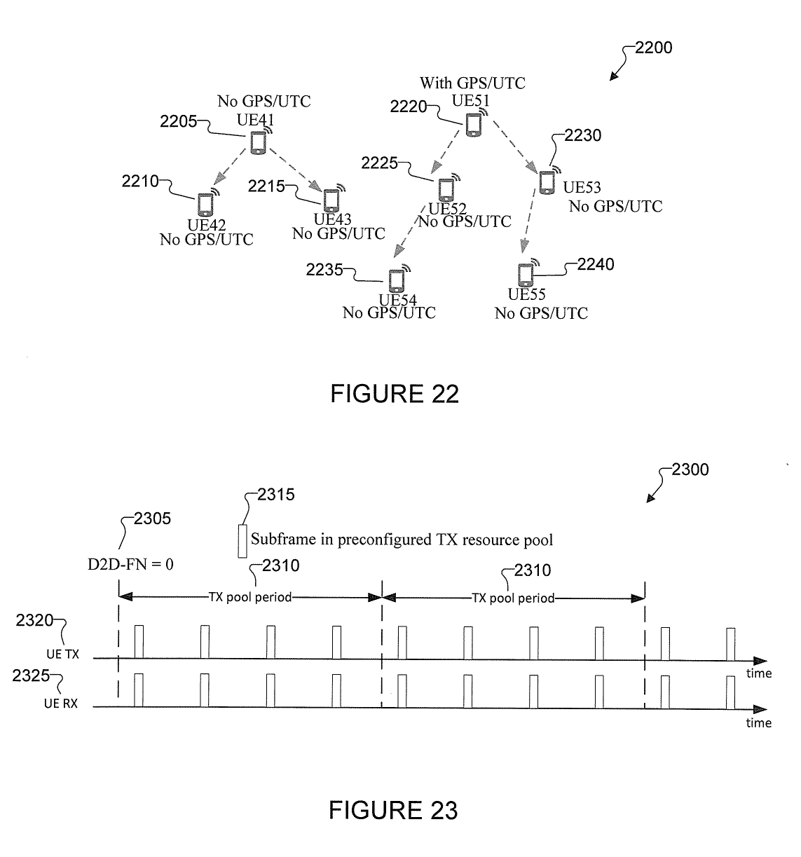

FIG. 22 illustrates another sync establishment according to embodiments of the present disclosure. The embodiment of the sync establishment 2200 shown in FIG. 22 is for illustration only. Other embodiments could be used without departing from the scope of the present disclosure.

In the example shown in FIG. 22, UE41 2205 does not detect another node to provide sync. UE41 2205 does not have accurate sync method, such as a GPS or UTC. UE41 2205 has no choice but send a sync signal with a rough timing on its own. UE41 2205 needs to indicate in D2DSS and PD2DSCH that UE41 2205 cannot provide sync to other nodes, for example, the bit in Table 3 set as ‘0’. Alternatively, UE41 2205 indicates that it does not have accurate sync method, for example, the bit in Table 4 set as ‘0’. Alternatively, UE41 2205 indicates that it does not derive timing from node that has as an accurate sync method (for example, the bit in Table 5 set as ‘0’. UE41 2205 can indicate it is hop number “1”. Then UE42 2210 and UE43 2215 detects the sync from UE41 2105, and sync to UE41 2205. That is, UE42's 2210 TX timing is derived from the sync signal transmitted by UE41 2205, and UE42's 2210 RX timing is the same as its TX timing, when UE41 2205 does not receive another sync signal from another node for communication purpose. UE42 2210 and UE43 2215 understand that the sync provided by UE41 2205 is not accurate, so whenever either UE42 2210 or UE43 2215 detect another more accurate sync (such as UE51 2220, UE52 2225, or UE53 2230) UE42 2210, or UE43 2215 respectively, reselect the other node. UE51 2220 does not detect any other node to provide sync, but UE51 2220 has an accurate sync method, such as a GPS or UTC, then UE51 2220 sends a sync signal with timing on its own. UE51 2220 needs to indicate in D2DSS and PD2DSCH that UE51 2220 can provide sync to another node, for example, the bit in Table 3 set as ‘1’. Alternatively, UE51 2220 indicates that UE51 2220 has accurate sync method, for example, the bit in Table 4 set as ‘1’. Alternatively, UE51 2220 indicates that UE51 2220 has its timing derived from an accurate timing source, such as a GPS or UTC, or a node that has an accurate sync method available, for example, the bit in Table 5 set as ‘1’. UE51 2220 can indicate it is hop number 1. Then UE52 2225 and UE53 2230 detect the sync from UE51 2220. UE52 2225 and UE53 2230 sync to UE51 2220 for communication purposes. UE52 2225 and UE53 2230 understand that the sync provided by UE51 2220 is accurate, so when either UE52 2225 or UE53 2230 detect another UE without accurate sync, such as UE41 2220, even with stronger signal, UE52 2225, or UE53 2230 respectively, does not reselect to the other node. If Max_hop_NeNB is set to be more than “1” if the origin of the sync source has accurate sync method, such as GPS or UTC, then UE52 2225, or UE53 2230, transmits a sync signal and indicates that UE52 2225, or UE53 2230 respectively, has its timing derived from a node that has accurate sync method available, for example, the bit in Table 5 set as ‘1’. And UE52 2225, or UE53 2230 respectively, indicates it is hop number 2. UE54 2235 and UE55 2240 can then sync to UE52 2225 and UE53 2230 respectively, if detected. If UE43 2215 detects UE52 2225, UE43 2215 can reselect UE52 2225 as the sync to which it can sync to.

In certain embodiments, a node with GPS or UTC available always sets hop number equal to “1” when the does not use reference timing from eNB.

In certain embodiments, the OOC UE has a preconfigured resource pool for transmission, where the preconfigured resource pool can be based on D2D frame number (D2D-FN). For example, the preconfigured resource pool can define some sub-frames to be used for D2D transmission. In certain embodiments, the sub-frames are defined as a set of sub-frames, indicated by certain bitmap, within a resource pool periodicity, where the periodicity can be based on D2D-FN 0, such as each window of the period duration starting at the beginning of the frame whose D2D-FN modulo resource_pool_period=0. The preconfigured resource pool can be a pool for Mode 2 communication. The preconfigured resource pool can also be a pool for SA.

FIG. 23 illustrates a diagram of a preconfigured resource pool based on D2D-FN according to embodiments of the present disclosure. The embodiment of the preconfigured resource pool 2300 shown in FIG. 23 is for illustration only. Other embodiments could be used without departing from the scope of the present disclosure.

In the example shown in FIG. 23, the beginning of a frame with D2D-FN=0 2305 is the starting point of period 2310 of a preconfigured resource pool. The preconfigured resource pool can consist of the sub-frames 2315 in the preconfigured TX resource pool in the time domain, so the UE can transmit the D2D signal within the pool. In certain embodiments, a bitmap is used to indicate whether a sub-frame is used for D2D or not based on each of the bit in the bitmap. A UE TX 2320 uses the TX resource pool for transmission. A UE RX 2325 monitors the resource pool for reception. If the UE RX 2325 is an OOC and UE RX 2325 does not know any other resources to monitor, for example, UE RX 2325 does not receive any reception pool or TX pool configured by any eNB. UE RX 2325 monitors the RX resources based on D2D-FN, and does not need to monitor other resources for D2D communication.

A mapping function can be defined. The mapping function maps a common accurate timing such as GPS/UTC to D2D frame number (D2D-FN).

A D2D-FN can have, for example, ten (10) bits, to indicate a frame number. Each frame is 10 ms. A further 4 bits can be used to indicate the subframe index (0 to 9) within a frame. These 4 bits can be combined together with the 10-bit D2D frame number to form a 14-bit D2D-FN up to the accuracy level of sub-frame. Alternatively, a D2D-FN can have fewer bits than ten (10) bits. Alternatively, a D2D-FN may have more than ten (10) bits, to allow a periodicity of OOC resource pool more than 1024 ms.

The mapping function from the GPS, or UTC, to D2D-FN can be, for example, D2D-FN=(GPS_time (in the unit of ms)/10) modulo 1024, if D2D-FN has 10 bits. GPS_time can be in the unit of ms. For example, if GPS_time is 30,000 ms, then D2D-FN is 30,000/10 modulo 1024=952. The mapping function can also give the first subframe of the frame indicated by D2D-FN. For example, the starting point or the first subframe of D2D-FN=0 can be, the subframe with GPS_time where GPS_time (in the unit of ms) modulo 10240=0.

For D2D UE, the D2D UE is either an OOC or an IC. When the GPS, or UTC, is available and running, the D2D UE maps the GPS, or UTC, to obtain D2D-FN, using the mapping function. The mapping function can be fixed, or preconfigured.

If an eNB has GPS or UTC available, the eNB maps the GPS, or UTC, to obtain D2D-FN, using the mapping function. For the IC UE and the OOC UE of cat. 1, the eNB provides D2D-FN to the UE, which for example, can be signaled in the signal from eNB, such as via SIB or via dedicated signaling, to UE, or relayed from a UE to another UE, such as, for an IC UE to an OOC UE of cat. 1, and further from OOC UE of cat. 1 to another OOC UE of cat. 1. The relayed D2D-FN can be signaled, for example, in PD2DSCH.

In certain embodiments, SFN and D2D-FN are synchronized. An eNB sets its system frame number (SFN) to be the same as D2D-FN, and the starting point (the first subframe) of D2D-FN and the starting point (the first subframe) are set to be the same. Alternatively, D2D-FN can be obtained using the same mapping function from the GPS, or UTC, to D2D-FN, if there is also a mapping function from the GPS, or UTC to SFN, for the derivation of SFN. Synchronizing SFN and D2D-FN, for example, the same SFN ‘0’, namely the first sub-frame of SFN ‘0’, and D2D-FN ‘0’, namely the first sub-frame of D2D-FN ‘0’, can simplify the UE's operation, as well as having better performance for co-existence of D2D and WAN (cellular).

Alternatively, the derivation of D2D-FN, for example, the mapping function from the GPS, or UTC, to D2D-FN, can be different from the derivation of SFN, for example, the mapping function from the GPS, or UTC, to D2D-FN. If the derivations of D2D-FN and SFN are different, D2D-FN can be separately provided to the UE.

An eNB signals to a UE regarding whether the eNB has D2D-FN derived from the GPS, or UTC, or whether the eNB has D2D-FN, such as by default the D2D-FN, if any, provided by eNB is accurate, or whether the D2D-FN is the same or different from SFN, and if different, by how much. For example, an offset with respect to the SFN ‘0’ can be provided as the D2D-FN where the offset can be in the unit of frames; for another example, an offset of D2D-FN ‘0’ with respect to the SFN ‘0’ can be provided where the offset can be in the unit of sub-frames, and the UE can derive:

D2D-FN=SFN+MSB_{—}10(Offset_{—}D2D-FN0_{—}SFN0_fomat1) (1)

where MSB_{—}10 (Offset_D2D-FN0_SFN0_format1) is the ten most significant bit (MSB) of the Offset_D2D-FN0_SFN0_format1, which is the offset of D2D-FN 0 with respect to the SFN 0 in the unit of sub-frames in its first format, where the first format is that Offset_D2D-FN0_SFN0_format1 is in a format that Ten MSB is the offset of D2D-FN0 and SFN0 in the unit of frames, and LSB (least significant bit) 4-bit is used to further indicate the relative location of the sub-frame within a frame as the offset, where the actual offset in the unit of sub-frames can be calculated as

Actual offset=MSB_{—}10(Offset_{—}D2D-FN0_{—}SFN0_format1)*10+LSB_{—}4(Offset_{—}D2D-FN0_{—}SFN0_format1). (2)

Offset_D2D-FN0_SFN0_format1, in the unit of sub-frames in its first format, in some embodiments, can represent the D2D-FN, which is up to the accuracy level of sub-frame. Alternatively, if Offset_D2D-FN0_SFN0 is a value counted as the actual offset in the number of sub-frames where the counting starts from 0, then:

D2D-FN=SFN+int(Offset_{—}D2D-FN0_{—}SFN0/10) (3)

where int (Offset_D2D-FN0_SFN0/10) is the integer part of Offset_D2D-FN0_SFN0/10.

Throughout the disclosure, SFN 0 (SFN0) or D2D-FN0 (D2D-FN 0) means the starting sub-frame with SFN=0 or D2D-FN=0, respectively.

If an eNB does not have GPS or UTC, or another method to provide an accurate D2D-FN, the eNB is configured to provide any D2D-FN. In the sync prioritization, namely, selecting or reselecting a node, when a first UE receives a sync signal (D2DSS and PD2DSS) from a second UE that indicates it derives its timing from a first eNB that provided D2D-FN, and when the first UE also receives a sync signal from a third UE that indicates it derives its timing from a first eNB that does not provide D2D-FN, the first UE prioritizes connection to the second UE and third UE. That is, the first UE prioritizes to select or reselect to sync to the second UE if some other conditions are similar for the second and the third UE. To achieve such, in the sync signal, such as PD2DSCH, a UE provides information of whether the eNB has D2D-FN or not.

Table 20 illustrates an example of the signaling from eNB to UE. The information can be in SIB, or in dedicated signaling. The information indicates whether D2D-FN is provided or not. If the information is provided, and if D2D-FN offset with respect to SFN 0 of the cell that transmits SIB or the dedicated signaling is not provided, the UE can regard the offset as a default value zero. Alternatively, in certain embodiments, the D2D-FN offset with respect to SFN 0 is always provided. This offset can be in the units of frames. If the offset is in the units of frames, the offset may require 10-bits. Some further offset indication in the units of sub-frames may be needed, to provide more accuracy. Alternatively, this offset can be in the units of sub-frames. If the is in the units of sub-frames, the offset may require 14-bits. The unit in terms of sub-frames provides more accuracy. Throughout the disclosure, SFN 0 or SFN0 or D2D-FN0 or D2D-FN 0 refers to the starting sub-frame with SFN or D2D-FN=0. The D2D offset to SFN0 can be interchangeable to D2D-FN, which can be a 14-bit D2D-FN up to the accuracy level of sub-frame where the MSB 10-bit of the 14-bit can be D2D frame number and LSB 4-bit of the 14-bit is 4-bit indication of the sub-frame index (0 to 9) within a frame.

TABLE 20
Information fields in SIB (or dedicated signaling from eNB)

| | Size (bits) | Information |
|---|---|---|
| . . . | . . . | . . . |
| D2D-FN provided or not | 1 | Value ‘0’ indicates: no |
| | | Value ‘1’ indicates: yes |
| D2D-FN offset to SFN (if | 10, or 14 | An offset of D2D-FN to SFN 0 (default value |
| D2D-FN is provided) | | can be zero). |
| | | Presents if D2D-FN is provided. |
| | | This offset can be in the unit of frames. If it is in |
| | | the unit of frames, it may need 10-bits. Some |
| | | further offset indication in the unit of sub-frames |
| | | may be needed, to provide more accuracy. |
| | | Alternatively, this offset can be in the unit of |
| | | sub-frames. If it is in the unit of sub-frames, it |
| | | may need 14-bits. The unit of sub-frames gives |
| | | more accuracy. |
| . . . | . . . | . . . |

Table 21 illustrates an alternative to Table 20 on how to indicate the D2D-FN offset to SFN. A D2D-FN offset to SFN can be provided in units of frames (for example, with 10-bits), and further a D2D-FN sub-frame offset in units of sub-frames with respect to SFN sub-frames can be provided (for example, with 4-bits). The actual offset in the unit of sub-frames can be calculated as

Actual offset=D2D-FN offset to SFN*10+D2D-FN sub-frame offset (4)

In Equation 4, The D2D-FN offset to SFN is in frames and D2D-FN sub-frame offset is in sub-frames. D2D-FN offset can be applicable to other scenarios such as the other tables in the disclosure. Or the D2D-FN offset can be combined with other indications or tables.

TABLE 21
Information fields in SIB (or dedicated signaling from eNB)

| | Size | |
|---|---|---|
| | (bits) | Information |
| . . . | . . . | . . . |
| D2D-FN provided or not | 1 | Value ‘0’ indicates: no |
| | | Value ‘1’ indicates: yes |
| D2D-FN offset to SFN | 10 | An offset of D2D-FN to SFN 0 |
| (if D2D-FN is provided) | | (default value can be zero). |
| (in the unit of frames) | | Presents if D2D-FN is provided. |
| | | In the unit of frames |
| D2D-FN sub-frame | 4 | The index of further offset |
| offset or index | | in the unit of sub-frames with respect |
| | | to SFN sub-frames, in addition |
| | | to the frame level offset. |
| | | It may be omitted if the system is |
| | | synchronous to the sub-frame level. |
| . . . | . . . | . . . |

Table 22 illustrates an example of the signaling from an eNB to a UE. The information can be signaled in SIB or in dedicated signaling. The information indicates whether D2D-FN is provided or not. The information also indicates D2D-FN offset with respect to SFN 0 of the cell that transmits SIB or the dedicated signaling. The D2D-FN related information may go together with the TX resource pool configuration, and RX resource pool configuration. The RX resource pool configuration includes resource pool(s) for both Mode 1 and Mode 2 communications (jointly, or separately). PCID of neighboring cell can be provided, and offset with respect to the first sub-frame in SFN0 also can be provided for each of the neighboring cell's RX resource pool. Alternatively, an offset of neighboring cell's first sub-frame SFN0 with respect to the first sub-frame in SFN0, and an offset of the starting of a bitmap, within a periodicity of a D2D resource pool, with respect to the neighboring cell's SFN0, which is the first sub-frame, where each of the bit in the bitmap indicates whether a respective sub-frame is used for D2D or not.

TABLE 22
Information fields in SIB (or dedicated signaling from eNB)

| | Size | |
|---|---|---|
| | (bits) | Information |
| . . . | . . . | . . . |
| D2D-FN provided or not | 1 | Value ‘0’ indicates: no |
| | | Value ‘1’ indicates: yes |
| D2D-FN offset to SFN (if | 14 | An offset of beginning of D2D-FN to the first sub- |
| D2D-FN is provided) | | frame of SFN 0 (default value can be zero). Present if |
| | | D2D-FN is provided. (in the unit of sub-frames) |
| TX resource pool | | Configuration for TX resource pool, with respect to |
| configuration | | SFN 0 of the cell that transmits the SIB |
| RX resource pool | | May include resource pool(s) for both Mode 1 and |
| configuration | | Mode 2 communications |
| {PCID | | PCID of the cells (e.g., neighboring cells) (may be |
| | | omitted for this cell that transmits the SIB) |
| Offset with respect to the | | In the unit of sub-frames |
| first sub-frame in SFN 0 | | |
| RX resource pool | | May include resource pool(s) for both Mode 1 and |
| configuration | | Mode 2 communications |
| . . . | | |
| } | | |
| . . . | . . . | . . . |

Table 23 illustrates example of the information field transmitted by PD2DSCH. The SFN of the eNB can be provided. When PD2DSCH is transmitted in one sub-frame, then a 10-bit SFN and 10-bit or 14-bit offset of D2D-FN with respect to SFN, or D2D-FN itself, is transmitted in PD2DSCH. If PD2DSCH is repeated over multiple frames, for example, repeated over N (N=2, or 4, and so forth) frames, such as consecutive frames, as the information field in these N sub-frames should be the same, the information bit in PD2DSCH for SFN or for D2D-FN, or the offset with respect to SFN, is 10−log₂N bits. For example, if N=4, then 8-bits are used, and these bits in the payload of PD2DSCH can be the MSB (most significant bits) of the D2D-FN, while the LSB (log₂N) bit can be derived by blind decoding.

TABLE 23
Information fields in PD2DSCH

| | Size | |
|---|---|---|
| | (bits) | Information |
| . . . | . . . | . . . |
| SFN | 10 | eNB SFN (only applicable for the UE that |
| | | transmits D2DSS sequence from a set of |
| | | sequences that are used by UEs that derive |
| | | timing from eNB) |
| D2D-FN provided by eNB or not | 1 | Value ‘0’ indicates: no |
| (alternatively, | | Value ‘1’ indicates: yes |
| D2D-FN originated by GPS or | | (only applicable for the UE that transmits |
| UTC or not) | | D2DSS sequence from a set of sequences that |
| | | are used by UEs that derive timing from eNB) |
| D2D-FN offset to SFN if SFN | 14 | An offset of D2D-FN to SFN 0 (default value |
| presents; otherwise, D2D-FN | | can be zero) if SFN presents, otherwise, D2D- |
| | | FN is provided. In the unit of sub-frames |
| . . . | . . . | . . . |

Table 24 illustrates example of the information field transmitted by PD2DSCH. As an alternative to Table 24, D2D-FN can be provided, and SFN can be provided as an offset with respect to D2D-FN.

TABLE 24
Information fields in PD2DSCH

| | Size | |
|---|---|---|
| | (bits) | Information |
| . . . | . . . | . . . |
| D2D-FN | 10 | D2D-FN |
| D2D-FN provided by eNB or not | 1 | Value ‘0’ indicates: no |
| (alternatively, | | Value ‘1’ indicates: yes |
| D2D-FN originated by accurate | | |
| method such as GPS or UTC or not) | | |
| SFN offset to D2D-FN | 14 | An offset of SFN to D2D-FN 0 (default value |
| | | can be zero) (only applicable for the UE that |
| | | transmits D2DSS sequence from a set of |
| | | sequences that are used by UEs that derive |
| | | timing from eNB), in units of sub-frames |
| . . . | . . . | . . . |

Table 25 illustrates example of the information field transmitted by PD2DSCH. Similar to Table 22, PD2DSCH includes the resource pool related information, IC UE and OOC cat. 1 UE relay the information. Table 25 also can extend Table 24, instead of extend Table 23, that is, instead of SFN, and D2D-FN offset with respect to SFN, Table 25 provides information on D2D-FN, and for SFN, it can be determined by an offset with respect to D2D-FN.

TABLE 25
Information fields in PD2DSCH

| | Size | |
|---|---|---|
| | (bits) | Information |
| . . . | . . . | . . . |
| SFN | 10 | eNB SFN (this field is applicable for the UE that |
| | | transmits D2DSS sequence from a set of sequences that |
| | | are used by UEs that derive timing from eNB) |
| D2D-FN provided by eNB | 1 | Value ‘0’ indicates: no |
| or not | | Value ‘1’ indicates: yes |
| (alternatively, | | (this field is applicable for the UE that transmits |
| D2D-FN originated by | | D2DSS sequence from a set of sequences that are used |
| GPS or UTC or not) | | by UEs that derive timing from eNB) |
| D2D-FN offset to SFN if | 10 | An offset of D2D-FN to SFN 0 (default value can be |
| SFN presents; otherwise, | | zero) if SFN presents, otherwise, D2D-FN is provided |
| D2D-FN | | |
| TX pool resource | | Configuration for TX resource pool, with respect to |
| configuration | | SFN 0 of the cell that transmits the SIB (mainly for |
| | | Mode 2) (this field is applicable for the UE that |
| | | transmits D2DSS sequence from a set of sequences |
| | | which are used by UEs that derive timing from eNB) |
| RX pool resource | | May include resource pool(s) for both Mode 1 and |
| configuration | | Mode 2 communications (this field is applicable for the |
| | | UE who transmits D2DSS sequence from a set of |
| | | sequences which are used by UEs who derive timing |
| | | from eNB) |
| . . . | . . . | . . . |

For TX resource pool, the eNB configured TX resource pool can be the same as preconfigured resources, such as based on D2D-FN, or a subset of the preconfigured resources. For the RX resource pool, the eNB configured TX resource pool can be preconfigured TX resource pool plus the Mode 1 resource pool (a union of these pools). When Mode 1 resource pool for OOC UE to monitor or reception is a union of resources that can be also preconfigured, the RX resource pool may be omitted in PD2DSCH. For example, the RX resources for Mode 1, as a total, can be preconfigured.

Table 26 illustrates example of the information field transmitted by PD2DSCH. The field of whether D2D-FN is originated by accurate sync method, such as GPS or UTC, can be applicable for the UE that transmits D2DSS sequence from a set of sequences that are used by UEs that do not derive timing from an eNB, when the eNB provides accurate sync method. When the eNB does not have accurate sync method, this field is applicable to any D2D UE, and the UE can relay the accurate D2D-FN to other UEs, or even eNB. The indication of whether D2D-FN is originated by accurate sync method, such as GPS and UTC, or not can alternatively carried by D2DSS, such as via using different sequence sets, or using different relative timing of PD2DSS and SD2DSS, or by using different location of D2DSS. “D2D-FN originated by accurate sync method, such as GPS or UTC, or not” also can be alternatively “Sync originated by accurate sync method or not”.

TABLE 26
Information fields in PD2DSCH

| | Size | |
|---|---|---|
| | (bits) | Information |
| . . . | . . . | . . . |
| D2D-FN originated by | 1 | Value ‘0’ indicates: no |
| accurate sync method | | Value ‘1’ indicates: yes |
| (such as GPS or UTC) or | | |
| not | | |
| D2D-FN | 10 | D2D-FN derived |
| . . . | . . . | . . . |

For example, in the example shown in FIG. 22, UE51 2220, UE52 2225, UE53 2230, UE54 2235, and UE55 2240 can indicate D2D-FN originated by an accurate source, such as GPS or UTC, having the bit set ‘1’. UE41 2205, UE42 2210, UE43 2215 can indicate D2D-FN that is not originated by an accurate source, such as GPS or UTC, having the bit set ‘0’. If UE43 2215 detects any of UE51 2220, UE52 2225, UE53 2230, UE54 2235, or UE55 2240, UE43 2215 updates its D2D-FN to the D2D-FN provided by UE51 2220, UE52 2225, UE53 2230, UE54 2235, and UE55 2240.

In certain embodiments, an OOC cat. 2 obtains D2D-FN from another UE that indicates D2D-FN, such as another OOC cat. 2 or OOC cat. 1. If there are multiple hops allowed, even the UE with max hop can transmit D2DSS and PD2DSCH that includes D2D-FN.

When OOC UE cat. 1 also has GPS, the OOC UE cat. 1 can relay D2D-FN. But the resource the OOC UE cat. 1 would use to transmit is the resource pool configured by the eNB, not the resource pool determined by D2D-FN, namely preconfigured.

PD2DSCH also can provide a sub-frame number or index, to assist a UE to detect the sub-frames. If D2DSS is located in certain sub-frames, then by detecting D2DSS, the UE can determine the respective sub-frame. For example, when D2DSS is located in sub-frame #2 for TDD case, or in sub-frame #1, sub-frame #2, or sub-frame #6 for common design for TDD and FDD, the UE receives D2DSS and determines that the respective sub-frame is subframe#2, with respect to the TX timing of the transmitter that transmits the D2DSS. When the D2DSS is located in multiple different sub-frames, such that a UE after detecting D2DSS is unable to determine the sub-frame, the UE needs to further decode PD2DSCH to decide the respective sub-frame. If the PD2DSCH is located in certain sub-frame(s), then by detecting the PD2DSCH, the UE determines the respective sub-frame based on the location of the PD2DSCH. In certain embodiments, such as if the PD2DSCH may be located in multiple different sub-frames, such that the PD2DSCH location may not provide a respective sub-frame number, the sub-frame number is carried in the payload of the PD2DSCH. When there is D2D signaling spanning out for consecutive sub-frames, such as ten (10) sub-frames, where the signaling can carry D2D-FN number, the UE detects the boundary of frame, hence the UE can determine the respective sub-frame number.

In certain embodiments, the D2DSS is transmitted in predetermined sub-frames where each location of the sub-frame corresponds to a respective hop number. For example, hop #1 is in sub-frame #1, hop #2 is in sub-frame #2, hop #3 is in sub-frame #6. When the hop number is indicated by a respective set of sequence of D2DSS, or by a respective relative distances of PD2DSS and SD2DSS, the UE detects the hop number from D2DSS detection based on the sequence or the relative distances of PD2DSS and SD2DSS, and determines the sub-frame accordingly by using the predetermined mapping of the hop number to the location or the index of sub-frame.

In certain embodiments, configured TX resources have higher priority than the preconfigured TX resources.

For UE RX, the UE can monitor RX resources with respect to the respective timing. The UE uses the same timing as its TX timing to monitor the RX resources that are used by other D2D UEs that use the same TX timing as itself. For example, the UE monitors a RX pool that can be a union of the TX and the RX resources based on its serving cell's SFN (if any). The TX resource can include an SA resource pool for Mode2 D2D communication. The RX resource includes a SA resource pool for Mode1 and Mode2 communication. Alternatively, the UE monitors the SFN of the eNB from which the UE derives reference timing from, if any, or the SFN relayed by other UE. In addition, the UE can monitor RX resources of neighboring cells based on timing offset with respect to the serving cell's timing. The UE can also monitor the preconfigured resources based on D2D-FN.

For UE's operation, following options can be used.

In Option 1, OOC resource for UE communication is predefined or preconfigured. The OOC UEs of cat. 1 or cat. 2 all use the preconfigured resources for TX. The relayed information in PD2DSCH includes D2D-FN. The PD2DSCH may not need to include a TX resource pool configuration. This option simplifies PD2DSCH. For RX purpose, SFN may still be needed to be included in PD2DSCH. If IC UE also uses preconfigured resources for TX, then SFN can be omitted from the PD2DSCH if UE relays the information from eNB.

In Option 2, OOC resource for UE communication is predefined or preconfigured. The OOC UEs of cat. 2 all use the preconfigured resources for TX. The OOC UEs of cat. 1 use the eNB configured resources. When the eNB has D2D-FN, the eNB signals the D2D-FN to the UEs. When the eNB does not have D2D-FN, other UEs signal D2D-FN to the eNB. The relayed information in PD2DSCH includes TX resource pool configuration. The D2D-FN may also be needed to be included. Certain embodiments of this option require more bits carried in PD2DSCH. For RX purpose, SFN may still be needed to be included in PD2DSCH. An extension is that for OOC UE of cat. 1, which receives D2DSS and PD2DSCH indicating the hop number being Max_hop_eNB, the OOC UE cat. 1 does not provide sync to other nodes, and the OOC UE cat. 1 uses preconfigured OOC resources to transmit. The alternative would be that the OOC UE cat. 1 acts like other OOC UEs of cat. 1, which transmits in eNB configured OOC resources, relayed by UEs, if available, which is a higher priority, and if not available, the OOC UE cat. 1 uses preconfigured OOC resources, which is a lower priority, for transmission.

For OOC UEs cat. 1, if the OOC UE has GPS or UTC, the OOC UEs cat. 1 indicates such in a sync signal, such as in Table 4. In certain embodiments, the OOC UEs cat. 1 also indicates that the OOC UEs cat. 1 uses reference timing from eNB, such as by D2DSS sequence from the set for the nodes using reference timing derived from eNB. In certain embodiments, the OOC UEs cat. 1 can also indicate the hop number counting from the eNB. The signaling of the indication that the OOC UEs cat. 1 has GPS or UTC for D2D-FN enables other UEs to sync to the OOC UEs cat. 1. In certain embodiments, even if the OOC UEs cat. 1 has GPS or UTC, for Option 2 above, the OOC UEs cat. 1 uses the eNB configured TX resources to transmit, if the TX resources configured are different from the preconfigured resource, such as when the eNB configured resource is a subset of the preconfigured resource based on D2D-FN. The advantage is to reduce the interference to the in-coverage UEs.

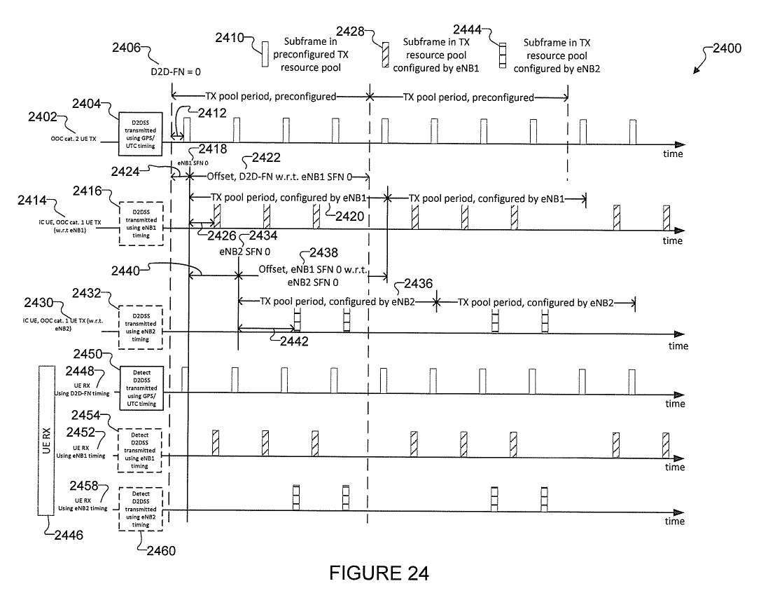

FIG. 24 illustrates TX and RX resources including OOC resources determined by or based on D2D-FN and respective timing according to embodiments of the present disclosure. The embodiment of the TX and RX resources 2400 shown in FIG. 24 is for illustration only. Other embodiments could be used without departing from the scope of the present disclosure.

In the example shown in FIG. 24, UE TX 2402 is an OOC cat. 2 UE. UE TX 2402 transmits D2DSS using accurate sync method, such as GPS or UTC, if available 2404. If not, the UE TX 2402 transmits D2DSS using rough timing, which may not be very accurate. The UE TX 2402 also indicates whether its sync is obtained via an accurate method or not, such as in PD2DSCH. The beginning of a frame with D2D-FN=0 2406 is the starting point of period 2408 of a preconfigured resource pool. The preconfigured resource pool can consist of the sub-frames 2410 in the preconfigured TX resource pool in the time domain, so the UE TX 2402 can transmit the D2D signal, such as Mode2 communication SA and data, within the pool. The UE TX 2402, such as an OOC UE cat. 2, can use the TX resource pool for transmission. An offset within the preconfigured TX pool period from where the TX resources are indicated, for example by a bitmap or bitmaps, is referred to as Offset_inner_Preconfig 2412. Each bit of the bitmap or bitmaps indicates that a respective sub-frame is used for D2D resource or not.

For an IC UE or an OOC UE cat. 1 2414 that has a reference timing derived from eNB1 transmits D2DSS using eNB1 timing 2416. The D2DSS can be for communication purpose or it can be reserved for discovery purpose with respect to eNB 1. In certain embodiments, the IC UE, or OOC UE cat. 1, 2414 also transmits PD2DSCH, indicating that its reference timing is from eNB1, via an indication of identifier of eNB1 such as PCID of eNB1 and carrier index. The IC UE, or OOC UE cat. 1, 2414 receives TX pool and RX pool(s) configured by eNB1. The IC UE, or OOC UE cat., 2414 transmission with respect to eNB1 can have a TX pool based on eNB1 SFN 0 2418, with a TX pool 2420 period configured by eNB1. TX and RX resources 2400 include a first offset 2422 of D2D-FN 0 with respect to eNB1 SFN 0 and a second offset 2424 of eNB 1 SFN 0 with respect to D2D-FN 0. An offset within the eNB 1 configured TX pool period from where the TX resources are indicated, such as by a bitmap or bitmaps is referred to as Offset_inner_eNB1 2426. The eNB 1 can signal SFN, and the first offset 2422 of D2D-FN 0 with respect to eNB1 SFN 0 to the UE. The UE can signal SFN and the first offset 2422 of D2D-FN 0 with respect to eNB 1 SFN 0 to another UE. Alternatively, the UE can signal D2D-FN and the second offset 2424 of eNB 1 SFN 0 with respect to D2D-FN 0 to other UE. The pool period can consist of the sub-frames 2428 in the preconfigured TX resource pool in the time domain, so the IC UE, or OOC UE cat. 1, 2414 can transmit the D2D signal, such as Mode2 communication SA and data, within the pool.

An IC UE, or OOC UE cat. 1, 2430 that has a reference timing derived from eNB2 transmits D2DSS using eNB2 timing 2432. The D2DSS can be for communication purpose or the D2DSS can be reserved for discovery purpose with respect to eNB2. In certain embodiments, the IC UE, or OOC UE cat. 1, 2430 transmits PD2DSCH, indicating that its reference timing is from eNB2 such as via an indication of an identifier of eNB2, such as PCID of eNB2 and carrier index. The IC UE, or OOC UE cat. 1, 2430 receives TX pool and RX pool(s) configured by eNB2. The IC UE, or OOC UE cat. 1, 2430 transmission with respect to eNB2 can have a TX pool, based on eNB2 SFN 0 2434 with a TX pool period 2436 configured by eNB2. The TX and RX resources 2400 includes a third offset 2438 of eNB1 SFN 0 with respect to eNB2 SFN 0 and a fourth offset 2440 of eNB2 SFN 0 with respect to eNB1 SFN 0. An offset within the eNB2 configured TX pool period from where the TX resources are indicated, such as by a bitmap or bitmaps, is referred to as Offset_inner_eNB2 2442. The pool period can consist of the sub-frames 2428 in the preconfigured TX resource pool in the time domain, so the IC UE, or OOC UE cat. 1, 2444 can transmit the D2D signal, such as Mode2 communication SA and data, within the pool.

An RX UE 2446 uses one or multiple of RX timings to monitor respective resources for respective transmitted D2D signal from other nodes. The RX UE 2446 derives a sub-frame level of RX timing based on signaling of the offsets. The RX UE 2446 can further tune the RX timing based on the TX timing of the other nodes, such as based on received D2DSS from other nodes, and its own TX timing, respectively. Finer tuning using sync signals can be used by the RX UE 2446 to enhance the accuracy of RX timing to finer level than sub-frame level, such as to the accuracy at the symbol level.

In certain embodiments, the RX UE 2446 is an IC UE, or OOC UE cat. 1, with respect to eNB1. The eNB1 can provide a RX pool with respect to the neighboring cell, eNB2, which has eNB2 SFN 0 2434. The eNB1 can provide, the period of the TX pool period 2436 configured by eNB2, the fourth offset 2440 of the eNB2 SFN0 with respect to eNB1 SFN0, and an offset within the eNB2 configured TX pool period from where the TX resources are indicated, such as by a bitmap or bitmaps, referred to as Offset_inner_eNB2 2442. Alternatively, the eNB1 provides a sum of the fourth offset 2440 of the eNB2 SFN0 with respect to eNB1 SFN0 and the Offset_inner_eNB2 2442. In certain embodiments, the eNB1 provide the first offset 2422 of D2D-FN 0 with respect to eNB1 SFN 0, and then the RX UE 2446, such as when the RX UE 2446 is the IC UE, or OOC UE cat. 1, 2414 with respect to eNB1, derives the timing of D2D-FN with respect to the eNB1 SFN0, and also using a preconfigured offset, Offset_inner_Preconfig 2412, the RX UE 2446 derives the timing for it to monitor the bitmap or bitmaps for the preconfigured resources, such as at a timing of the first sub-frame of eNB1 SFN 0+first offset 2422+Offset_inner_Preconfig 2412, of such as at a timing of the first sub-frame of eNB1 SFN 0+first offset 2422*10+Offset_inner_Preconfig 2412 if first offset 2422 is in the unit of frame. The RX UE 2446 can monitor D2D signal transmitted in TX resource pool configured by eNB1, such as at a timing of the first sub-frame of eNB1 SFN 0+Offset_inner_eNB1 2426. The RX UE 2446 can monitor D2D signal transmitted in TX resource pool configured by eNB2, such as at a timing of the first sub-frame of eNB1 SFN 0+fourth offset 2440+Offset_inner_eNB2 2442, or such as at a timing of the first sub-frame of eNB1 SFN 0+fourth offset 2440*10+Offset_inner_eNB2 2442 if fourth offset 2440 is in the unit of frame.

In certain embodiments, the RX UE 2446 is an OOC UE cat. 2. The RX UE 2446 can have D2D-FN 0 timing. The RX UE 2446 can receive relayed information from another UE, such as an OOC UE cat. 1 with respect to eNB1, the RX UE 2446 can obtain the information of the second offset 2424, Offset_inner_eNB1 2426, or alternatively, a sum of the second offset 2424 and the Offset_inner_eNB1 2426, then the RX UE 2446 can derive the timing to monitor TX resource pool configured by eNB1, such as at a timing of the first sub-frame of D2D-FN 0+second offset 2424+Offset_inner_eNB1 2426. The RX UE 2446 can also obtain the information of fourth offset 2440, Offset_inner_eNB2 2442, or alternatively, a sum of the fourth offset 2440 and Offset_inner_eNB2 2442, then the RX UE 2446 can further derive the timing to monitor TX resource pool configured by eNB2, such as at a timing of the first sub-frame of D2D-FN 0+second offset 2424+fourth offset 2440+Offset_inner_eNB2 2442.

The offsets in the TX and RX resources 2400 shown in FIG. 24 can be in the units of sub-frames. If first offset 2422, second offset 2424, fourth offset 2440, third offset 2438 are in the units of frames, they need to multiply by ten (10) in the addition operation of deriving time. For example, a UE, such as an OOC UE cat. 2, can monitor resources configured by eNB1 at a timing of the first sub-frame of D2D-FN 0+second offset 2424*10+Offset_inner_eNB1 2426, and monitor resources configured by eNB2 at a timing of the first sub-frame of D2D-FN 0+second offset 2424*10+fourth offset 2440*10+Offset_inner_eNB2 2442.

Since the offsets can be in the unit of sub-frames, further tuning of the TX timing and RX timing at the level of symbols can be based on the D2DSS or sync signal received.

The RX UE 2446 monitors the D2D signal using D2D-FN timing or preconfigured resource timing 2448. The RX UE 2446 derives the timing to monitor the preconfigured resource in the resource pool based on D2D-FN. If the RX UE 2446 has GPS or UTC available, the RX UE 2446 uses it to fine tune at the symbol level RX sync accuracy. If the RX UE 2446 does not have GPS or UTC available, the RX UE 2446 attempts to detect 2450 a D2DSS transmitted using accurate sync method, such as GPS or UTC, to fine tune at the symbol level sync accuracy, so that the RX UE 2446 can monitor with accurate RX timing for the D2D-FN based resources. The RX UE 2446 may need to decode PD2DSCH to understand whether the D2DSS transmitted by another node uses accurate sync method, such as GPS or UTC, when such indication is carried in PD2DSCH. When the RX UE 2446 detects that PD2DSCH indicates the D2DSS does not use an accurate sync method or D2D-FN is not derived using an accurate sync method, the RX UE 2446 can disregard the D2DSS decoded, and disregard the D2D-FN, not to monitor the preconfigured resource based on D2D-FN not derived by accurate sync method. Alternatively, the RX UE 2446 can monitor the signal based on the rough D2D-FN and based on the detected D2DSS and PD2DSCH.

The RX UE 2446 monitors D2D signal transmitted in TX resource pool configured by eNB1, such as at a timing of the first sub-frame of eNB1 SFN 0+Offset_inner_eNB1 2426, using eNB1 reference timing 2452. The sub-frame level of the timing can be derived by a timing of the first sub-frame of eNB1 SFN 0+Offset_inner_eNB1 2426, or by eNB2 SFN 0+third offset 2438+Offset_inner_eNB1 2426 if the RX UE 2446 has TX timing from eNB2, or by D2D-FN 0+second offset 2424+Offset_inner_eNB1 2426 if the RX UE 2446 has TX timing from D2D-FN or GPS or UTC. If the UE TX timing is eNB1, the UE can use TX timing for the RX timing, using eNB1 reference timing 2452. If the UE TX timing is not eNB1, the RX UE 2446 detects UE D2DSS transmitted using eNB1 timing, or detects sync signal from eNB1, to fine tune the RX timing, to the symbol level 2454. In certain embodiments, the RX UE 2446 needs to detect PD2DSCH to find out the UE D2DSS signal is transmitted using eNB1 timing, where PD2DSCH indicates eNB1's identifier, such as PCID and carrier index.

The RX UE 2446 monitors the D2D signal transmitted in TX resource pool configured by eNB2, at a timing of the first sub-frame of eNB2 SFN 0+Offset_inner_eNB2 2442, using eNB2 reference timing 2458. The sub-frame level of the timing can be derived by a timing of the first sub-frame of eNB2 SFN 0+Offset_inner_eNB2 2442 if the RX UE has TX timing from eNB2, or by eNB1 SFN 0+fourth offset 2440+Offset_inner_eNB2 2442 if the RX UE has TX timing from eNB1, or by D2D-FN 0+second offset 2424+fourth offset 2440+Offset_inner_eNB2 2442 if the RX UE has TX timing from D2D-FN or GPS or UTC. If the UE TX timing is eNB2, the UE can use TX timing for the RX timing 2458. If the UE TX timing is not eNB1, the UE detects UE D2DSS transmitted using eNB2 timing, or detects sync signal from eNB2, to fine tune the RX timing, to the symbol level 2460. In certain embodiments, the RX UE 2446 needs to detect PD2DSCH to find out the UE D2DSS signal is transmitted using eNB2 timing, where PD2DSCH indicates eNB2's identifier, such as PCID and carrier index.

In certain embodiments, second offset 2424 and first offset 2422 can be equivalent and interchangeable, fourth offset 2440 and third offset 2438 can be equivalent and interchangeable.

In certain embodiments, the offset for TX pool is the same as the offset for RX pool. In certain embodiments, the offset for TX pool is different from the offset for RX pool. For example, Offset_inner_Preconfig 2412, Offset_inner_eNB1 2426, Offset_inner_eNB2 2442, are some of the offsets defined for TX pools, and respective RX pools, the offsets can be different from the offsets for TX pools. The offset for TX pool, offset for RX pool of the serving cell, and the offsets with respect to the RX pools of the neighboring cells can be separately provided. The RX timing derivation then can be based on the respective offsets with respect to the RX pool.

In the example shown in FIG. 24, the transmission of D2DSS and PD2DSCH and the detection of D2DSS and PD2DSCH are illustrated around the similar time in the timeline; however, this is only for illustration and embodiments of the present disclosure are not so limited. The transmission of D2DSS and PD2DSCH and the detection of D2DSS and PD2DSCH can be any time before the UE transmits D2D signal using resource in the resource pool and before the UE monitors D2D signal in the respective RX resource pool.

In certain embodiments, timing advance is applied to the timing (not illustrated in FIG. 24).

For example, in FIG. 7, UE7 755 uses TX timing from UE6 750 and uses RX timing from UE6 750 to receive signal transmitted at the D2D-FN timing for D2D signal transmitted using OOC resources. In certain embodiments, UE7 755 also uses RX timing from UE3 735 (eNB1 705 timing) to receive signal transmitted at eNB1 705 timing for D2D signal transmitted using the resources defined based on eNB1 705 timing, UE7 755 uses the offset in-between eNB1 705 SFN0 and D2D-FN0, and Offset_inner_eNB1 2426 if any, to determine sub-frame level timing, and use the D2DSS transmitted using eNB1 705 timing to further tune for the symbol level accuracy. UE7 755 also can use RX timing from UE11 775 (eNB2 715 timing) to receive signal transmitted at eNB2 715 timing for D2D signal transmitted using resources defined based on eNB2 715 timing. In certain embodiments, UE7 755 uses the offset in-between eNB2 715 SFN0 and D2D-FN0, and Offset_inner_eNB2 2442 if any, to determine sub-frame level timing, and use the D2DSS transmitted using eNB2 715 timing to further tune for the symbol level accuracy. In certain embodiments, UE7 755 monitors the signal from UE8 760 if UE7 755 detects the sync signal from UE8 760, and UE3 735 uses the timing of D2D-FN indicated by UE8 760, though the D2D-FN may be rough, to try to monitor the signal from UE8 760.

For another example, in the example shown in FIG. 7, UE3 735 uses TX timing from eNB1 705, and uses RX timing from eNB1 705 to receive signal transmitted at eNB1 705 timing for D2D signal transmitted using the resources defined based on eNB1 timing. UE3 735 uses D2D-FN timing for D2D signal transmitted using OOC resources. UE3 735 can use the offset in-between D2D-FN0 and eNB1 705 SFN0 if any. In certain embodiments, UE3 735 also uses RX timing from UE11 775 (eNB2 715 timing) to receive signal transmitted at eNB2 715 timing for D2D signal transmitted using resources defined based on eNB2 715 timing. In certain embodiments, UE3 735 also monitors the signal from UE8 760 if UE3 735 can detect the sync signal from UE8 760, and UE3 735 uses the timing of D2D-FN indicated by UE8 760, though the D2D-FN can be rough, to try to monitor the signal from UE8 760.

For another example, in the example shown in FIG. 7, UE8 760 uses its own rough TX timing. UE8 760 uses RX timing from UE7 755, or UE8 760 uses RX timing from UE11 775 (eNB2 715 timing) to receive signal transmitted at eNB2 715 timing for D2D signal transmitted using resources defined based on eNB2 715 timing, or UE8 760 uses RX timing from UE3 735 (eNB1 705 timing) to receive signal transmitted at eNB1 705 timing for D2D signal transmitted using the resources defined based on eNB1 705 timing.

As an alternative, for a UE that does not have accurate sync method, and cannot sync to another node that can provide sync, such as UE8 760, the UE can still try to sync to a node from which the UE can detect D2DSS and PD2DSCH. Even if the node cannot provide sync to others, for example, the UE can pick a node from which the UE receives the strongest signal of D2DSS and PD2DSCH. This means exceptions for a node that cannot provide sync can be made for a UE that does not have accurate sync method. Alternatively, the UE can sync to any other node that can provide sync.

As previously mentioned, if a first UE cannot be a sync source, or if the first UE cannot provide sync to a second UE, the first UE can still transmit D2DSS and PD2DSCH and other signals, for D2D communications. In certain embodiments, the second UE that receives the first UE's D2DSS and PD2DSCH does not determine its own TX timing as the one derived from the received D2DSS from the node that cannot provide sync to others. For example, UE3 735 can transmit D2DSS and PD2DSCH, and indicate that UE3 735 gets sync from a node with a max hop number originated from eNB, such that other UEs would not use UE3 735 as a sync source. When UE7 755 detects D2DSS and PD2DSCH from UE3 735, UE7 755 cannot set its own TX timing for D2D signal as the timing derived from UE3 735. Rather, if UE7 755 does not have GPS or UTC available, UE7 755 should find another node to sync to where the other node may be eligible to provide sync, where in the example shown in FIG. 7, UE7 755 finds UE6 750, which can provide sync. UE7 755 may set its RX timing as the TX timing to receive the D2D signal transmitted by other nodes that use the same TX timing as itself, and the UE7 755 also can set its RX timing derived from the D2DSS and PD2DSCH, based on SFN and D2D-FN offset, and other offset if applicable with respect to the RX resource pool indicated in PD2DSCH, as well as fine tuning at the symbol level based on the received D2DSS, to receive the D2D signal transmitted by UE3 735 or other nodes which use the same TX timing as UE3 735.

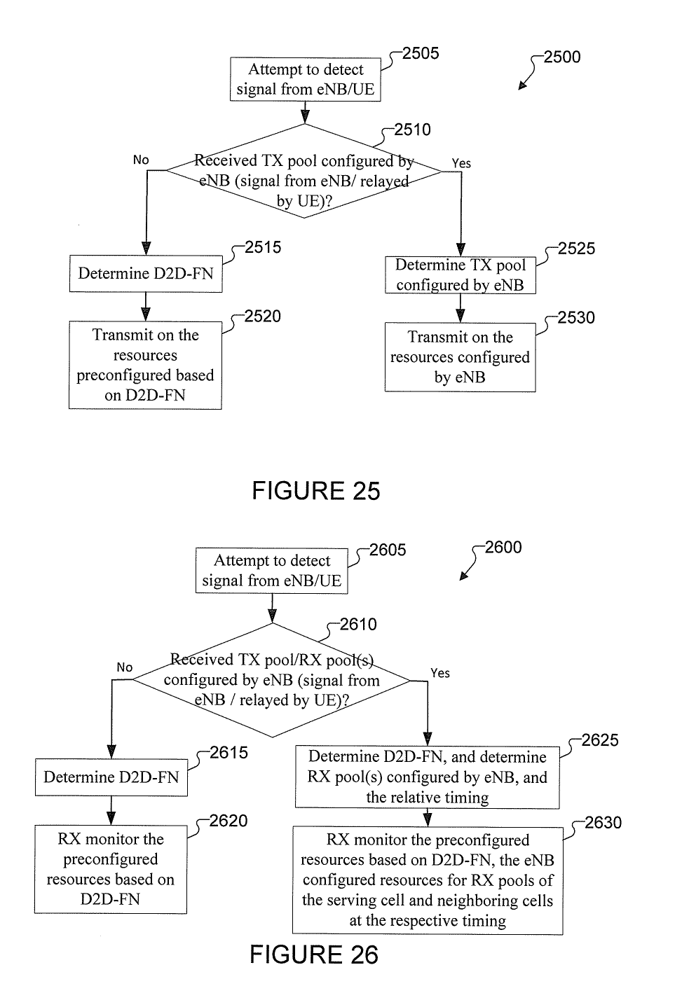

FIG. 25 illustrates a process for a UE to determine TX resources according to embodiments of the present disclosure. While the flow chart depicts a series of sequential steps, unless explicitly stated, no inference should be drawn from that sequence regarding specific order of performance, performance of steps or portions thereof serially rather than concurrently or in an overlapping manner, or performance of the steps depicted exclusively without the occurrence of intervening or intermediate steps. The process depicted in the example depicted is implemented by a transmitter chain in, for example, a mobile station.

In block 2505, a UE attempts to detect signal from eNB or other UE. The UE determines whether it receives TX pool configured by eNB in block 2510. The signal can be from eNB or relayed by other UE. If, in block 2510, the UE determines that it does not receive TX pool configured by eNB, for example, the UE is an OOC UE cat. 2, then the UE determines D2D-FN in block 2515. The D2D-FN can be determined by a mapping function, if the UE has its own accurate sync method, such as GPS or UTC. The D2D-FN may be obtained via other UE, if other UE has D2D-FN signaled in PD2DSCH. If the UE cannot get any D2D-FN from any other UE, or on its own by accurate sync method, the UE can get D2D-FN by a rough method. The UE indicates that the UE obtains D2D-FN by a rough method so that other UEs would not relay the D2D-FN to yet other UEs. In block 2520, the UE transmits on the resources preconfigured based on the D2D-FN. If, in block 2510, the UE determines that it receives TX pool configured by eNB, for example, when the UE is an IC UE and the UE receives the TX pool information from eNB, or the UE is an OOC UE cat. 1 and the UE receives the TX pool in PD2DSCH relayed by a OOC UE cat. 1 or relayed by an IC UE, then the UE determines TX pool configured by eNB in block 2525. In block 2530, the UE transmits then using the resources in the TX pool configured by eNB.

FIG. 26 illustrate a process for RX monitoring by a UE according to embodiments of the present disclosure. While the flow chart depicts a series of sequential steps, unless explicitly stated, no inference should be drawn from that sequence regarding specific order of performance, performance of steps or portions thereof serially rather than concurrently or in an overlapping manner, or performance of the steps depicted exclusively without the occurrence of intervening or intermediate steps. The process depicted in the example depicted is implemented by a transmitter chain in, for example, a mobile station.

In block 2605, a UE attempts to detect signal from eNB or other UE. The UE determines whether it receives TX pool or RX pool(s), or both, configured by eNB in block 2610. The signal can be from eNB or relayed by other UE. If, in block 2610, the UE determines that it does not receive TX pool or RX pool(s) configured by eNB, for example, when the UE is an OOC UE cat. 2, then the UE determines D2D-FN in block 2615. The D2D-FN can be determined by a mapping function, if the UE has its own accurate sync method, such as GPS or UTC. The D2D-FN can be obtained via other UE, if another UE has D2D-FN signaled in PD2DSCH. If the UE cannot get any D2D-FN from any other UE, or on its own by accurate sync method, the UE can get D2D-FN by a rough method. The UE indicates that the UE obtains D2D-FN by a rough method so that other UEs would not relay the D2D-FN to yet other UEs. In block 2640, the UE RX monitors on the resources preconfigured based on the D2D-FN. If, in block 2610, the UE determines that it receives TX pool or RX pool(s) configured by eNB, for example, the UE is an IC UE and the UE receives the resource pool information from eNB, or the UE is an OOC UE cat. 1 and the UE receives the resource pool information in PD2DSCH relayed by OOC UE cat. 1 or relayed by an IC UE, then the UE determines D2D-FN, and it determines RX pool(s) configured by eNB and relative timing in block 2625. The D2D-FN can be determined by its own accurate method, such as GPS or UTC, or by D2D-FN signaled from eNB, or D2D-FN signaled by other UEs in PD2DSCH, where the D2D-FN has to be the one determined by accurate method. In block 2630, the UE then monitors the preconfigured resources based on D2D-FN, using the RX timing based on D2D-FN, at the sub-frame level, and performs fine tuning by GPS or UTC, or transmits D2DSS using reference timing of GPS or UTC. The UE also monitors the eNB configured resources for RX pool of the serving cell or the cell from which the UE derives timing, where the RX pool can include the TX resource pool (Mode 2) and the TX resource pool for Mode 1. The RX resource union also includes the RX pool of neighboring cells with respective timing offset. The UE monitors the RX resources included RX pool of neighboring cells at the respective RX timing of the neighboring cells (timing based on the sub-frame level according to the offsets, such as illustrated in FIG. 24, and fine tuning based on D2DSS with respect to the respective neighboring cell's timing.

When a UE cannot be a sync source, or if a UE cannot provide sync to another UE, while the UE can still transmit D2DSS and PD2DSCH and other signals, for D2D communications, the UE's TX timing, for example, the TX resource pool, can be based on OOC, namely, the preconfigured TX resource pool, even if the UE may have also a TX resource pool based on SFN from the eNB. Alternatively, the UE uses TX timing and TX resource pool based on SFN from the eNB, if available.

When an eNB does not have D2D-FN, while UE has D2D-FN based on accurate sync method, such as GPS or UTC, the UE can signal the D2D-FN to eNB. The D2D-FN based on accurate sync method, such as GPS or UTC, also can be relayed by the UEs, such as OOC UEs, then IC UE can receive the D2D-FN and then signal it to eNB. When a first eNB does not have accurate sync method such as GPS or UTC, a second eNB has accurate sync method such as GPS or UTC, a UE or UEs can relay the D2D-FN provided by the second eNB to the first eNB. The UE's D2DSS can then provide further tuning or refinement of the sync.

In certain embodiments, the UE derives D2D-FN based on its own GPS or UTC, but the UE also detects D2D-FN from another node where the D2D-FN can be different from its own derived one. When the other node is a UE, the UE uses its own derived one. When the other node is an eNB, the UE uses the one from eNB, or the UE uses its own derived one.

In certain embodiments, the UE does not derive D2D-FN, such as a UE without GPS or UPC available. When the UE detects two different D2D-FN from other nodes, the UE chooses the D2D-FN from the node that has stronger signal.

In certain embodiments, a UE is situated such that the UE cannot be a node that provides sync to other node. For example, when the UE does not have accurate D2D-FN available, such as a UE without GPS or UPC available and not detecting other nodes that can provide sync, the UE should not be the node that provides sync to other node.

As an example, for the UEs illustrated in FIG. 7, when an OOC UE cat. 2, such as UE5 745, moves and sees a OOC UE cat. 1 but that is the last hop, such as UE11 775, UE5 745 may or may not update its D2D-FN with the one from UE11 775. When UE5 745 has GPS or UTC available, UE5 745 derives its own D2D-FN. When UE5 745 has its own derived D2D-FN, UE5 745 uses its own, which should be the same as the one in UE4 740 and UE11 775 if UE4 740 also use GPS or UTC, and UE11 775 gets D2D-FN from itself or from other node. If the D2D-FN derived by UE5 745 is different from the one in UE4 740 and UE11 775, UE5 745 still can use its own D2D-FN. If UE5 745 obtains the D2D-FN previously from UE4 740, and the D2D-FNs from UE4 740 and UE11 775 are different, and UE11 775 has stronger signal, UE5 745 can use D2D-FN from UE11 775 since it may be the more reliable channel.

In certain embodiments, when a UE gets D2D-FN from eNB, such as when the UE is in the eNB coverage, and the UE also detects a D2D-FN from another UE that may be in-coverage or out-of-coverage. The UE can set its D2D-FN in the priority order of the D2D-FN from eNB, in coverage UE, from out-of-coverage UE, when these D2D-FN can be different from eNB, or UEs.

When a UE obtains D2D-FN from a first node with D2D-FN derived from accurate sync method, such as GPS or UTC, and a D2D-FN from a second node that the D2D-FN is not derived by an accurate sync method, the UE sets its D2D-FN as the D2D-FN indicated by the first node. When both the first node and the second node have D2D-FN derived from accurate sync methods, yet the D2D-FN from these two nodes are different, the UE that receives these two different D2D-FN further determines to set its D2D-FN as the same as one of the D2D-FNs based on the priority order, where the priority can be set based on signal strength, wherein a higher priority is given to the node with higher signal strength, or the priority can be set based on the node type with a priority order of eNB, IC UE, OOC UE cat. 1, OOC UE cat. 2, if the signal strengths are beyond a certain threshold. Combination of the priority rule may also apply.

In certain embodiments, the offset within the preconfigured TX or RX pool period from where the TX or RX resources are indicated, such as by a bitmap or bitmaps, can be determined according to the period of the pool if there are multiple values for the period of the pool. Each bit of the bitmap or bitmaps indicate a respective sub-frame is used for D2D resource or not.

For example, in the example shown in FIG. 24, the offset, such as Offset_inner_Preconfig 2412, Offset_inner_eNB1 2426, Offset_inner_eNB2 2442, can have multiple period values. A first period can have a value of Period1. A second period can have a value of Period2. For example, Period1 can be 160 ms. Period2 can be 640 ms. In certain embodiments Period1 has N values for the offset. For example, N=4, values are 0 ms, 20 ms, 40 ms, 60 ms. Period2 has M values for the offset. For example, M=6, values are 0 ms, 40 ms, 80 ms, 120 ms, 160 ms, 200 ms. Then, the indication of the offset can be jointly indicated with the value of the period. M and N can be different or the same. If M and N are the same, then one size, namely, number of bits, of the field to indicate the offset can be used. Table 27 and Table 28 provide examples. In Table 27 and Table 28, the offset can be set with respect to the indicated period of pool. When there are multiple cells, each cell can have different offset, then the offset can be provided for each of the cells, respectively. The offset can be for TX resource pool, or for RX resource pool.

TABLE 27
Information fields related to resource pool

| | Size | |
|---|---|---|
| | (bits) | Information |
| . . . | . . . | . . . |
| Period of pool | 2 | 00: Period1, |
| | | 01: Period2, |
| | | 10, 11: reserved |
| Offset | 2 bit | For Period1, Offset: 0 ms, 20 ms, 40 ms, 60 ms |
| | or | For Period2, Offset: 0 ms, 40 ms, 80 ms, 120 ms, |
| | 3 bit | 160 ms, 200 ms |
| . . . | . . . | . . . |

TABLE 28
Information fields related to resource pool

| | Size | |
|---|---|---|
| | (bits) | Information |
| . . . | . . . | . . . |
| Period of pool | 2 | 00: Period1, |
| | | 01: Period2, |
| | | 10, 11: reserved |
| Offset | 2 | For Period1, Offset: 0 ms, 20 ms, 40 ms, 60 ms |
| | | For Period2, Offset: 0 ms, 40 ms, 80 ms, 120 ms |
| . . . | . . . | . . . |

The offset can have a default value 0. When offset is omitted, it can mean the offset is equal to 0.

Alternatively, the granularity of possible offsets with respect to a resource pool period can be set according to the period. The number of possible offset values with respect to a resource pool period can be set according to the period. The granularity of offset, and number of offset values can be predetermined for each resource pool period, or may be signaled.

Although the present disclosure has been described with an exemplary embodiment, various changes and modifications may be suggested to one skilled in the art. It is intended that the present disclosure encompass such changes and modifications as fall within the scope of the appended claims.

What is claimed is:

1. For use in a wireless communications network, a User Equipment (UE) comprising:
an antenna configured to communicate via a device to device (D2D) communication; and
processing circuitry configured to communicate with a second UE via the D2D communication, the processing circuitry further configured to:
derive a transmission (TX) timing from a synchronization (sync) source; and
transmit a sync signal configured to indicate a hop number from the sync source, wherein:
when the UE derives the timing from a base station, the sync signal comprises a preamble sequence from a first set of sequences and Physical D2D Sync Channel (PD2DSCH) carrying an indicator indicating the UE is in-coverage,
when the UE derives the timing from a D2D user UE at the first hop, the sync signal comprises a preamble sequence from a first set of sequences and Physical D2D Sync Channel (PD2DSCH) carrying an indicator indicating the UE is out-of-coverage,
when the UE derives the timing from a D2D UE at the second hop, the sync signal comprises a preamble sequence from a second set of sequences and Physical D2D Sync Channel (PD2DSCH) carrying an indicator indicating the UE is out-of-coverage, and
the hop number is indicated via the preamble sequence set and the indicator in PD2DSCH.

2. The UE as set forth in claim 1, wherein the sync signal is a D2D Sync Signal (D2DSS).

3. The UE as set forth in claim 2, wherein the D2DSS is partitioned into two sets comprising the first set of sequences and the second set of sequences, the first set comprising a D2DSSue_net, and the second set comprising D2DSSue_oon.

4. The UE as set forth in claim 1, wherein the PD2DSCH comprises a 1-bit indicator configured to indicate whether the UE is in-coverage of the base station or out-of-coverage of the base station.

5. The UE as set forth in 1, wherein the processing circuitry is configured to:
identify a plurality of nodes capable of providing the sync source; and
prioritize respective ones of the plurality of nodes to select a sync node from which the TX timing will be derived.

6. The UE as set forth in claim 5, wherein the processing circuitry is configured to prioritize from which node to derive the TX time based on the hop number.

7. The UE as set forth in claim 1, wherein the processing circuitry is configured to transmit information, the information comprising one or more bits configured to indicate at least one of:
whether the TX timing is derived from an accurate timing source;
whether the UE can provide sync to other nodes; and
whether the UE is in coverage or out of coverage of a base station.

8. A non-transitory computer readable medium comprising a plurality of instructions, the plurality of instructions configured to, when executed by a processor, cause the processor to:
communicate with at least one portable terminal via a device to device (D2D) communication;
derive a transmission (TX) timing from a synchronization (sync) source; and
transmit a sync signal and Physical D2D Sync Channel (PD2DSCH), the sync signal configured to indicate a hop number from the sync source, wherein
when the processor derives the timing from a base station, the sync signal comprises a preamble sequence from a first set of sequences and Physical D2D Sync Channel (PD2DSCH) carrying an indicator indicating the at least one portable terminal is in-coverage,
when the processor derives the timing from a D2D user UE at the first hop, the sync signal comprises a preamble sequence from a first set of sequences and Physical D2D Sync Channel (PD2DSCH) carrying an indicator indicating the at least one portable terminal is out-of-coverage,
when the processor derives the timing from a D2D UE at the second hop, the sync signal comprises a preamble sequence from a second set of sequences and Physical D2D Sync Channel (PD2DSCH) carrying an indicator indicating the at least one portable terminal is out-of-coverage, and
the hop number is indicated via the preamble sequence set and the indicator in PD2DSCH.

9. The non-transitory computer readable medium as set forth in claim 8, wherein the sync signal is a D2D Sync Signal (D2DSS).

10. The non-transitory computer readable medium as set forth in claim 9, wherein the D2DSS is partitioned into two sets comprising the first set of sequences and the second set of sequences, the first set comprising a D2DSSue_net, and the second set comprising D2DS Sue_oon.

11. The non-transitory computer readable medium as set forth in claim 8, wherein PD2DSCH comprises a 1-bit indicator configured to indicate whether the UE is in-coverage of the base station or out-of-coverage of the base station.

12. The non-transitory computer readable medium as set forth in claim 8,
wherein the plurality of instructions, when executed, is configured to cause the processor to:
identify a plurality of nodes capable of providing the sync source; and
prioritize respective ones of the plurality of nodes to select a sync node from which the TX timing will be derived.

13. The non-transitory computer readable medium as set forth in claim 12, wherein the plurality of instructions is configured to cause the processor to prioritize from which node to derive the TX time based on the hop number.

14. The non-transitory computer readable medium as set forth in claim 8, wherein the plurality of instructions is configured to cause the processor to transmit information, the information comprising one or more bits configured to indicate at least one of:
whether the TX timing is derived from an accurate timing source;
whether the at least one portable terminal can provide sync to other nodes; and
whether the at least one portable terminal is in coverage or out of coverage of a base station.

15. A method comprising:
deriving a transmission (TX) timing from a synchronization (sync) source; and
transmitting a Device to Device (D2D) Sync Signal (D2DSS) and Physical D2D Sync Channel (PD2DSCH), the sync signal configured to indicate a hop number from the sync source, wherein transmitting comprises:
transmitting, when a User Equipment (UE) derives the timing from a base station, the sync signal including a preamble sequence from a first set of sequences and Physical D2D Sync Channel (PD2DSCH) carrying an indicator indicating the UE is in-coverage,
transmitting, when the UE derives the timing from a D2D user UE at the first hop, the sync signal including a preamble sequence from a first set of sequences and Physical D2D Sync Channel (PD2DSCH) carrying an indicator indicating the UE is out-of-coverage,
transmitting, when the UE derives the timing from a D2D UE at the second hop, the sync signal including a preamble sequence from a second set of sequences and Physical D2D Sync Channel (PD2DSCH) carrying an indicator indicating the UE is out-of-coverage, and
the hop number is indicated via the preamble sequence set and the indicator in PD2DSCH.

16. The method as set forth in claim 14, wherein the D2DSS is partitioned into two sets comprising the first set of sequences and the second set of sequences, the first set comprising a D2DSSue_net, and the second set comprising D2DSSue_oon.

17. The method as set forth in claim 15, wherein the PD2DSCH comprises a 1-bit indicator configured to indicate whether the UE is in-coverage of the base station or out-of-coverage of the base station.

18. The method as set forth in claim 15, further comprising:
identifying a plurality of nodes capable of providing the sync source; and
prioritizing respective ones of the plurality of nodes to select a sync node from which the TX timing will be derived.

19. The method as set forth in claim 18, further comprising prioritizing from which node to derive the TX time based on the hop number.

20. The method as set forth in claim 15, further comprising transmitting information comprising one or more bits configured to indicate at least one of:
whether the TX timing is derived from an accurate timing source;
whether the UE can provide sync to other nodes; and
whether the UE is in coverage or out of coverage of a base station.
